(19) United States
(12) Patent Application Publication
(10) Pub. No.: US 2024/0351528 A1
(43) Pub. Date: Oct. 24, 2024

(54) Devices For Attachment To A Utility Vehicle

(71) Applicant: Polaris Industries Inc., Medina, MN (US)

(72) Inventors: Mychale HINNERS, Center City, MN (US); Jared ALBERS, St. Croix Falls, WI (US); Cole PETERSON, Chaska, MN (US); Boris RUBANOVICH, Oak Grove, MN (US); Tim BUSSE, East Bethel, MN (US); Beree James COX, Los Alamitos, CA (US); Saravanan DHANUSHKODI, Meluyr-Taluk (IN); Brian SEIDEL, Osceola, WI (US); Brijesh PANDYA, Forest Lake, MN (US); Bradley REINAGLE, Osceola, WI (US)

(21) Appl. No.: 18/618,253

(22) Filed: Mar. 27, 2024

Related U.S. Application Data
(60) Provisional application No. 63/460,737, filed on Apr. 20, 2023.

(51) Int. Cl. B60R 9/058; B60K 15/067; B60P 7/08; B60R 9/08; B60R 21/02

(52) U.S. Cl. CPC B60R 9/058; B60K 15/067; B60P 7/0815; B60R 9/08; B60R 21/026

(57) ABSTRACT

A vehicle assembly includes a roof panel with a first roof mount with a first extension sized to be received in a first roof recess and a second roof mount with a second extension sized to be received in a second roof recess. The first roof mount includes a first mount recess having a first fastener passage receiving a first fastener. The first fastener couples the first roof mount to the roof panel at the first roof recess. The first roof mount includes a first receiver channel. The second roof mount may be similarly formed with a second fastener in a second receiver channel. The second roof mount includes a second receiver channel. The assembly includes a first roof rail that may include a first rail channel at least partially disposed in the first receiver channel and the second receiver channel. The rails are attached to the mounts with fasteners.

### CROSS-REFERENCE TO RELATED APPLICATIONS

This application is a non-provisional of U.S. provisional application 63/460,737 filed Apr. 20, 2023, which is incorporated by reference herein. This application also incorporates by reference the entire disclosure of PCT Application PCT/US2023/026591 the priority date of which is Jun. 30, 2022.

### FIELD

The present disclosure relates to a system for holding articles or implements carried by a vehicle, more particularly, to a retaining system and a retention device for a securing implements and articles to a vehicle.

### BACKGROUND

This section provides background information related to the present disclosure which is not necessarily prior art.

Vehicles such as cars, trucks and all-terrain vehicles are used for hauling various articles such as tools, utensils, coolers and other equipment. Securing the articles to the vehicle while the vehicle is moving to prevent loss or damage is important. This prevents the articles from shifting and reduces the amount of distraction to the vehicle operator. Flexibility for mounting positions as well as the ability to accommodate various sized articles improves the utility of the system.

### SUMMARY

This section provides a general summary of the disclosures and is not a comprehensive disclosure of its full scope or all of its features.

The present disclosure provides a retaining system that allows flexibility in the types of articles and the position of the article relative to the vehicle or mounting structure.

The vehicle assembly includes a roof panel having a plurality of roof recesses may include a first roof recess spaced apart from a second roof recess. The assembly also includes a first roof mount may include a first extension sized to be received in the first roof recess and a second roof mount may include a second extension sized to be received in the second roof recess. The assembly also includes said first roof mount may include a first mount recess having a first fastener passage receiving a first fastener, said first fastener coupling the first roof mount to the roof panel at the first roof recess, said first roof mount may include a first receiver channel. The assembly also includes said second roof mount may include a second mount recess having a second fastener passage receiving a second fastener, said second fastener coupling the second roof mount to the roof panel at the second roof recess, said second roof mount may include a second receiver channel. The assembly also includes a first roof rail may include a first rail channel at least partially disposed in the first receiver channel and the second receiver channel. The assembly also includes a third fastener coupling the first roof rail to the first roof mount at the first receiver channel. The assembly also includes a fourth fastener coupling the first roof rail to the second roof mount at the second receiver channel.

The vehicle assembly may include a fifth fastener coupling the first roof rail to the first roof mount at the first receiver channel and a sixth fastener coupling the first roof rail to the second roof mount at the second receiver channel. The first fastener is recessed in the first mount recess. The vehicle assembly may include a fourth fastener coupling the second roof mount to the roof panel. The fourth fastener is recessed in the second mount recess. The first roof mount is elongated and the second roof mount is elongated. The first roof mount and the second roof mount are oriented laterally on the roof panel. The third fastener and the fourth fastener are disposed in the first receiver channel. The vehicle assembly may include a third roof mount and a fourth roof mount coupled to the roof panel and to a second rail extending therebetween. The vehicle assembly may include a first cap coupled to a first end of the first roof rail and a second cap disposed in a second end of the first roof rail.

One general aspect includes a power outlet assembly for a cargo box. The power outlet assembly also includes a housing; a door enclosing the housing; a receptacle disposed within the housing; and a bracket coupled to the housing and extending from the housing, said bracket may include an opening therethrough for receiving a retainer retaining the housing to the cargo box.

Implementations may include one or more of the following features. The power outlet assembly where the bracket extends laterally from an end of the housing. The housing is elongated and may include a first end and a second end spaced apart from the first end, where the bracket extends laterally from the first end. The housing is rectangular. A vehicle may include: a cargo box may include a plurality of walls, said plurality of walls may include channel; the power outlet assembly; and said bracket may include an opening for alignment with the channel. The retainer is received in the opening and where the retainer is received within the channel. The plurality of walls may include a rail and the channel is disposed in the rail. A side wall of the plurality of the walls folds flat.

One general aspect includes a fuel tank mount assembly for mounting an accessory fuel tank. The fuel tank mount assembly also includes a housing may include a base, a plurality of sides extending from the base, said plurality of sides may include a first longitudinal side, a second longitudinal side, a first lateral side and a second lateral side; and a first bracket extending from the base.

Implementations may include one or more of the following features. The fuel tank mount assembly where the first bracket is integrally formed with the base. The base is sized to receive a first accessory fuel tank and a second accessory fuel tank. The first longitudinal side may include a formation to position the first accessory fuel tank and the second accessory fuel tank. Further an anti-cap removal feature. The anti-cap removal feature may include a first angular wall extending from the base. The first angular wall extends between the second longitudinal side and the first lateral side. The plurality of sides at least partially surrounds an accessory fuel tank. The base is coupled to a lock mechanism for locking the accessory fuel tank to the base. A vehicle may include: a cargo box may include a plurality of cargo box walls, said plurality of cargo box walls may include a plurality of channels extending into an edge thereof; the fuel tank mount assembly; and a first fastener coupling the first bracket to a channel of the plurality of channels. The first longitudinal side is disposed adjacent to a cargo box floor of the cargo box. The second longitudinal side is disposed above the plurality of cargo box walls. The vehicle may include a second bracket extending from the base. The first bracket and the second bracket couple the housing to a first wall of the plurality of cargo box walls with a retainer. The first bracket and the second bracket couple the housing to a rail of the plurality of cargo box walls with a retainer. The first bracket and the second bracket couple the housing to a rail disposed on an inside surface of the plurality of cargo box walls with a retainer. The vehicle may include a first accessory fuel tank and a second accessory fuel tank received between the first longitudinal side, the second longitudinal side the first lateral side and the second lateral side. The base further may include a slot, said slot receiving a first fastener. The base may include a locating feature extending from the base in a direction opposite the sides, said locating feature received in a slot in the vehicle.

One general aspect includes a vehicle assembly for a vehicle. The vehicle assembly also includes a cargo box may include a first wall spaced apart from a second wall. The assembly also includes a retainer system may include a first elongated member coupled to the first wall, said first elongated member having three or more first regularly spaced apart locating openings and a second elongated member coupled to the second wall, said second elongated member having three or more second regularly spaced apart locating openings. The assembly also includes a headache rack may include a first base, a second base and a cross-member extending therebetween and extending laterally relative to the vehicle, said first base may include a first opening and second opening aligned with a first two of the first regularly spaced apart locating openings and a second base may include a third opening and fourth opening aligned with a second two of the first regularly spaced apart locating openings. The assembly also includes a first fastener disposed in the first opening and a second fastener disposed in the second opening, said first fastener and the second fastener retaining the first base to the retainer system at the first two locating openings. The assembly also includes a third fastener disposed in the third opening and a fourth fastener disposed in the fourth opening, said second fastener and the third fastener retaining the second base to the second elongated member at the second two locating openings.

Implementations may include one or more of the following features. The vehicle assembly may include a molle panel coupled between the first base and the second base. The vehicle assembly may include a first upright member coupled to the first base; and a second upright member coupled to the second base, said molle panel extending between the first upright member and the second upright member. The retainer system may include a rail. The first fastener may include a d-ring. The first fastener may include a locking fastener. The first fastener may include a first retainer and the second fastener may include a second retainer. The first base acts as a first cover for the first retainer and the second retainer. The third fastener may include a third retainer and the fourth fastener may include a fourth retainer, said second base acts as a second cover for the third retainer and the fourth retainer.

One general aspect includes the rising storage box assembly including a receiver housing. The assembly also includes an inner housing. The assembly also includes a lift mechanism biasing the inner housing out of the inner housing. The assembly also includes a latch mechanism may include a latch latching the inner housing within the receiver housing.

Implementations may include one or more of the following features. The rising storage box assembly where the latch mechanism may include a handle operatively coupled to the latch. The latch mechanism may include a button operatively coupled to the latch. The rising storage box assembly may include a rod or cable operatively coupling the latch mechanism and the button, said latch mechanism coupled to the receiver housing, said latch engaging a catch dispose on the inner housing. The lift mechanism may include a gas spring coupled between the receiver housing and the inner housing. The rising storage box assembly may include a linear guide slidably coupling the receiver housing to the inner housing. The lift mechanism may include an electric motor moving the inner housing relative to the receiver housing. A vehicle assembly may include: a cargo box may include a first wall spaced apart from a second wall; a retainer system may include a first rail coupled to the first wall, said first rail having first locating openings, said retainer system may include a second rail coupled to the second wall, said first rail having second locating openings; and the rising storage box coupled to a first elongated member. The receiver housing may include a coupler coupling the receiver housing to the first rail of the retainer system. The retainer system may include a first side and a second side, said first side receiving a retainer therein, said retainer extending though the coupler and through the second side, said retainer coupling the coupler to the first rail. The second side may include a third elongated member. The vehicle may include a supplemental rail housing coupled to a second elongated member of the second wall, said supplemental rail housing may include a fourth elongated member aligned with the third elongated member.

One general aspect includes the vehicle assembly having a cargo box may include a first wall spaced apart from a second wall. The assembly also includes a retainer system may include a first elongated member coupled to the first wall and a second elongated member coupled to the second wall. The assembly also includes a first striker plate coupled to the first elongated member. The assembly also includes a second striker plate coupled to the second elongated member; and. The assembly also includes a rack having a first side member rotatably coupled to the first elongated member and a second side member rotatably coupled to the second elongated member, a first latch mechanism coupled to the first side member releasably engaging the first striker plate and a second latch mechanism coupled to the second side member releasably engaging the second striker plate.

Implementations may include one or more of the following features. The vehicle assembly where the first striker plate extends from a first vertical wall of the first elongated member and the second striker plate extends from a second vertical wall of the second elongated member. The rack may include a plurality of rack members may include a plurality of elongated members disposed between the first side member and the second side member. The plurality of elongated members is disposed parallel to the first side member and the second side member. The plurality of rack members may include a plurality of channels. The plurality of rack members may include regularly spaced apart locating openings. The vehicle assembly may include a lift mechanism coupled between the first side member and the first elongated member, between the second side member and the second elongated member or both. The lift mechanism may include a gas filled spring coupled between the first side member and the first elongated member. The first latch mechanism and the second latch mechanism are coupled to a cable actuator may include a handle portion. The cable actuator is at least partially disposed within a tubular first rack member and a second tubular rack member. First tubular rack member and the second tubular rack member each may include a longitudinal portion and a lateral portion, each of which have the cable actuator therein. The cable actuator extends from respective openings each of the lateral portions.

One general aspect includes a slide out bed assembly for a utility vehicle having a cargo box with a load floor. The slide also includes a tray. The slide also includes a first mounting bracket fixedly coupled to the load floor or the first side wall. The slide also includes a second mounting bracket spaced apart from the first mounting bracket and fixedly coupled to the load floor or the second side wall. The slide also includes a first slide rail coupled to the first mounting bracket. The slide also includes a second slide rail coupled to the second mounting bracket. The slide also includes a first slide coupled to the tray and slidably coupled to the first slide rail. The slide also includes a second slide coupled to the tray and slidably coupled to the second slide rail.

Implementations may include one or more of the following features. The slide out bed assembly where the tray has a first laterally extending vertical side, a second laterally extending vertical side, a first longitudinally extending vertical side and a second longitudinally extending vertical side. The first longitudinally extending vertical side and the second longitudinally extending vertical side extend a vertically greater distance than the first laterally extending vertical side and a second laterally extending vertical side. The tray may include a tray floor having a plurality of rails mounted thereto. The plurality of rails is coupled to the tray floor longitudinally relative to the vehicle. The first mounting bracket may include a first horizontal member coupled to the load floor, where the second mounting bracket may include a second horizontal member coupled to the load floor. The first mounting bracket may include a first vertical member extending from the first horizontal member, where the second mounting bracket may include a second vertical member extending from the second horizontal member. The first vertical member is coupled to the first slide rail and the second vertical member is coupled to the second slide rail. The first slide is coupled to a first longitudinally extending vertical side and the second slide is coupled to a second longitudinally extending vertical side.

One general aspect includes a slide out bed assembly for a utility vehicle having a cargo box with a first side wall and a second side wall. The slide also includes a tray. The slide also includes a first slide rail coupled to the cargo box. The slide also includes a second slide rail coupled to the cargo box. The slide also includes a first slide coupled to the tray and slidably coupled to the first slide rail. The slide also includes a second slide coupled to the tray and slidably coupled to the second slide rail.

Implementations may include one or more of the following features. The slide out bed assembly where the first slide rail is coupled to the first side wall and the second slide rail is coupled to is coupled to the second side wall. The first slide rail is indirectly coupled to the first side wall and the second slide rail is indirectly coupled to the second side wall. The first slide rail is coupled to a first molle panel and the second slide rail is coupled to a second molle panel. The first slide rail is directly coupled to the first side wall and the second slide rail is directly coupled to the second side wall. The first slide rail and the second slide rail are coupled to a load floor of the cargo box. The first slide rail and the first slide and the second slide rail and the second slide allow the tray to extend over a folding wall of the cargo box. The tray may include a plurality of openings. The plurality of openings may include circular holes. The plurality of openings may include a plurality of elongated openings. The plurality of elongated openings may include a plurality of locating openings. At least two locating openings are disposed in each of the plurality of elongated openings. The plurality of openings is disposed in a tray floor and may include a plurality of elongated openings may include a plurality of locating openings, said plurality of openings further may include slots and circular openings.

One general aspect includes a fishing pole transport assembly for a vehicle may include a rail may include. The fishing pole transport assembly also includes an elongated housing having a first end and a second end. The assembly also includes a first end cap disposed on the first end. The assembly also includes a second end cap disposed on the second end. The assembly also includes a first retainer strap coupled to the elongated housing, said first retainer strap sized to receive a first retainer for coupling the first retainer strap to the rail. The assembly also includes a second retainer strap coupled to the elongated housing, said second retainer strap sized to receive a second retainer for coupling the second retainer strap to the rail.

Implementations may include one or more of the following features. The fishing pole transport assembly where the elongated housing is cylindrical. The elongated housing may include a first cylindrical portion and a second cylindrical portion. The first cylindrical portion has a diameter greater than the second cylindrical portion. The second cylindrical portion is longitudinally longer than the first cylindrical portion.

One general aspect includes the vehicle including a cargo box may include a first side edge and a second side edge and a floor therebetween. The vehicle also includes a first rail disposed on the first side edge. The vehicle also includes a first side may include a first retainer system, said retainer system removably coupling the first side to the first rail. The vehicle also includes a second rail disposed on the second side edge. The vehicle also includes a second side may include a second retainer system removably coupling the second side to the second rail.

Implementations may include one or more of the following features. The vehicle where the first retainer system may include a first plurality of retainers on a first mounting edge of the first side. The vehicle may include a first handle operably coupled to the first plurality of retainers. The vehicle may include a second plurality of retainers disposed on a second mounting edge of the first side. The first handle is operably coupled to the second plurality of retainers. The first mounting edge of the first side is perpendicular to the second mounting edge. The second retainer system may include a third plurality of retainers on a third mounting edge of the second side, said vehicle may include a second handle operably coupled to the first plurality of retainers, and may include a fourth plurality of retainers disposed on a second mounting edge of the second side, said second handle is operably coupled to the second plurality of retainers, where the first mounting edge of the second side is perpendicular to the second mounting edge.

One general aspect includes the roof rack and a roof. The roof rack also includes a first rail may include a may include a receiving channel for receiving a retainer, said first rail may include a first side channel and a second side channel integrally formed with the first rail receiving and retaining the roof within the first side channel and the second side channel.

Implementations may include one or more of the following features. The roof rack where the first rail is molded to the roof. The receiving channel is formed from a first side wall, a second side wall and a bottom wall. An outer surface of the first rail is exposed on an underside of the roof. The first rail may include an elongated opening with a plurality of regularly spaced locating openings. The roof rack may include a second rail spaced apart from the first rail, said second rail may include a second receiving channel for receiving a second retainer, said second rail may include a third side channel and a fourth side channel integrally formed with the second rail receiving and retaining the roof within the third side channel and the fourth side channel.

One general aspect includes a seat assembly for a vehicle. The seat assembly also includes a seat base support. The assembly also includes a seat base coupled to the seat base support. The assembly also includes a coupler coupled to the seat base support sized to receive a retainer. The assembly also includes a seat back. The assembly also includes a seat back frame coupled to the seat base support.

Implementations may include one or more of the following features. The seat assembly where the seat base is rotatably coupled to the seat base support. The seat base support may include a first leg and a second leg and where said coupler may include a first coupler and a second coupler. The first coupler may include first retainer for removably coupling the first coupler to a first vehicle rail and where the second coupler may include a second retainer for removably coupling the second coupler to a second vehicle rail. The seat base support may include a first leg, a second leg, a third leg and a fourth leg and where said coupler may include a first coupler coupled to the first leg, a second coupler coupled to the second leg, a third coupler coupled to the third leg and a fourth coupler coupled to the fourth leg. The first coupler may include first retainer for removably coupling the first coupler to a first vehicle rail, where the second coupler may include a second retainer for removably coupling the second coupler to a second vehicle rail, where the third coupler may include a third retainer for removably coupling the third coupler to a first vehicle rail and where the fourth coupler may include a fourth retainer for removably coupling the fourth coupler to the second vehicle rail. The first leg and the third leg are coupled by a first intermediate portion and the second leg and the fourth leg are coupled by a second intermediate portion. The first intermediate portion and the second intermediate portion are horizontal. The seat base is rotatably coupled to the first intermediate portion and the second intermediate portion. The seat base is rotatably coupled to the first intermediate portion and the second intermediate portion using brackets.

One general aspect includes the vehicle also having a vehicle floor. The vehicle also includes a rail coupled to the vehicle floor. The vehicle also includes a seat assembly may include a seat base. The vehicle also includes a seat base support coupled to the seat base. The vehicle also includes a retainer. The vehicle also includes a coupler coupled to the seat base support, said coupler sized to receive the retainer for removably securing the coupler to the rail. The vehicle also includes said retainer may include a movable plunger extending into a rail channel though a base plate. The vehicle also includes a seat back coupled to the seat base support.

Implementations may include one or more of the following features. The vehicle where the seat back is coupled to the seat base support. The seat base support is coupled to the rail so the seat assembly is in a forward-facing position. The seat base support is coupled to the rail so the seat assembly is in a rear-facing position. The seat base is rotatably coupled to the seat base support. The vehicle further may include a fastener head extending from the retainer through the base plate. The vehicle may include a rear seat having a rear seat base rotatably coupled to a vehicle structure. The seat base support may include a first leg, a second leg, a third leg and a fourth leg and where said coupler may include a first coupler coupled to the first leg, a second coupler coupled to the second leg, a third coupler coupled to the third leg and a fourth coupler coupled to the fourth leg, where the rail may include a first vehicle rail and a second vehicle rail. The first coupler may include first retainer for removably coupling the first coupler to the first vehicle rail, where the second coupler may include a second retainer for removably coupling the second coupler to the second vehicle rail, where the third coupler may include a third retainer for removably coupling the third coupler to the first vehicle rail and where the fourth coupler may include a fourth retainer for removably coupling the fourth coupler to the second vehicle rail.

One general aspect includes the mounting bracket including a first planar base having a first curved end; first openings in the first planar base receiving at least a portion of a first retainer; and a first curved wall extending from the first planar base at the first curved end, said first curved wall having a first slot therein.

Implementations may include one or more of the following features. The mounting bracket may include a second slot disposed in the curved. The first openings are disposed in a rectangular portion of the first planar base. The first curved wall extends perpendicular from the first planar base. An assembly may include: the mounting bracket a crossbar, and a first fastener extending though the first slot coupling the crossbar to the mounting bracket.

One general aspect includes the crossbar assembly including a crossbar; a first retainer; a first mounting bracket may include, a first planar base having a first curved end; first openings in the first planar base receiving at least a portion of the first retainer therethrough; and a first curved wall formed perpendicularly from the first planar base at the first curved end, said first curved wall having a first slot therein. The assembly also includes a first fastener disposed within the first slot coupling the first mounting bracket to the crossbar. The assembly also includes a second retainer. The assembly also includes a second mounting bracket may include, a second planar base having a second curved end; second openings in the second planar base receiving at least a portion of the second retainer therethrough; and a second curved wall formed perpendicularly from the second planar base at the second curved end, said second curved wall having a second slot therein. The assembly also includes a second fastener disposed within the second slot coupling the second mounting bracket to the crossbar.

Implementations may include one or more of the following features. A vehicle may include: a first rail, a second rail, the first retainer, the second retainer, and a crossbar assembly said first retainer coupling the first mounting bracket to the first rail, and said second retainer coupling the second mounting bracket to the second rail. The first retainer may include a first plunger and a first fastener head extending through the first openings. The second retainer may include a second plunger and a second fastener head extending through the second openings. The first plunger extends into the first rail though the first planar base and where the second plunger extends into the second rail though the second planar base.

One general aspect includes a roof rack for a vehicle having a first tubular roof support. The roof rack also includes a crossbar may include a first crossbar end and a second crossbar end; a first clamp coupled to the first crossbar end; a second clamp coupled to a second crossbar end; said first clamp having first central portion having a first end may include first lateral extension portion coupled to the first crossbar end, and a second end may include a first coupler portion positioned against the first tubular roof support, said first end, said second end and the central portion forming a first pocket for receiving the roof panel therein; and said second clamp having second central portion having a third end may include second lateral extension portion coupled to the second crossbar end, and a fourth end may include a second coupler portion positioned against the second tubular roof support, said third end, said fourth end and the second central portion forming a second pocket for receiving the roof panel therein.

Implementations may include one or more of the following features. The roof rack where the first coupler portion has a first curved surface corresponding to a first curvature of the first tubular roof support. The first central portion and the second central portion are curved. The first clamp is monolithic, and the second clamp is monolithic. The first end may include a first wall receiving fasteners therethrough and a second wall supporting the first crossbar end. The first wall may include a vertical wall and the second wall may include a horizontal wall and may include a first fastener extending through the vertical wall coupling the vertical wall to the crossbar.

One general aspect includes the vehicle having a first longitudinally extending roof support; a second longitudinally extending roof support; a roof panel coupled to the first longitudinally extending roof support and the second longitudinally extending roof support; a crossbar may include a first end and a second end; a first clamp coupled to the first end of the crossbar; a second clamp coupled to a second end of the crossbar; said first clamp having first central portion having a first end may include first lateral extension portion coupled to the first end of the crossbar, and a second end may include a first coupler portion positioned against the first longitudinally extending roof support, said first end, said second end and the central portion forming a first pocket for receiving the roof panel therein; and said second clamp having second central portion having a third end may include second lateral extension portion coupled to the third end of the crossbar, and a fourth end may include a second coupler portion positioned against the second longitudinally extending roof support, said third end, said fourth end and the second central portion forming a second pocket for receiving the roof panel therein.

Implementations may include one or more of the following features. The vehicle where the first longitudinally extending roof support may include a first tubular roof support and the second longitudinally extending roof support may include a second tubular roof support. The first coupler portion has a first curved surface corresponding to a first curvature of the first tubular roof support. The first central portion and the second central portion are curved. The first clamp is monolithic, and the second clamp is monolithic. The first end may include a first wall receiving fasteners therethrough and a second wall supporting the first end of the crossbar. The first wall may include a vertical wall and the second wall may include a horizontal wall. The vehicle may include a first fastener extending through the first wall coupling the first wall to the crossbar.

One general aspect includes the sprayer assembly having a base; a tank coupled to the base, a first rail lock coupled to the base and having a first portion positionable outside the base, and a second rail lock coupled to the base having a second portion positionable outside the base.

Implementations may include one or more of the following features. The sprayer assembly where the first rail lock may include a first rail and a first arm movably coupled to the first rail. The first arm is coupled to the first rail with a first retainer. The first retainer couples the first arm to the first rail through first openings in the first arm. The first retainer may include a first plunger and a first fastener head extending through the first openings. The first retainer may include a first plunger and a first fastener head extending through the first openings, said first fastener and the plunger extending into a first channel of the first rail. The first rail may include a first channel for receiving a portion of the first retainer therein. The first arm may include a block coupled to an end thereof. The block is elastomeric. The block is wedge-shaped. The base is planar.

One general aspect includes the vehicle including a cargo box. The vehicle also includes a sprayer assembly for a vehicle, said vehicle may include a cargo box may include vertically extending recesses, said sprayer assembly may include: The vehicle also includes a base. The vehicle also includes a tank coupled to the base. The vehicle also includes a first rail lock coupled to the base engaging a first vertically extending recess. The vehicle also includes a second rail lock coupled to the base engaging a second vertically extending recess.

Implementations may include one or more of the following features. The vehicle where the first rail lock may include a first rail and a first arm movably coupled to the first rail. The first arm is coupled to the first rail with a first retainer. The first retainer couples the first arm to the rail through first openings in the first arm. The first retainer may include a first plunger and a first fastener head extending through the first openings. The first retainer may include a first plunger and a first fastener head extending through the first openings, said first fastener and the plunger extending into a first channel of the first rail. The first rail may include a first channel for receiving a portion of the first retainer therein. The first arm may include a block coupled to an end thereof. The block is elastomeric. The block is wedge-shaped. The base is planar.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1A is a left side perspective view of a utility vehicle having a retaining system according to the present disclosure.

FIG. 1B is a right-side perspective view of the utility vehicle of FIG. 1A.

FIG. 1C is a left side view of the utility vehicle of FIGS. 1A-1B.

FIG. 1D is a right-side view of the utility vehicle of FIGS. 1A-1C.

FIG. 1E is a top side view of the utility vehicle of FIGS. 1A-1D.

FIG. 1F is a front view of the vehicle of FIGS. 1A-1E.

FIG. 1G is a rear view of the vehicle of FIGS. 1A-1F.

FIG. 2A is a perspective view of a cargo box having the retainer system.

FIG. 2B is a perspective view of a rail of the retainer system.

FIG. 2C is a perspective view of a double channel receiver of the retainer system.

FIG. 2D is a cross-sectional view of the double channel receiver of FIG. 2C.

FIG. 3A is a perspective view of the roof having a retainer system according to examples of the present disclosure.

FIG. 3B is a top view of a portion of the retainer system of FIG. 3A.

FIG. 3C is an exploded view of the retainer system of FIGS. 3A-3B.

FIG. 4A is a perspective view of an integral rail in a roof of the utility vehicle.

FIG. 4B is a cross-sectional view of the rail of FIG. 4A.

FIG. 5A is a rear perspective view of a utility vehicle having a power outlet assembly.

FIG. 5B is an enlarged view of the power outlet assembly of FIG. 5A.

FIG. 5C is a left side perspective of a utility vehicle having one wall of the cargo box folded having a power outlet assembly coupled thereto.

FIG. 5D is an enlarged view of the power outlet assembly of FIG. 5C.

FIG. 5E is a perspective view of the power outlet assembly 510 in a closed position.

FIG. 5F is a perspective view of the power outlet assembly in an opened position.

FIG. 5G is a perspective view of the power outlet assembly coupled to a rail.

FIG. 6A is a perspective view of a fuel tank mounting assembly mounted to a utility vehicle.

FIG. 6B is a lower perspective view of accessory fuel tanks mounted within a housing of a fuel tank assembly.

FIG. 6C is a front perspective view of a housing of the fuel tank mount assembly.

FIG. 6D is a rear view of the housing of the fuel tank mount assembly.

FIG. 6E is side view of the housing 612 of the fuel tank mount assembly.

FIG. 7A is a perspective view of the cargo box of the vehicle having a first example of a headache rack therein.

FIG. 7B is an enlarged portion of the base of the headache rack.

FIG. 7C is an enlarged area of the headache rack base having the retainer removed therefrom.

FIG. 7D is a plan view of holes in the headache rack for receiving a retainer.

FIG. 7E is a perspective of a portion of a headache rack having D-ring retainers therein.

FIG. 7F is an enlarged area of the base of the headache rack of FIG. 7F.

FIG. 8A is a perspective view of a rising storage box assembly in a retracted position in a cargo box of the vehicle.

FIG. 8B is a perspective under side view of the rising storage box assembly in a retracted position.

FIG. 8C is a rising storage box assembly in the extended position.

FIG. 8D is a perspective view the latch and catch mechanism of the rising storage assembly of FIGS. 8A-8C.

FIG. 8E is a perspective view of a possible tool storing example of the inner housing.

FIG. 8F is a perspective batch side view of the rising storage box assembly in the extended position.

FIG. 8G is a perspective view of a supplementary coupler.

FIG. 8H is a perspective view of an electrical rising storage box assembly in an extended position.

FIG. 8I is a button for the rising storage box assembly having a motor operated lift box.

FIG. 8J is the electrical rising storage box assembly in the retracted position.

FIG. 8K is the electrical rising storage box assembly in the extended position.

FIG. 9A is a perspective view of a cargo box having a rack assembly.

FIG. 9B is a perspective view of the rack assembly of FIG. 9A.

FIG. 9C is a cross-sectional view of the rack assembly at the latch mechanism and striker plate.

FIG. 9D is a perspective view showing the rack assembly in the open position.

FIG. 9E is a perspective view of an alternate example of a rack assembly.

FIG. 9F is a perspective view of the cable actuator of FIG. 9E.

FIG. 9G is a perspective view of the rack assembly of FIG. 9E in a lifted position with a wheel secured thereto.

FIG. 10 is a perspective exploded view of a D-ring assembly.

FIG. 11A is a top perspective view of another example of a retainer in a locked position.

FIG. 11B is a side perspective view of the retainer of FIG. 11A having the lever in an unlocked position.

FIG. 11C is an exploded view of the retainer of FIGS. 11A and 11B.

FIG. 11D is a cutaway view of the retainer through the cam so the position of the tab is illustrated in an unlocked position.

FIG. 11E is a cutaway view similar to that of FIG. 11D except in a locked position.

FIG. 11F is a cross sectional view through the cam illustrating the position of the pin opening.

FIG. 11G is the cross-sectional view of FIG. 11F except with the cam in the locked position.

FIG. 11H is a cutaway view of the housing showing the pin within the slot 1156.

FIG. 11I is a side view of the plunger.

FIG. 11J is a cross sectional view through the middle of the housing.

FIG. 11K is a bottom view of the housing.

FIG. 11L is a bottom view of a self-contained retainer mechanism with a bottom.

FIG. 11M is a perspective view of a retainer that may be mounted to an accessory.

FIG. 12A is a perspective view of an alternate retainer.

FIG. 12B is a perspective view of a removable tray assembly.

FIG. 12C is a perspective view of the removable tray system with the tray in the extended position.

FIG. 12D is a perspective view of the bed of the cargo box with the tray in the extended position.

FIG. 12E is a perspective view of the side rail of the removable tray assembly of FIG. 12B-12D.

FIG. 12F is an alternate sliding tray mounting for use with a sliding tray system.

FIG. 12G is a perspective view of a molle rack coupled within a cargo bed that may be used for storing various tools or implements or a slide out bed assembly as described below.

FIG. 12H is a perspective view of the slide out bed assembly coupled to a molle rack.

FIG. 12I is a front view of the molle rack of FIG. 12H.

FIG. 12J is a rear view of the molle rack of FIG. 12H.

FIG. 12K is a perspective view of a cargo box with an alternative configuration for a tray.

FIG. 12L is a perspective view of an alternative configuration for a tray.

FIG. 13A is a perspective view of a fishing pole transporting retainer.

FIG. 13B is an enlarged end view of the fishing pole transporting retainer of FIG. 13A.

FIG. 13C is an alternate perspective view of the fishing pole transport container.

FIG. 14A is a perspective view of a cargo box 16 with removable sides.

FIG. 14B is an underside view of a removable wall of the system of FIG. 14A.

FIG. 14C is a side view of the removable wall system.

FIG. 14D is a cross-sectional view of the retainers of the removable wall system.

FIG. 15A is a cutaway view of a vehicle chassis having rails for mounting a seat therein.

FIG. 15B is a perspective cutaway vehicle of a vehicle chassis having a reconfigurable seat mounted thereto.

FIG. 15C is a perspective view of an alternative mounting position for a seat of FIG. 15B.

FIG. 15D is a perspective view of a seat for coupling to rails.

FIG. 15E is a perspective view of the seat with the bottom in a raised position.

FIG. 15F is a perspective view of the back of the seat of FIGS. 15D and 15E.

FIG. 15G is a perspective view of a coupler for coupling the seat to the rail.

FIG. 15H is a bottom view of the coupler for coupling the seat to the rail.

FIG. 16A is a perspective view of a crossbar assembly.

FIG. 16B is a first example of a crossbar assembly positioned in a vehicle 10.

FIG. 16C is a crossbar assembly mounted in another position on the vehicle 10.

FIG. 16D is a top view of a vehicle having a crossbar assembly mounted in yet another position.

FIG. 16E is a top view of a vehicle having two crossbar assemblies mounted thereto.

FIG. 16F is a perspective view of a crossbar mounting bracket.

FIG. 16G is a top view of a crossbar mounting bracket.

FIG. 16H is a front view of a crossbar mounting bracket.

FIG. 16I is a top view of a crossbar mounting bracket with optional positions for the crossbar.

FIG. 17A is a perspective view of a roof of a vehicle having a roof rack mounted thereto.

FIG. 17B is a perspective view of the roof rack not assembled to the vehicle.

FIG. 17C is a perspective end view of a clamp and crossbar for the roof rack.

FIG. 17D is a cross section of the roof rack coupled to a tubular tube of the vehicle.

FIG. 17E is a second cross sectional view showing the crossbar and clamp coupled to the vehicle.

FIG. 18A is a top view of a sprayer assembly coupled within a cargo box of a vehicle.

FIG. 18B is a perspective view of the sprayer tank assembly.

FIG. 18C is an enlarged perspective view of an arm having a block coupled thereto for engaging the vertically extending recess.

FIG. 18D is a side view of a block showing the wedge shape coupled to an arm.

Corresponding reference numerals indicate corresponding parts throughout the several views of the drawings.

### DETAILED DESCRIPTION

Example embodiments will now be described more fully with reference to the accompanying drawings. Although the following description includes an example of a utility vehicle application, it is understood that the features herein may be applied to any appropriate vehicle, such as motorcycles, all-terrain vehicles, side by sides, mopeds, scooters, cars trucks, sport utility vehicle, etc. The examples disclosed below are not intended to be exhaustive or to limit the disclosure to the precise forms disclosed in the following detailed description. Rather, the examples are chosen and described so that others skilled in the art may utilize their teachings.

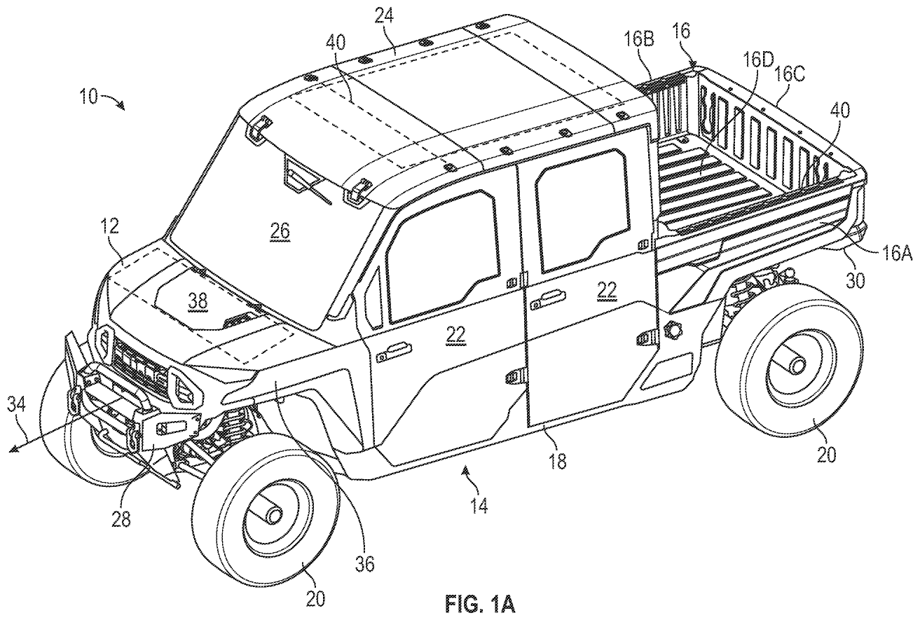

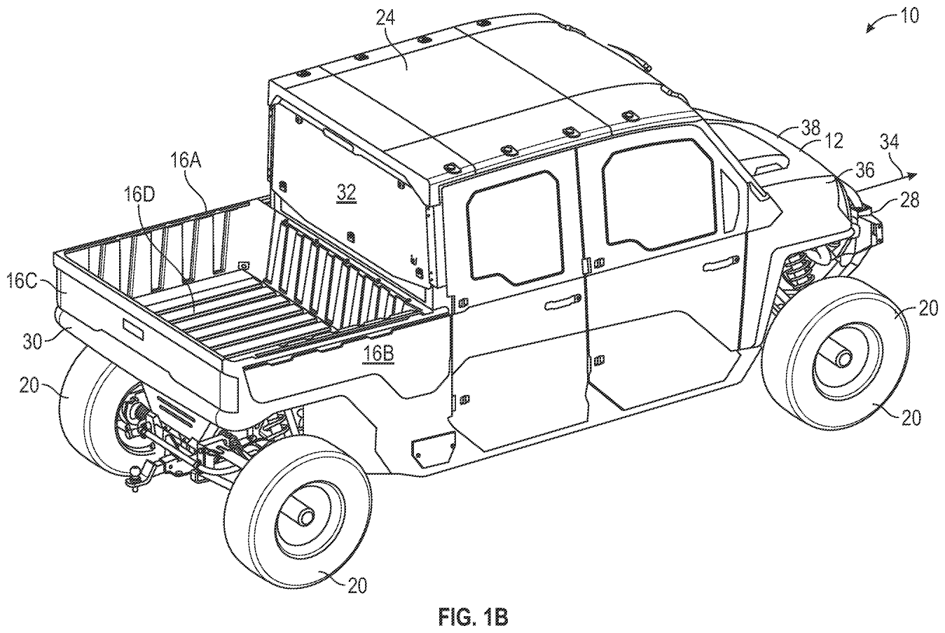

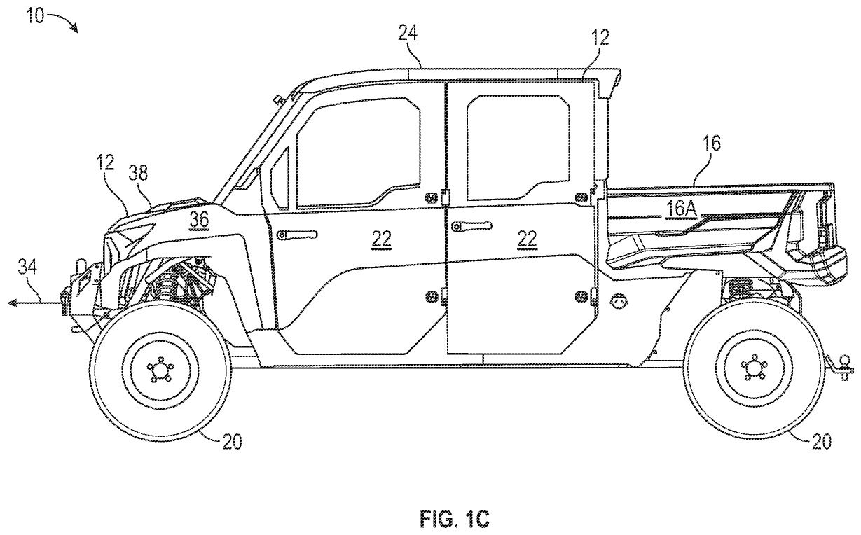

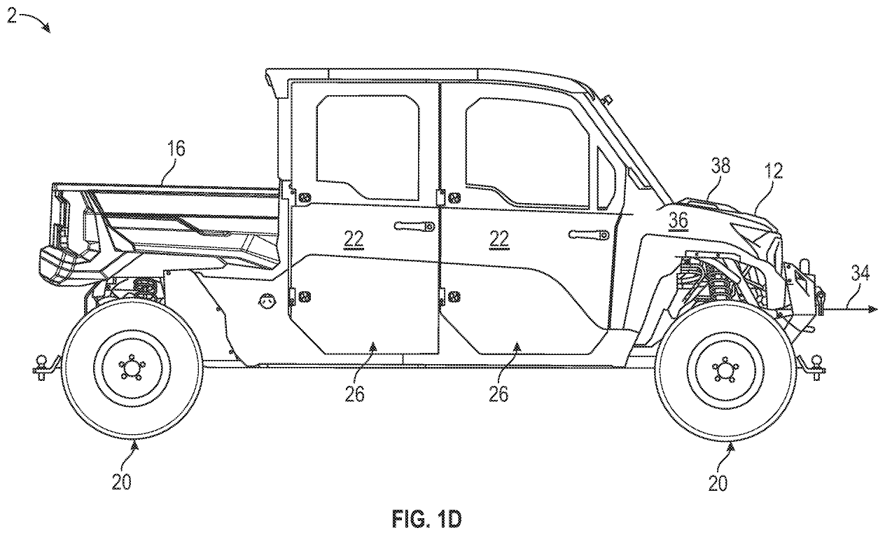

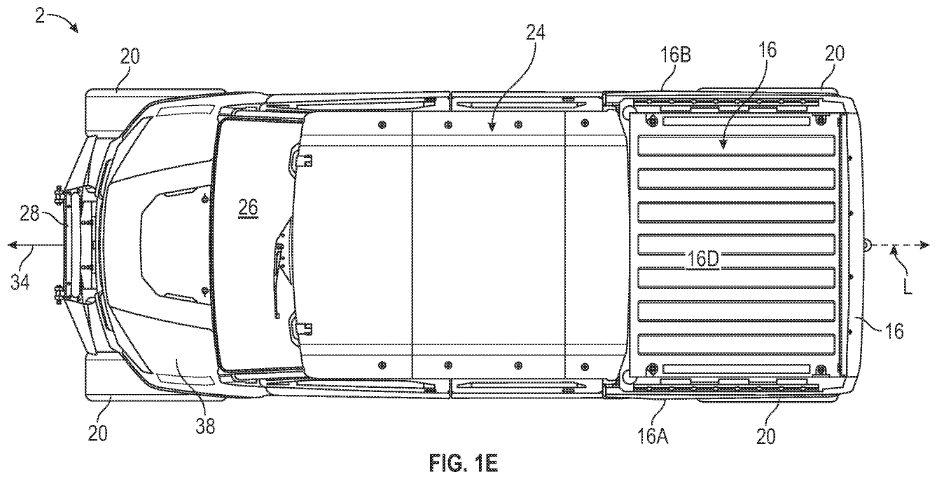

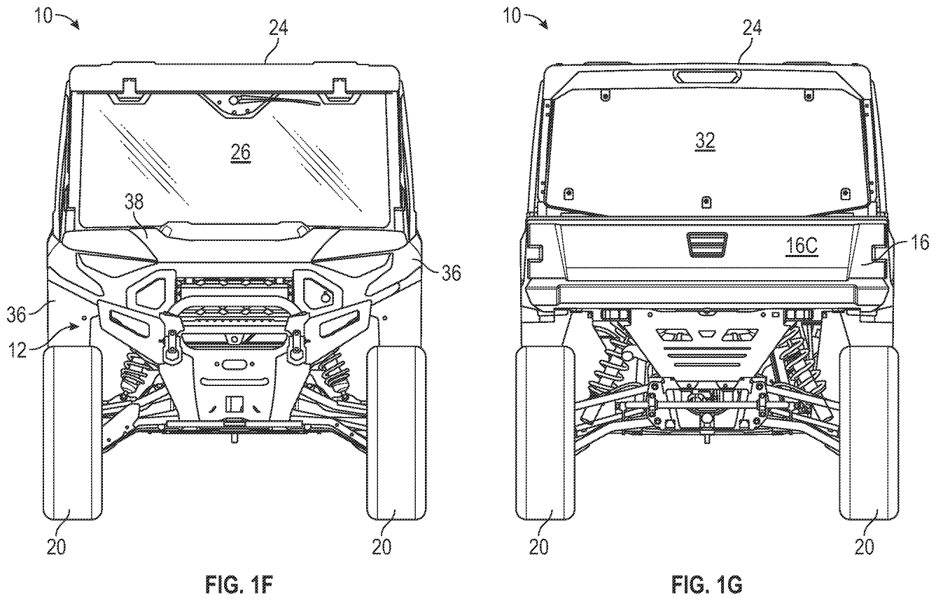

Referring now to FIGS. 1A-1G, a vehicle 10, such as a utility vehicle, is illustrated. The vehicle assembly or simply vehicle 10 has a front end 12, a passenger area 14 and a cargo box 16. The vehicle 10 may include a frame 18 and wheels 20 that are coupled to the frame for moving the vehicle 10. Of course, the wheels 20 may be replaced by tracks, skis or other vehicle supporting devices. As illustrated, the passenger area 14 includes doors 22 used for enclosing the passenger area 14. However, no doors may be provided in various types of vehicles.

The passenger area 14, in this example, is enclosed by a roof 24 and a windshield 26. The vehicle also has a front bumper 28 and a rear bumper 30.

A rear window 32 is also illustrated in various figures. The vehicle also has a longitudinal axis 34.

The cargo box 16 has a plurality of walls or side including a first vertical side wall 16A, a second vertical side wall 16B, a third vertical side wall 16C that may be a door and a bed or load floor 16D. As will be mentioned in further detail below, the sides 16A and 16B may fold flat outward so that the load floor 16D and the side walls 16A, 16B form a continuous flat surface. Further details on that example will be provided below.

A retaining system 40 may be used for securing articles to a portion of the vehicle 10. In this example, the retaining system 40 is generally illustrated coupled to the roof 24 and to the cargo box 16. Details and examples for the configuration of the retaining system at the roof 24 and the cargo box 16 are provided in more details below.

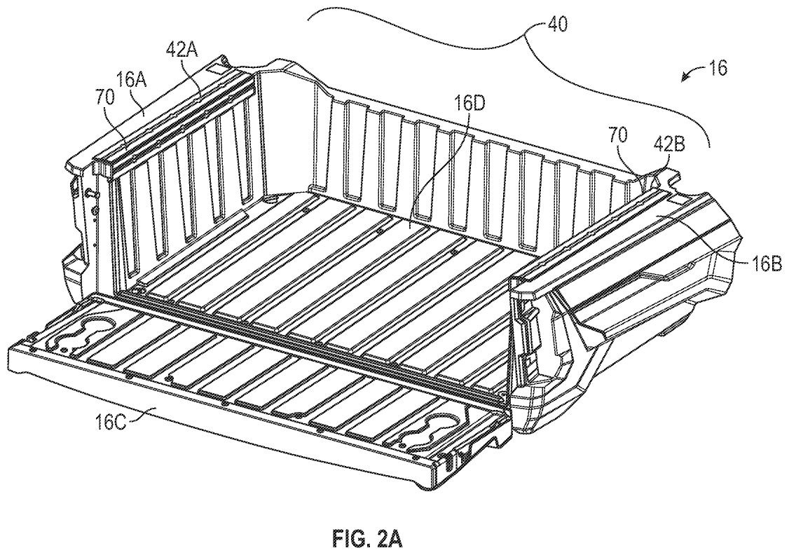

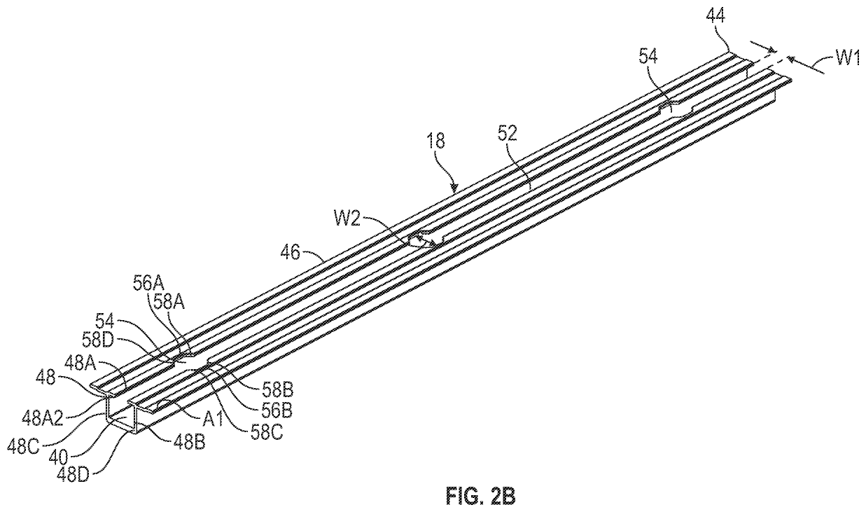

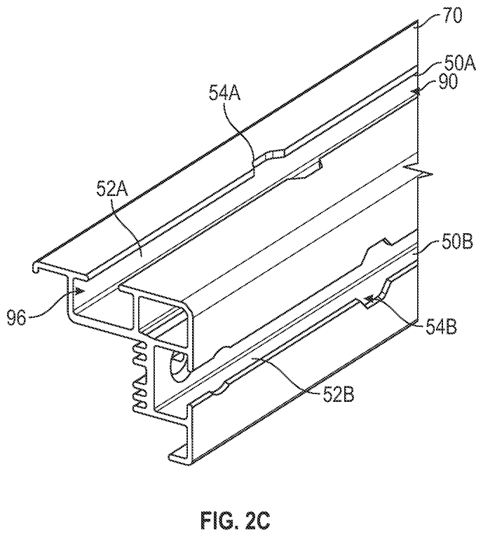

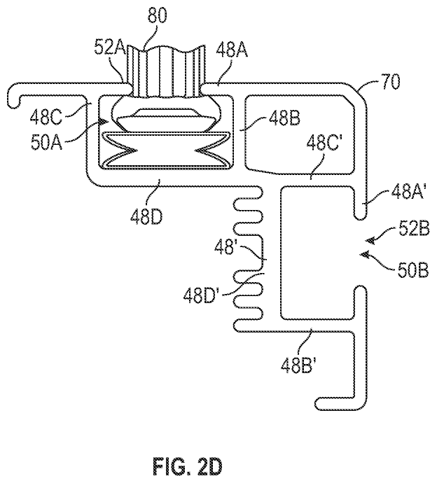

Referring now to FIG. 2A, the cargo box 16 is illustrated in further detail. In FIG. 2A, the cargo box 16 is illustrated having the wall 16C acting as a door in the open position. The retaining system 40, in this example, is formed from a first elongated member 42A and a second elongated member 42B. The elongated members 42A, 42B act as a receiver for receiving retainers as will be described in more detail below. The shapes, orientations and positions of the receivers and retainers may vary and are further described below. The retainers may be integrally formed with a portion of the vehicle or later added in the aftermarket. A locating slot 210 described later is used for locating a base plate for a fuel tank mount.

Referring now to FIG. 2B, one example of an elongated member 42 is set forth as a receiver 44. The elongated member 42A, 42B may be formed in a similar manner. Receiver 44 is a first example of a single channel receiver. A double channel receiver is described below.

The receiver 44 may be formed in a rail 46. The rail 46 has an outer wall 48 that at least partially encloses a channel 50. In this example, the outer wall 48 has a top wall 48A, side walls 48B, 48C and a bottom wall 48D. One or more of the walls 48A-48D may be a body panel of the vehicle 10. Of course, the rail 46 may be formed or partially formed as part of one of the vehicle components as described further herein. The outer wall 48A has a first side 48A1 that is outside of the channel 50 and a second side 48A2 that is within the channel 50. The wall 48A has an elongated opening 52 that, as illustrated, may extend a length such as the length of the rail 46. However, the elongated opening 52 may have shorter portions. The elongated opening 52 of the outer wall 48A has a width W1. The rail 46 may also have a second or locating opening 54. The locating opening 54 may be continuous with the elongated opening 52 and has a second width W2 that is wider than the width W1. The elongated opening 52 and the locating opening 54 together are used to receive and provide a position to secure a retainer as will be further described below. In this example, the locating opening 54 is a potential position for a retainer. The number of locating openings 54 may vary depending upon the application and type of retainer. The locating openings 54 may be regularly spaced apart. In some configurations of vehicles and accessories the spacing of retainers on various products is made to correspond to the spacing of the locating openings 54.

In this example, the locating openings 54 have a first side 56A and a second side 56B that are parallel to the elongated opening 52. Angled sides 58A, 58B, 58C and 58D may be disposed at various angles relative to the first side 56A and the second side 56B. In this example, the angled sides 58A-D are at 45° relative to the first and second sides 56A, 56B. As mentioned above, the sides 56A, 56B, 58A-58D may be differently spaced depending upon the design and the shape of the receiver.

Referring now to FIG. 2C, a double channel receiver 70 is illustrated. In this example, two channels 50A, 50B are configured in a similar manner to that set forth above with respect to FIG. 2B and channel 50. A plurality of elongated openings 52A, 52B are provided in a similar manner to that described above and have elongated openings 54A, 54B. Relative to the vehicle, the locating openings 54A, 54B may be aligned. In this example, the double channel receiver 70 may be an extruded piece that has the channels 50A, 50B located perpendicularly to each other. A double channel receiver 70 is illustrated in FIG. 2A. The double channel receiver 70 allows components to be located in a top horizontal surface of the double channel receiver (relative to the vehicle) or located within the cargo box 16 on vertical surfaces of the vehicle.

Referring now to FIG. 2D, a cross-sectional view of the double channel receiver 70 is illustrated. The outer wall 48 is formed from outer walls 48A-48D as described above with respect to FIG. 2B. The second channel 50B is formed by the outer wall 48′ and specifically the outer wall 48A′, 48B′, 48C′ and 48D′. A representation of a retainer 80 is illustrated.

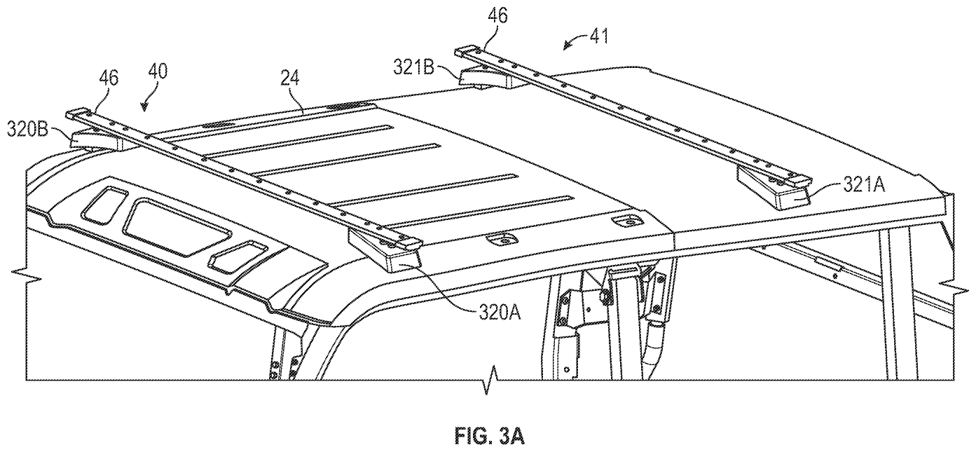

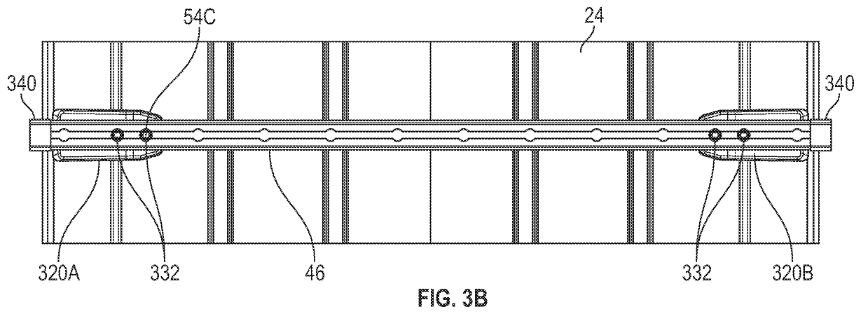

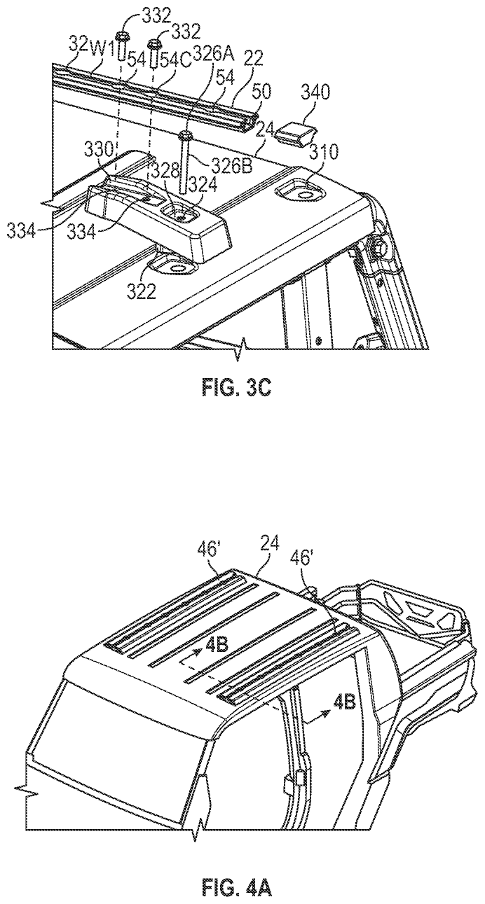

Referring now to FIGS. 3A-3C, the retaining system 40, as described above, may be attached to a roof 24. The retaining system 40, in this example, has two rails 46 that disposed laterally across the vehicle. The rails 46 may be configured and extruded in a similar geometry to that described above relative to FIG. 2B. As is best illustrated in FIGS. 3B and 3C, an additional locating opening 54C may be provided to receive a fastener at each end of the rails 46 should two fasteners by used for coupling the receivers 44. In this example, the roof 24 has a plurality of recess 310 formed therein. The roof 24 may be molded and have the recesses 310 integrally molded therein. The recesses 310 are below the outermost surface of the roof 24. In this example, the recesses 310 are generally trapezoidal in shape. A first roof mount 320A and a second roof mount 320B are used to secure the rail 46 to the roof 24. Each roof mount 320A, 320B has an extension 322 that is shaped to be received within the recess 310. The shape of the extension 322 and the shape of the recess 310 can be such to prevent the roof mount 320A, 320B from being rotated relative to the roof during assembly.

The roof mounts 320A, 320B may be formed of a plastic or metal material. In both cases, the roof mounts 320A, 320B may be molded in an elongated shape. The extension 322 is located close to one end of the elongated shape of the roof mounts 320A, 320B. A second end of the roof mounts 320A, 320B have a fastener passage 324 that is used to receive a fastener 326. The fastener 326 has a head 326A and a threaded portion 326B. The head 326A is recessed within a mount recess 328 through which the fastener passage 324 extends.

At a second end of the roof mounts 320A, 320B, a receiver channel 330 is formed therein. The receiver channel 330 is recessed into the surface of the roof mounts 320A, 320B and is sized to receive the channel 50 of the rail 46. Fasteners 332 extend through the rail 46 and into fastener passages 334. During assembly, the roof mounts 320A, 320B are positioned so that the extensions 322 fits into the roof recess 310. The fastener 326 is received in the fastener passage 324 so that the head 326A is received in the mount recess 328. The rail 46 is then aligned so holes within the rails 46 align with the fastener passages 334. The fasteners 332 secure the rails 46 to the roof mounts 320A, 320B.

A cap 340 may be sized to be received within the channel of the rail 46 at each end. The cap 340 may be formed of various types of materials, such as plastic or rubber. Adhesive or a friction fit may be used to secure the cap 340 within the channel 50. As mentioned above, although the rails 46 are illustrated as extending laterally across the vehicle, the rails 46 may also be disposed longitudinally.

FIG. 3A shows a second rail 41 and a second set of roof mounts 321A, 321B position spaced apart from the first set of roof mounts 320A, 320B and configured the same.

Referring now to FIGS. 4A and 4B, a rail 46′ is illustrated disposed on the roof 24 longitudinally. The rail 46′ is similar to the rail 46 above in that the channel 50 has an elongated opening 52 having a plurality of regularly space elongated openings 54. A second rail 46′ is formed in a similar manner. The roof 24 has an upper side 24A and a lower side 24B. The rail 46′ extends between the upper side 24A and the lower side 24B of the roof 24. As is best illustrated in FIG. 4B, the channel 50 and the outer walls 48 may have an extension 410 extending therefrom. The extensions 410 in this example extends from an intersection of the side wall 48A and the bottom wall 48D, and the intersection of the side wall 46B and the bottom wall 48D. The extensions 410 and an upper flange 416 form a channel 414 on each lateral side of the rail 46′ that allows the roof material to be molded therein. The rail 46′ is thereby retained within the roof 24. Angular walls 418 extend between the upper surface 24A of the roof 24 and the wall 46A. Angular walls 420 extend between the lower surface 24B of the roof 244 and the extension 410.

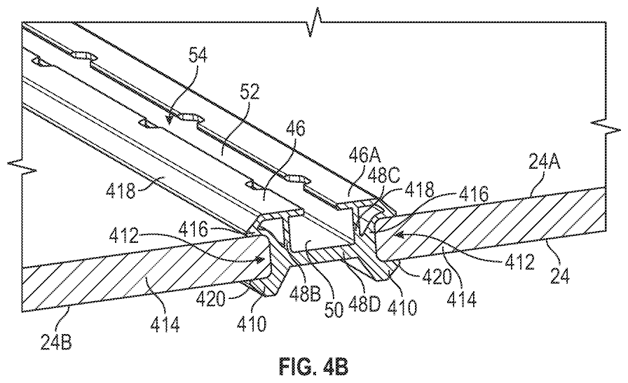

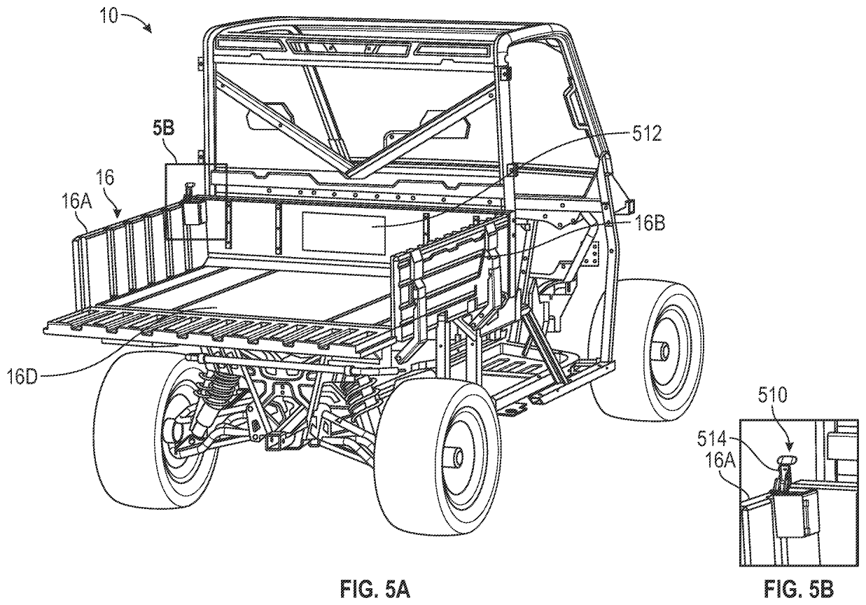

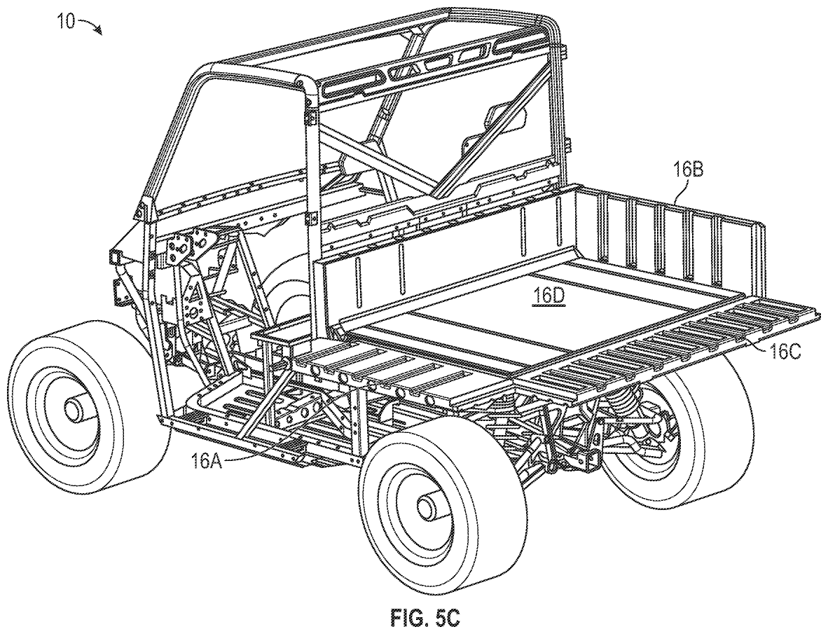

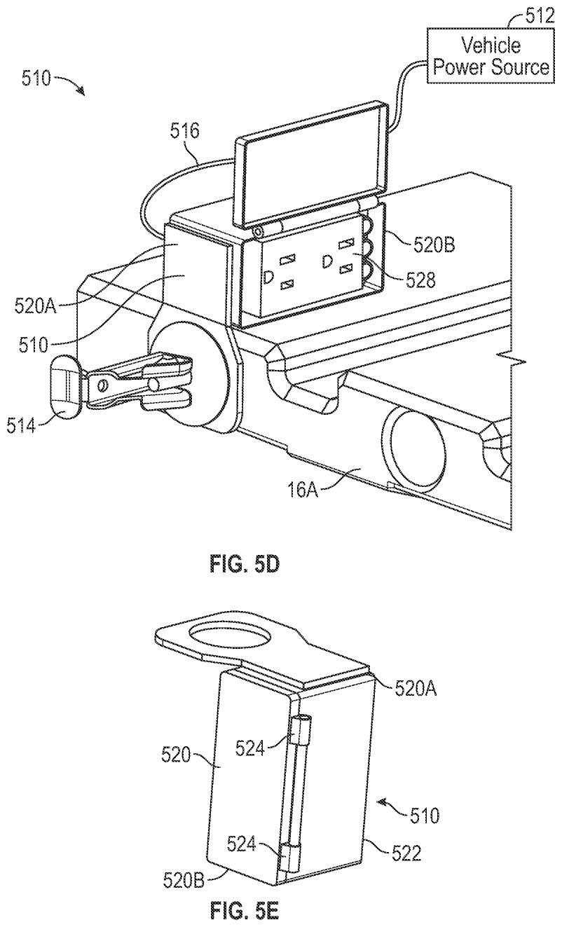

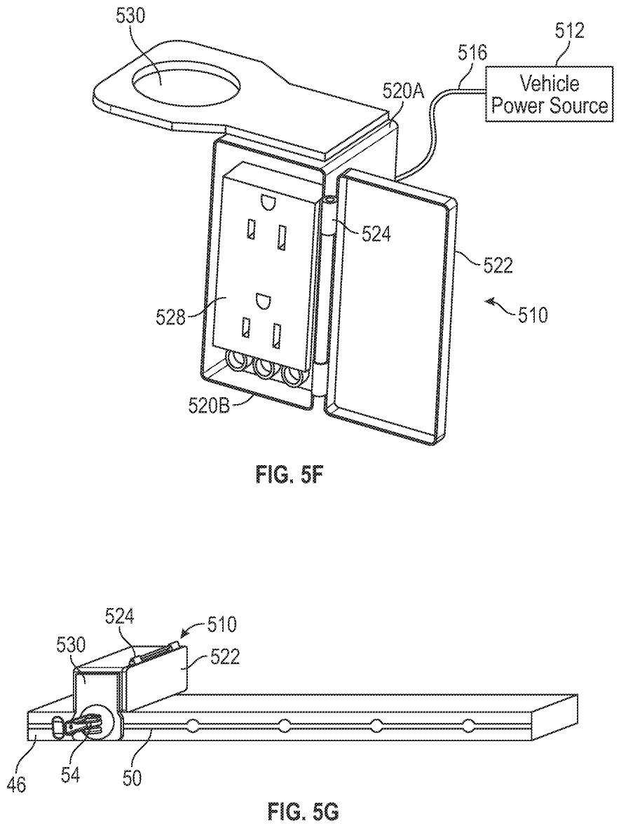

Referring now to FIGS. 5A-5G, the cargo box 16, as mentioned above, has one or more sides 16A-16C that fold into a flat position at a level corresponding to the load floor 16D. In this example, a power outlet assembly 510 is set forth coupled to one of the walls 16A, 16B and 16C. In this example, a retainer 514 secures the power outlet assembly 510 to at least one of the walls 16A, 16B. The retainer 514 may be removable so that the power outlet assembly 510 can be positioned in a desired location. Various types of retainers 514 are described below. As shown in FIG. 5G, the retainer 514 may couple the power outlet assembly 510 to a rail 46 and the 50 channel in the rail 46 rather than directly to a wall 16A, 16B.

The power outlet assembly 510 is coupled to a vehicle power source 512 through an electrical cable 516. The vehicle power source 512 may comprise a power inverter so that 120 volts of alternating current power is provided.

In FIGS. 5A and 5B, the power outlet assembly 510 is positioned on an upright wall 16A. However, in FIG. 5C, the upright wall 16A has been folded flat. The power outlet assembly 510 is coupled to the wall so that power outlet assembly 510 remains in place.

The power outlet assembly 510, as is best illustrated in FIGS. 5D-5F, has a housing 520. The housing 520 is preferably made from a durable material such as metal or plastic. The housing 520 is elongated and has a first end 520A and a second end 520B. In this example, the housing 520 forms a hollow rectangular prism.

The housing 520 has at least one side that forms a door 522. The door 522 may be closed when not in use. The door 522 is coupled to a hinge 524 so that the door 522 rotates relative to the housing 520. An electrical receptacle 528 is disposed within the housing 520. When the door 522 is closed, the receptacle 528 may be sealed from the exterior environment outside of the housing 520. In this example, the receptacle 528 is a 120-volt receptacle. However other types of receptacles such as 12-volt DC receptacle, a 240-volt AC receptacle or other types of voltages are found in different places of the world.

A bracket 526 is coupled to the first end 520A of the housing 520. The bracket 526 extends laterally from the first end 520A. The bracket 526 has an opening 530 therethrough. The opening 530 is used to receive a retainer 514. Of course, the style of retainer 514 and the sizes of the opening 530 depend on the wall and the mechanical configuration of the wall to which the bracket 526 will be coupled. Preferably, the opening 530 is surrounded by the bracket 526. However, depending upon the type of retainer 514, different types of openings 530 may be used.

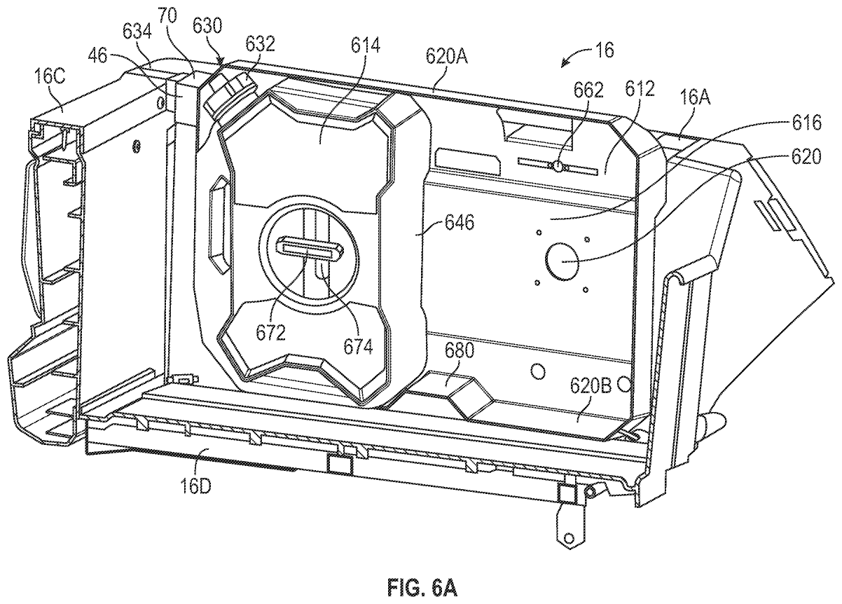

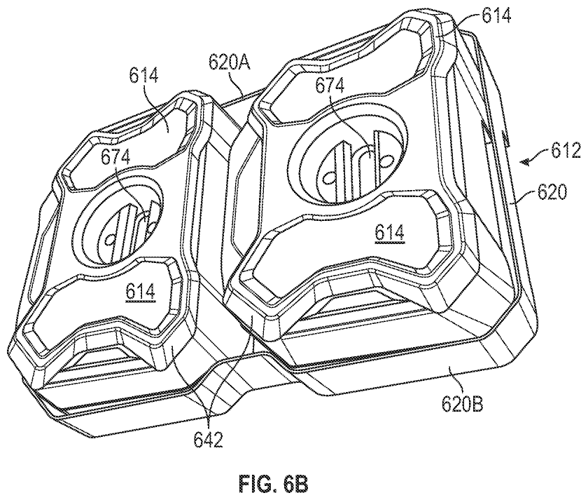

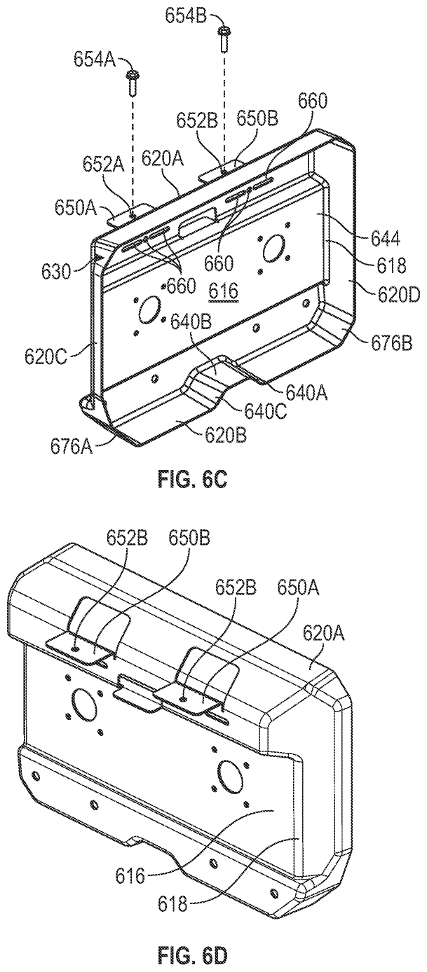

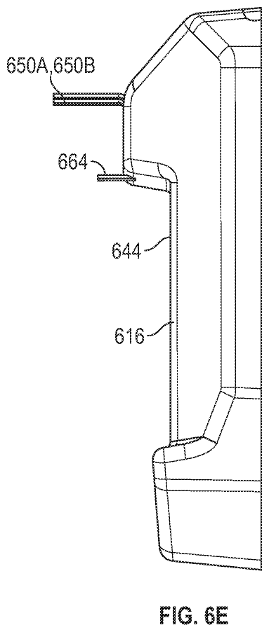

Referring now to FIGS. 6A-6E, the cargo box 16 is partially illustrated. In this example, a portion of the walls 16A and the door 16C are illustrated. Directly adjacent to the walls 16A, a fuel tank mount assembly 610 is set forth. The fuel tank mount assembly 610 has a housing 612 used for storing one or more accessory fuel tanks 614. In this example, accessory fuel tank 614 has the same shape. However, different shaped tanks may be used. The housing 612 is sized, in this example for two accessory fuel tanks 614. However, the housing 612 may be sized for one or more than two accessory fuel tanks 614. The housing 612 has a base 616 that is shaped to receive the accessory fuel tanks 614. The base 616 has an edge 618 therearound. The edge 618 may be considered a plurality of edges that surround the perimeter of the base 616. A plurality of sides 620 extend from the base 616 in a generally perpendicular direction. However, the side 620 may be slightly angular as is illustrated best in FIG. 6E. In this example, a first longitudinal side 620A defines an uppermost or topmost side. A second longitudinal side 620B extends generally parallel to the side 620A. A first lateral side 620C and a second lateral side 620D are disposed at the rear and front (relative to the vehicle) of the housing 612. Preferably, the perimeter formed by the longitudinal sides 620A, 620B and the lateral sides 620C, 620D are large enough to fit the accessory fuel tanks 614 therein.

An anti-cap removal feature 630 is illustrated in FIG. 6A. The anti-cap removal feature 630 prevents a cap 632 from the fuel tank 614 from being removed when the accessory fuel tank 614 is stored within the housing 612. The anti-cap removal feature 630 comprises an angular wall 634 that extends between the first longitudinal side 620A and the first lateral side 620C. The cap 632 unscrews and therefore the angular wall 634 is positioned directly adjacent to the cap 632 so that the cap 632 cannot be unscrewed in the direction of the angular wall 634.

The second longitudinal side 620B includes a position formation 640. The position formation may be formed of three walls 640A, which is angular, a wall 640B, which is generally horizontal, and another angular wall 640C. The angular walls 640A and 640C extend angularly from the wall 640B to the longitudinal side 620B. Features in the accessory fuel tank 614, such as the angle portions 642, directly align with the position formation 640. This allows the accessory fuel tanks 614 to be positioned in place.

The base 616 may also be contoured to correspond to contours in the accessory fuel tank 614. As is best shown in FIG. 6C, a raised portion 644 of the base corresponds to a recessed portion 646 in the accessory fuel tank 614 as best illustrated in FIG. 6A.

The base 616 also includes a first bracket 650A and a second bracket 650B that has corresponding openings 652A, 652B. The brackets 650A, 650B are used to secure the housing 612 to one of the side walls 16A, 16B of the cargo box 16. The openings 652A, 652B are sized to receive a retainer 654A, 654B which are simplistically illustrated in FIG. 6C. The retainers 654A. 654B may be received and secured to the walls of the cargo box 16 the rail 46. As mentioned above, the rails 46 may have two different retainers in a double channel receiver 70 as illustrated above. The base 616 may include openings 660 that are used to receive a fastener 662 as illustrated in FIG. 6A or one of the retainers described below. The fastener 662 acts as a retainer to retain the base 616 and therefore the housing 612 to the double channel receiver 70. One of the surfaces of the double channel receiver 70 is located on the inside edge of the cargo box 16. Thus, the fasteners 662, the retainers 654A, 654B or both may be used for securing the housing 612 within the cargo box 16.

A locating feature 664 may also extend from the base 616 toward the wall of the cargo box 16. The locating feature 664 may extend in the direction of the bracket 650A, 650B but not as far as illustrated in FIG. 6E. The locating feature 664 may prevent installation into a position that is undesirable by the manufacturer. For example, the locating feature 664 may prevent the housing 612 from being installed within a passenger compartment. The locating feature may fit into a slot 210 (shown in FIG. 2) in the cargo bed wall 16A or other desired location of the vehicle. No slot will prevent the base from positioning properly.

The base 616 may also include lock openings 670. The lock openings 670 are provided so that a lock handle 672 engages the lock opening 670 to retain the accessory fuel tanks 614 therein. The lock handle 672, in FIG. 6A, is illustrated in a locked position. However, when the lock handle 672 is turned 90° into the unlocked position 674, the accessory fuel tank 614 may be uninstalled or disassembled from the housing 612.

Angular corner walls 676A, 676B correspond to angular corners of the accessory fuel tank 614. By providing a snug fit and with the lock handle 672, the accessory fuel tank 614 may maintain its position within the housing 612.

As is best shown in FIG. 6C, the handle 672 is rotatably mounted to a base 678 that is secured to the base 616 with fasteners 680. The fixed base 682 aligns with the opening 674 in the fuel tank 614 whereby the handle 672 rotates to hold the fuel tank 614 into position. Optionally, a lock 684 can be provided to lock the handle 672 in place. Although FIG. 6C shows the handle assembly in one position for contrast, both positions are likely to have a handle assembly.

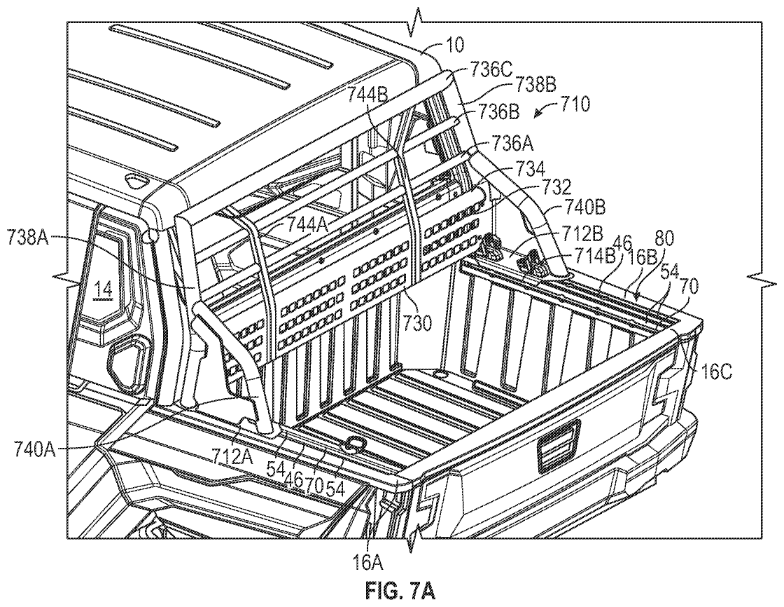

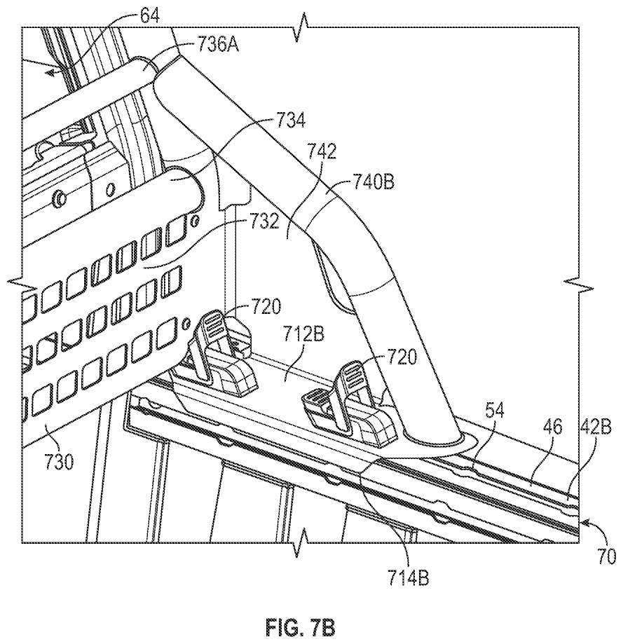

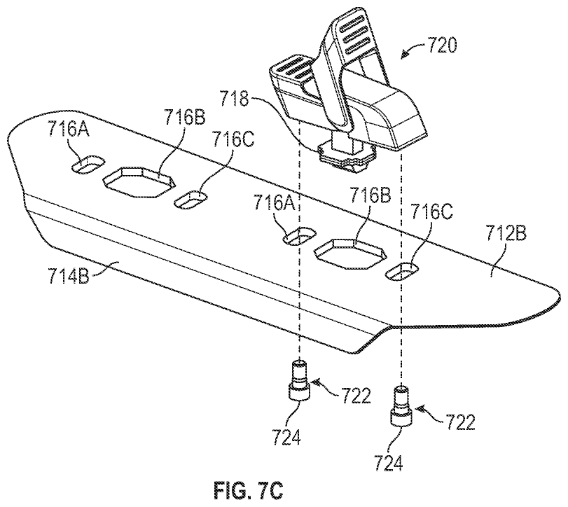

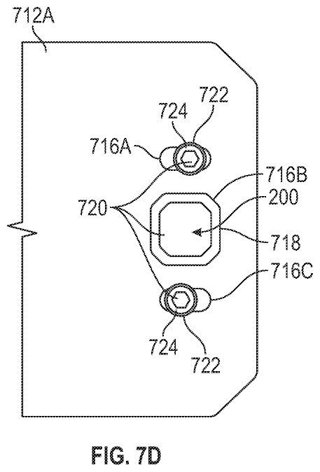

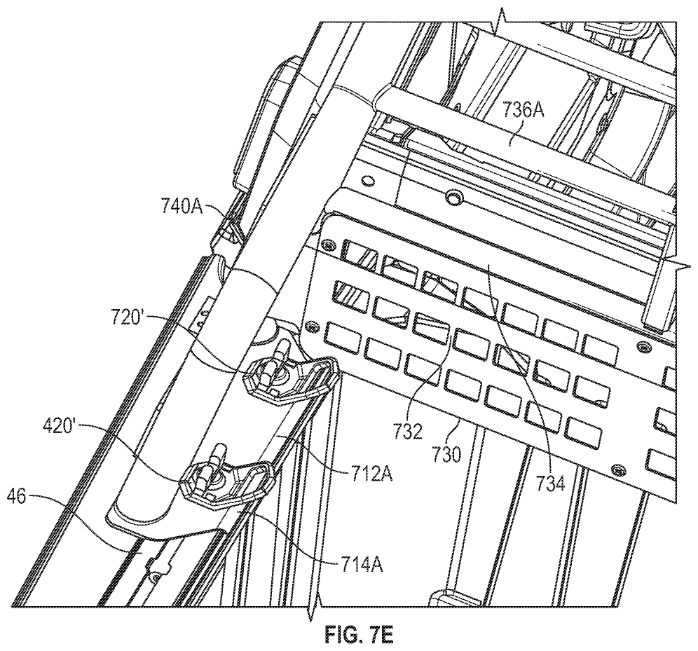

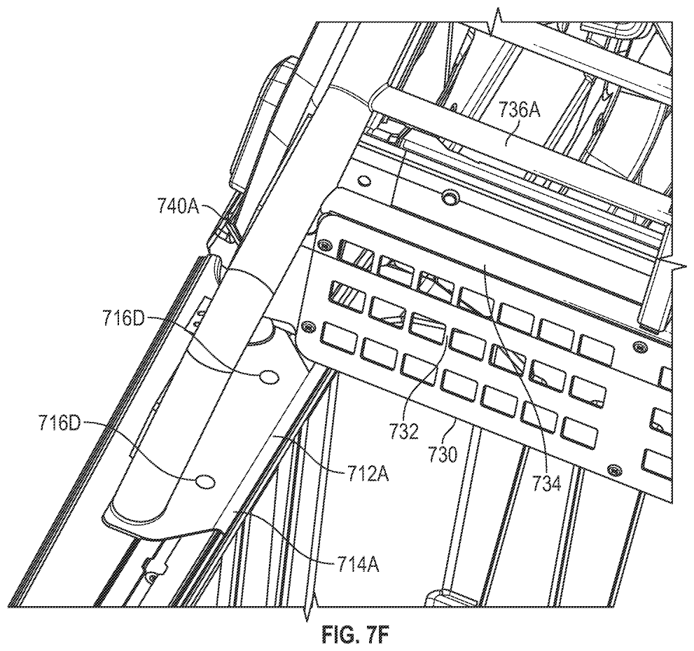

Referring now to FIGS. 7A-7F, a headache rack assembly 710 is illustrated. The headache rack assembly 710, as illustrated, is coupled to sides 16A, 16B of the cargo box 16. The headache rack assembly 710 is coupled to the retaining system 40 of the cargo box 16. In particular, the cargo box 16 has a double channel receiver 70 described in detail above. However, a single rail 46 may also be incorporated instead of the double channel receiver 70. The headache rack assembly 710 is thus coupled to the horizontal rail 46. The headache rack assembly 710 may be located or fixed to two locating openings that are not visible due to being covered by the headache rack assembly 710. In this manner, the headache rack assembly 710 may also be positioned into a desired position corresponding to two adjacent locating openings 54. A headache rack assembly 710 is used to prevent objects within the cargo box from moving forward toward the passengers within the passenger area 14 of the vehicle 10.

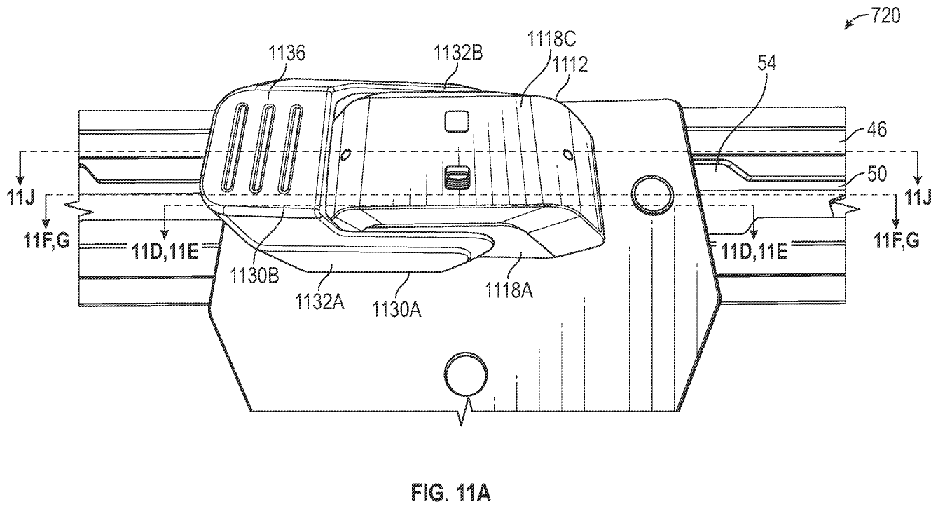

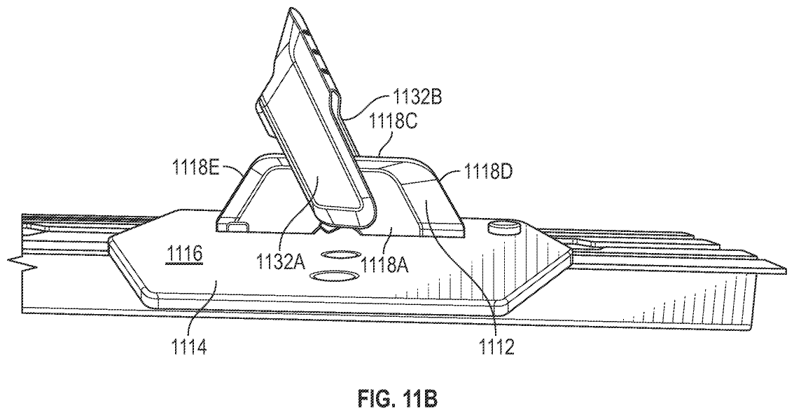

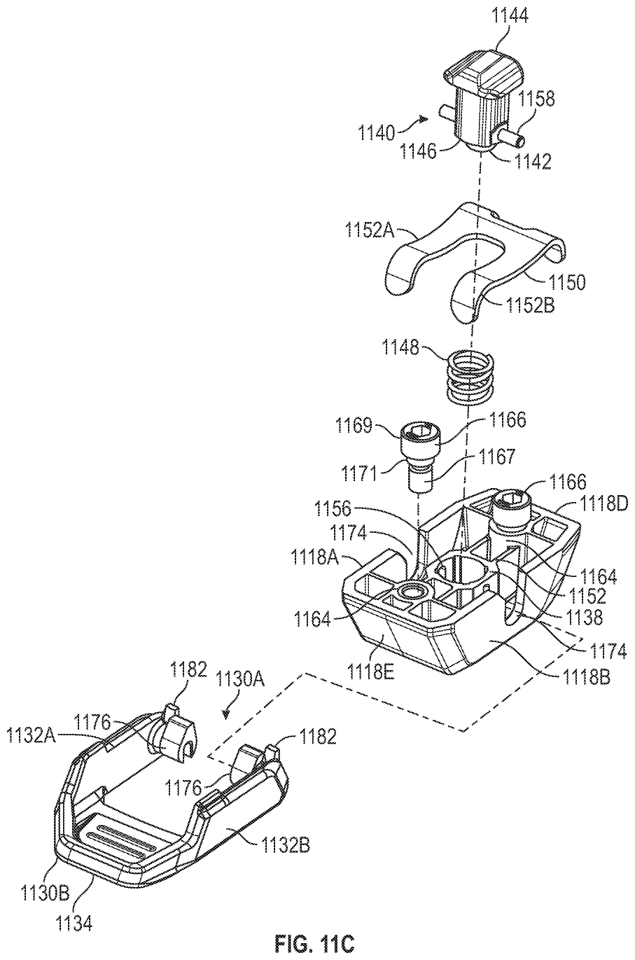

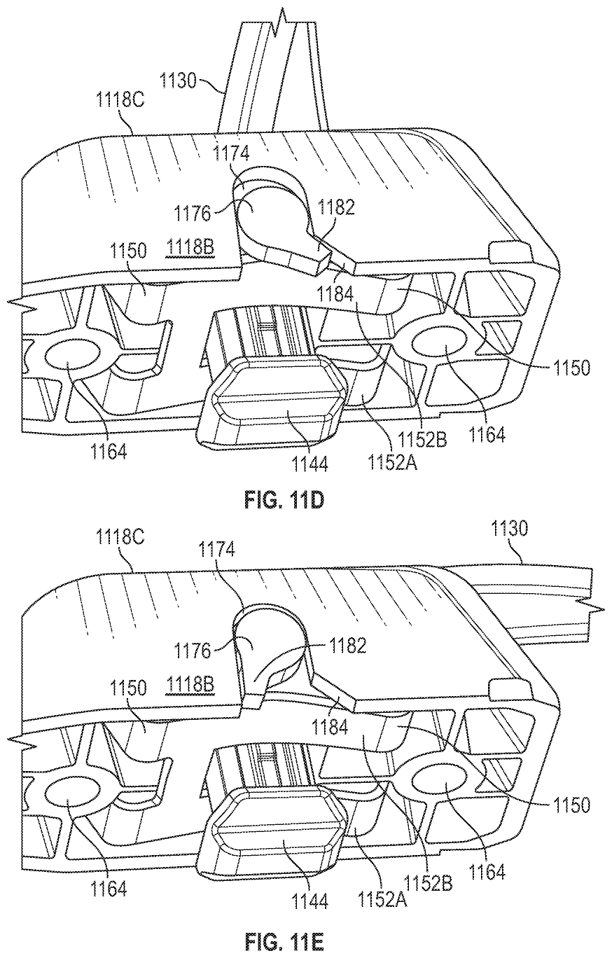

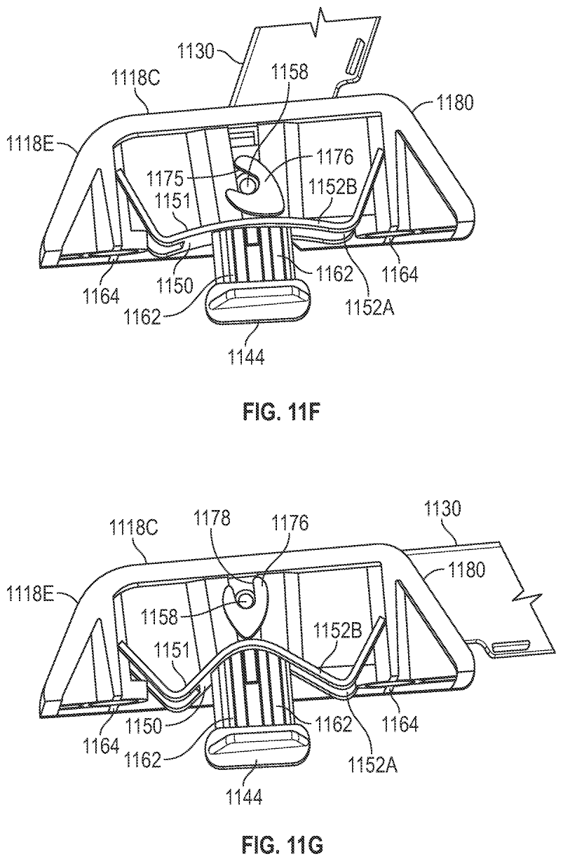

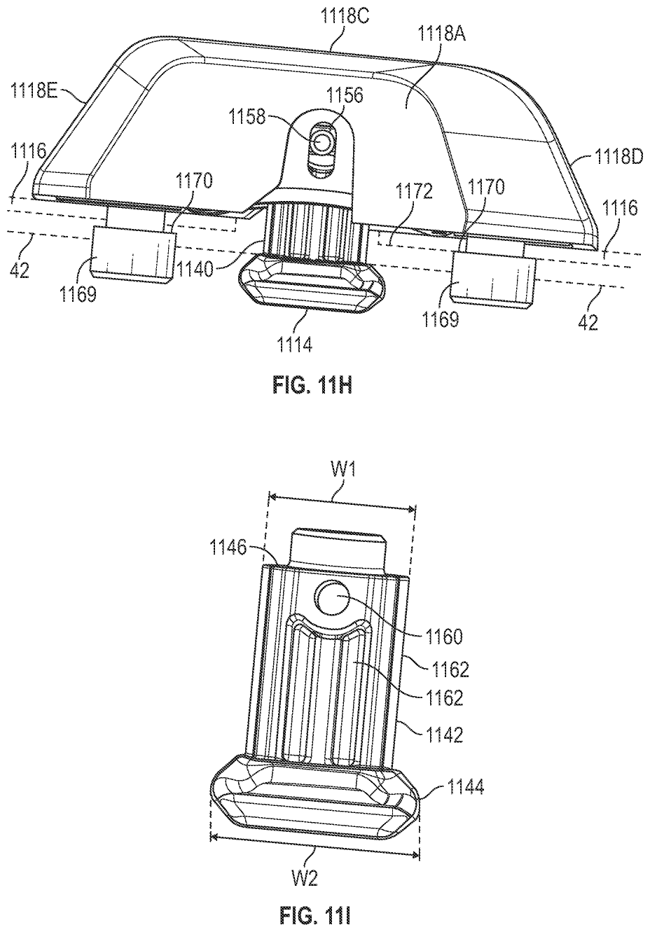

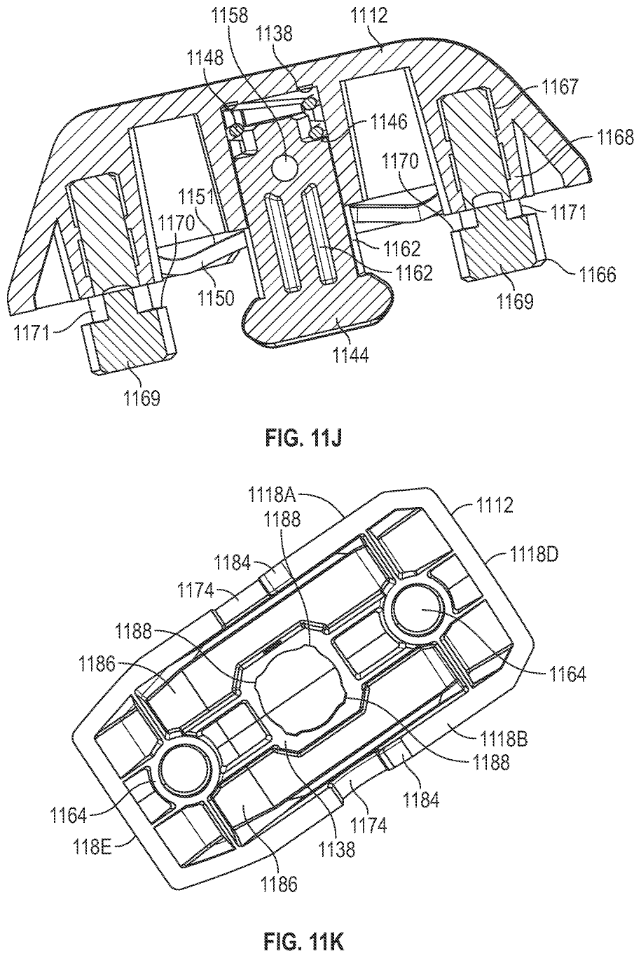

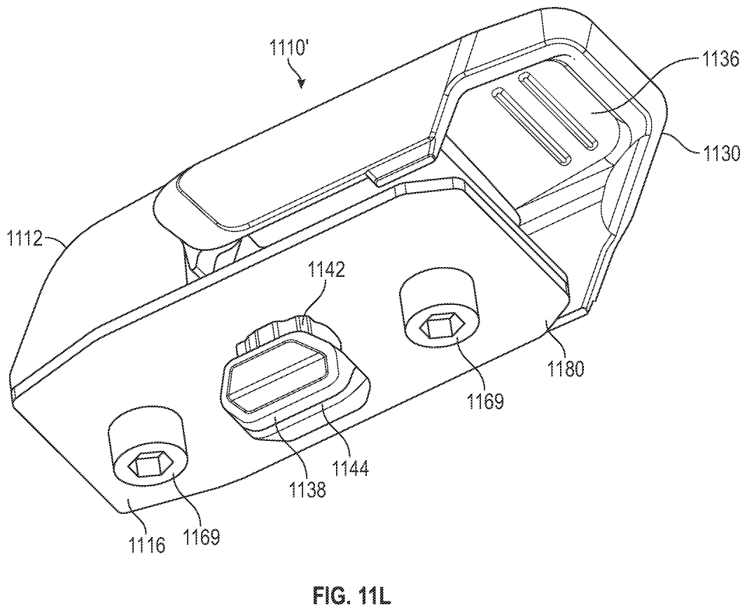

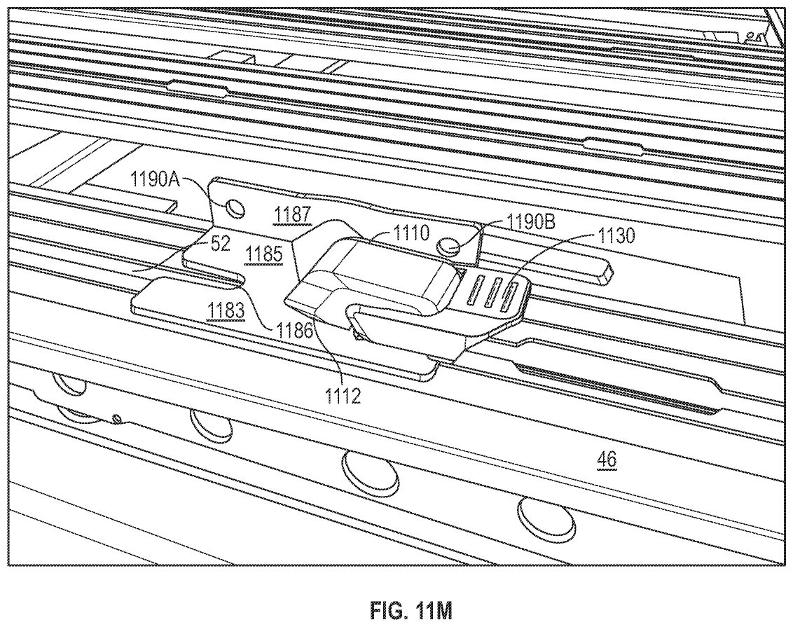

The headache rack assembly 710 may be formed of durable material such as metal or hard plastic. The headache rack assembly 710 may be formed of steel. The headache rack assembly 710 includes a headache rack base 712A, 712B. Bases 712A, 712B are positioned adjacent to the rails 46 on the side walls 16A, 16B of the cargo box 16. The base 712 may each have a flange 714A, 714B that is perpendicular to the respective bases 712A, 712B. The flange 714A, 714B is thus located within the cargo box 16 and is directly adjacent to the rails 46 as is best illustrated in FIG. 7C. The base has a plurality of openings 716A, 716B and 716 for receiving a retainer 720 therein. The retainer 720 is further described in more detail below in FIGS. 11A-11M. The bases 712A, 712B may act as the cover plate (1180 of FIG. 11L) for the retainer 720 as illustrated in FIGS. 11L and 11M. The retainer openings 716B are regularly spaced and correspond to the locating openings 54. The retractable or moving portion 718 of the retainer 720 is used to engage the locating openings 716B and therefore are received by the receiver 44 for retaining the headache rack assembly 710 to the vehicle 10. Fasteners 722 extend from the retainer 720 to engage openings 716A, 716B. The retractable or moving portion 718 and the heads 724 engage elongated openings 52. More specifically the retractable or moving portion 718 is received into the locating opening 54 for that the retractable portion may be coupled within the rail 46 to hold the rack in place.

The base 712A and the base 712B have a cross member 730. The cross member 730 is adjacent to a molle panel 732. The molle panel 732 is a web of plastic or metal material that allows items or accessories to be coupled thereto through the use of hook, clip or the like. The molle panel 732 is bounded by a second cross-member 734. A plurality of other cross members 730A, 736B and 736C are generally horizontal and extend between generally vertical members 738A, 738B. The shape of the vertical members 738A, 738B may follow the contour of the vehicle. Support members 740A, 740B extend between the bases 712A, 712B and the respective generally vertical members 738A, 738B.

Flanges 742A, 742B are located adjacent to respective bases 712A, 712B, the vertical members 738A, 738B and the support members 740A, 740B. The flanges 742A, 742B may provide structural support and ornamental design to the headache rack assembly 710.

Intermediate members 744A, 744B extend between the cross member 734 and the cross member 736. The intermediate member 744A may be used to strengthen the headache rack assembly 710 as well provide aesthetic ornamentation.

Referring now to FIG. 7D, a bottom view of a portion of the base 712A is illustrated relative to the retainer opening 716A, 716B, 716C. The head 724 of the fastener 722 of the retainer 720 are received within the openings as will be described in more detail below. The base 712A as mentioned above, may act as a cover to the retainer 720. The center opening 716B may have a moving portion 718 such as a plunger foot of the retainer 720 that is used to engage the rail 46 as described in more detail in FIG. 11.

Referring now to FIGS. 7E and 7F, a different type of retainer 720′ is illustrated and used for retaining the base 712A and flange 714A to the rail 46. In this example, the retainers 720′ have openings for fixing or securing items within the cargo box 16. In this example, the retainer openings 716D are circular for receiving the retainer 720′. FIG. 7F shows the opening without the retainer.

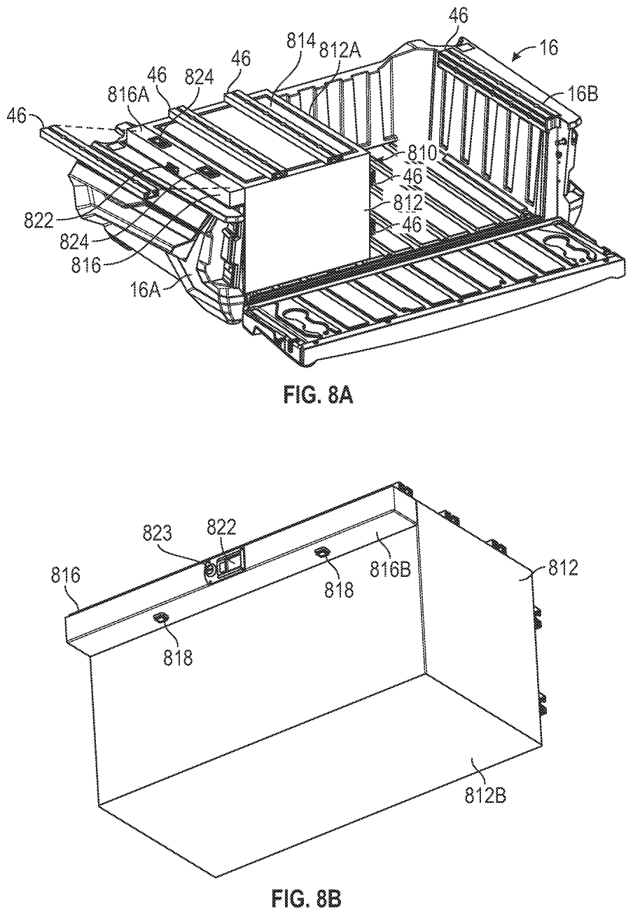

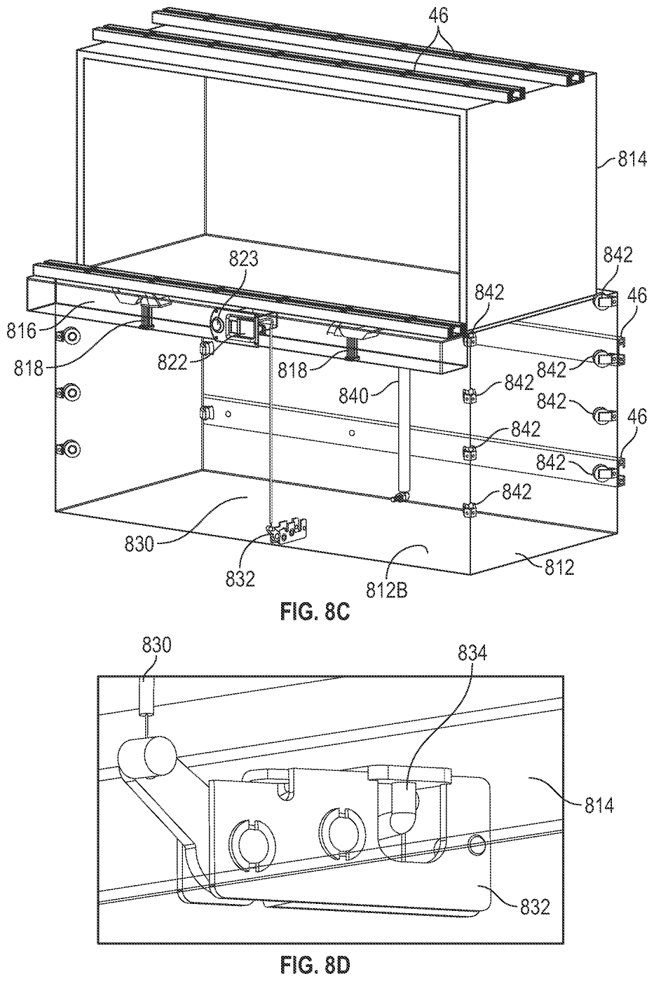

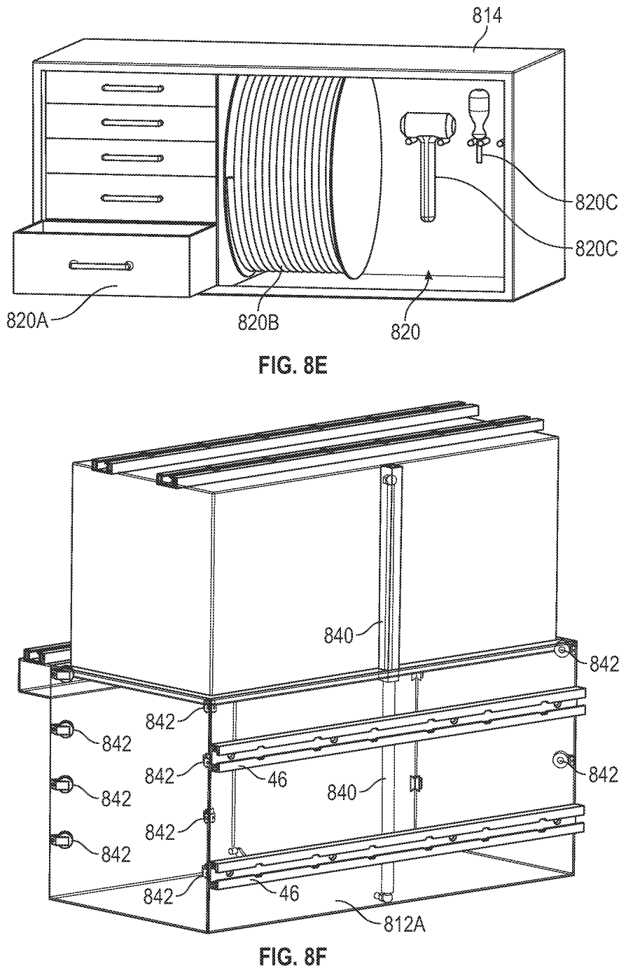

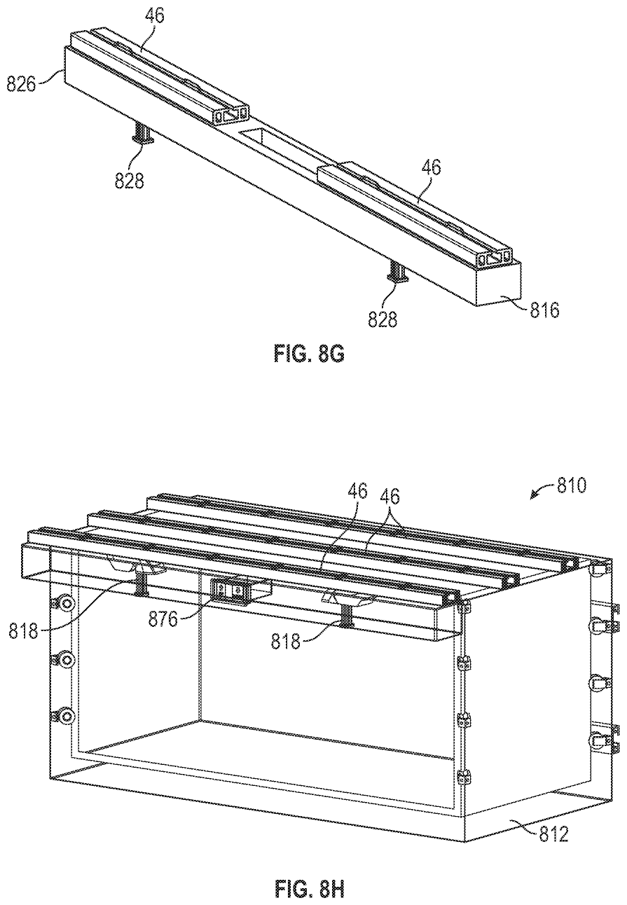

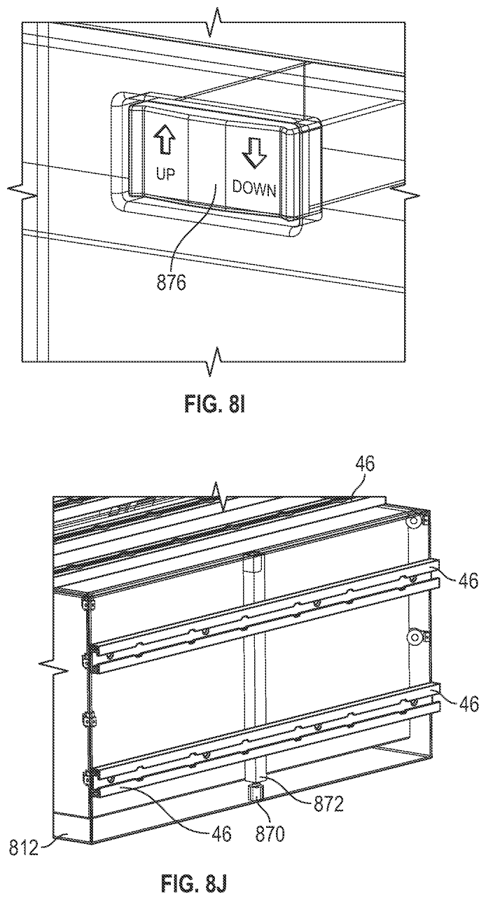

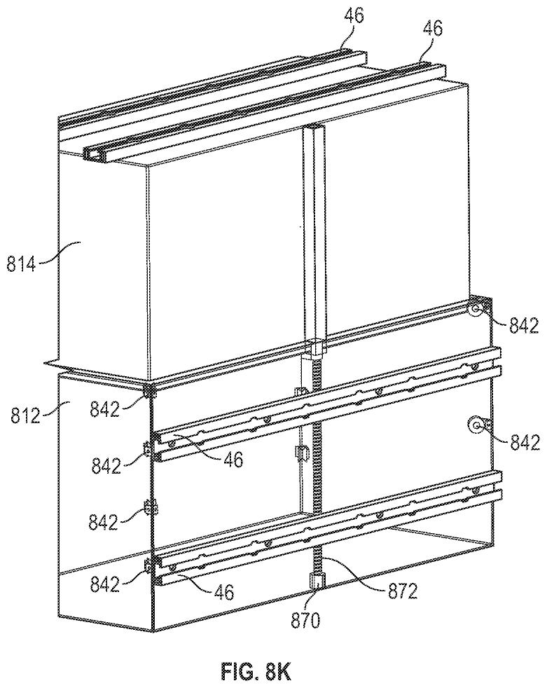

Referring now to FIGS. 8A-8J, a cargo box 16 of the vehicle 10 is set forth. The cargo box 16 has a rising storage box assembly 810 disposed therein. The rising storage box assembly 810 is in a retracted position in FIGS. 8A and 8B and in an extended position in FIG. 8C. The rising storage box assembly 810 comprises a receiver housing 812. The receiver housing 812 in this example is a rectangular solid. The receiver housing 812 comprises an inner housing 814. The inner housing 814 is extended in FIG. 8C in a vertical direction relative to the cargo box 16 of the vehicle 10. A coupler 816 extends from the receiver housing 812. The coupler 816 has a first side 816A shown FIG. 8A and a second side 816B shown best in FIG. 8B. Retainers 818, two of which are used in this example, are used to couple coupler 816 to the rail 46 on the first side 16 of the cargo box 16. FIG. 11A-11M below show examples of suitable retainers. The retainers 818 are disposed in respective recesses 824 in the first side 816A so that they are out of the way and within the coupler 816. Another rail 46 may be disposed over the recesses 824 and fixed to the coupler 816. The retainers 818 extend through the second side 816B and engage a rail 46 on the first side 16A which is covered in FIG. 8A but is illustrated above in various figures. The retainers 818 allow the rising storage box assembly 810 to be securely placed and maintain its position during the operation of the vehicle 10. As illustrated best in FIG. 8D, stored items 820, such as drawers 820A, wire 820B, and various tools 820C may be placed within the inner housing 814. When the inner housing 814 is closed in a retracted position, the receiver housing 812 prevents the stored items from leaving the rising storage box assembly 810.

The rising storage box assembly 810 is illustrated having two rails 46 disposed on a top side of the inner housing 814. Likewise, one rail 46 is shown disposed on the coupler 816 and two on a wall 812A of the receiver housing 812 adjacent (within) the cargo box 16. This allows the rising storage box assembly 810 to be used to be secured to various articles to the cargo box 16 in various positions. The number and position of the rails 46 may vary including providing not rails 46 on the rising storage box assembly 810.

As is best shown in FIGS. 8C and 8D, the coupler 816 has a latch activator 822, which could be a button or handle. The latch activator 822 may be used to unlatch the inner housing 814 from the receiver housing 812 and allow the inner housing to rise relative to the receiver housing 812. A lock 823 may lock to prevent the latch activator 822 from allowing the inner housing 814 to rise. In FIG. 8C the lock 823 is in an unlocked position. The latch activator 822 is coupled to a rod or cable 830 that is used to engage and disengage a latch 832 disposed on a floor 812B of the receiver housing 812. The latch 832 illustrated is a rotary latch. However, other types of latches may be used. In this example, the activator 822 moves the rod or cable 830 to release the catch 834 affixed to the underside of the inner housing 814. As long as one side of the latch is coupled to the receiving housing 812 and one to the inner housing, different types of latches may be used including but not limited to a sliding bolt latch or a gate latch.

Referring now to FIGS. 8C and 8F, one or more gas struts or springs 840 are used to assist the lifting of the inner housing 814 relative to the receiver housing 812 when the activator 822 releases the catch 834. That is, one end of the gas spring 840 is affixed to the receiver housing 812 and one end to the inner housing 814. The gas spring 840 illustrated in FIG. 8A is retracted (and out of view) while the gas spring 840 in FIGS. 8C and 8F is extended. Further, linear guides 842 may be located at each corner to allow the inner housing 814 to lift relative to the receiver housing 812 in a straight manner. To lift the inner housing 814, the activator 822 release the latch from the catch and the gas spring 840 pushes the inner housing 814 up and out of the receiver housing 812.

In FIG. 8F, a supplemental coupler 826 also has rails 46 disposed thereon. The supplemental coupler 826 may be coupled to the side walls 16A, 16B of the cargo box 16. That is, retainers 828 extending from the bottom of the supplemental coupler 826 are received in the rails 46 on the side walls 16A, 16B. The level of the rails 46 on the supplemental coupler 826 is thus the same as the rails 46 on the coupler 816 to allow it to be easier to couple components thereto.

Referring now to FIGS. 8H to 8K, an electric version of the rising storage box assembly 810 is shown. The gas spring 840, described above, is replaced with a motor 870 and screw assembly 872 which are used to lift the inner housing 814 relative to the receiver housing 812. Guides 842 are also illustrated. The button 876 has an up, down and neutral position (for maintaining the position of the inner housing) is used to provide power (such as vehicle power not illustrated in this figure) to the motor 870.

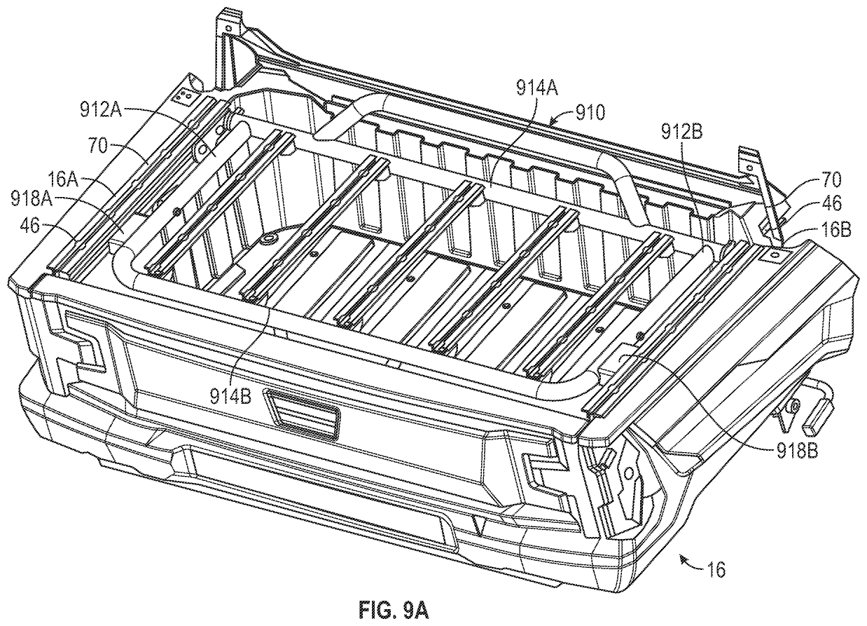

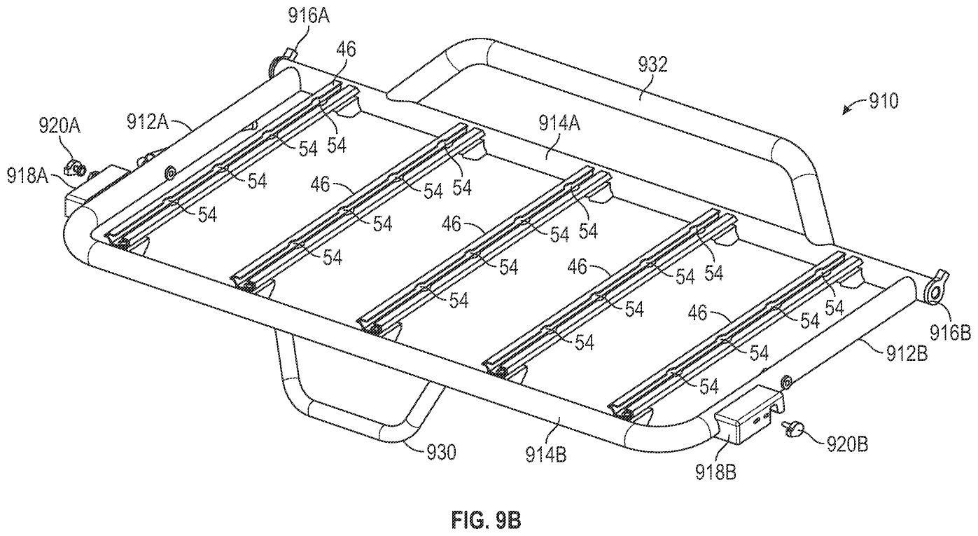

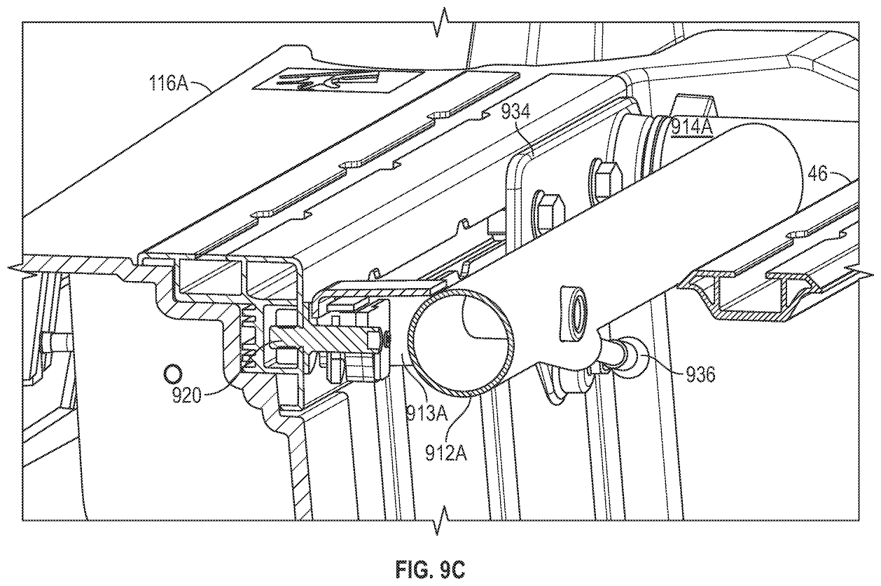

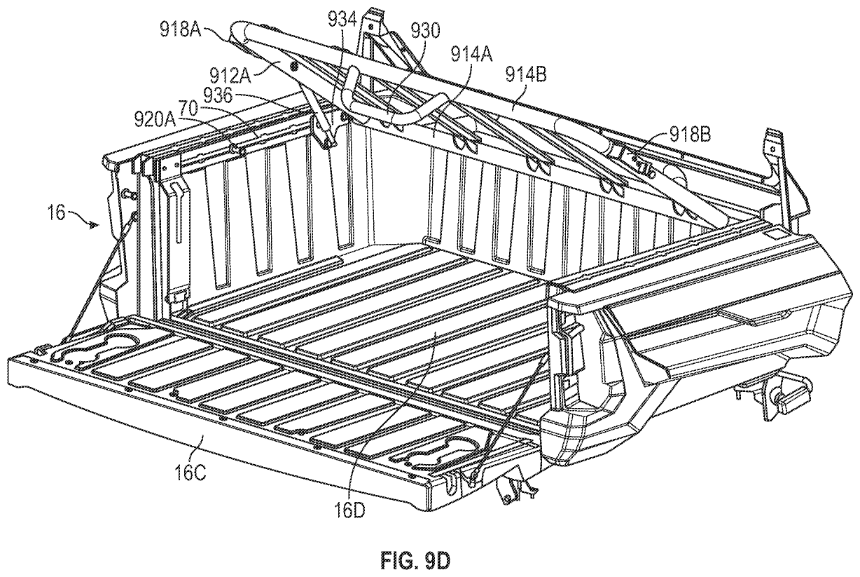

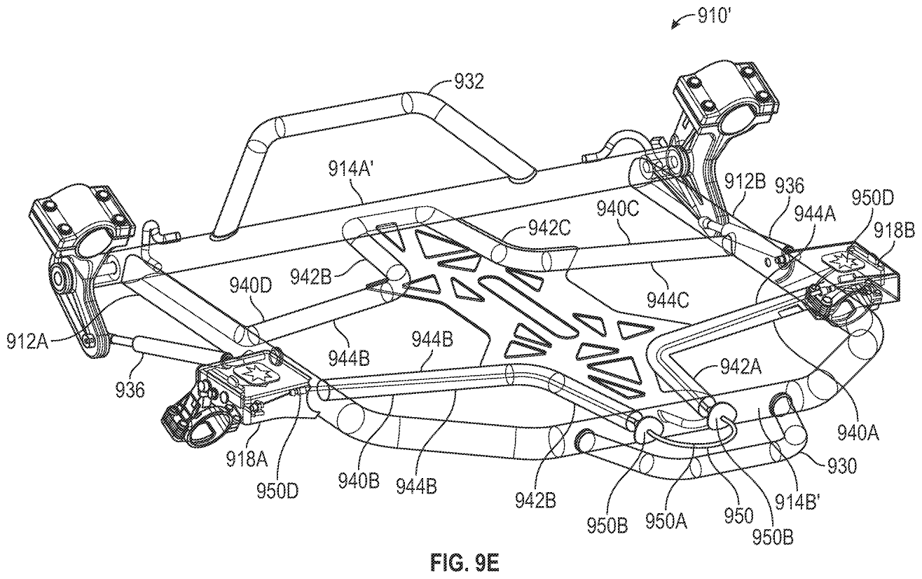

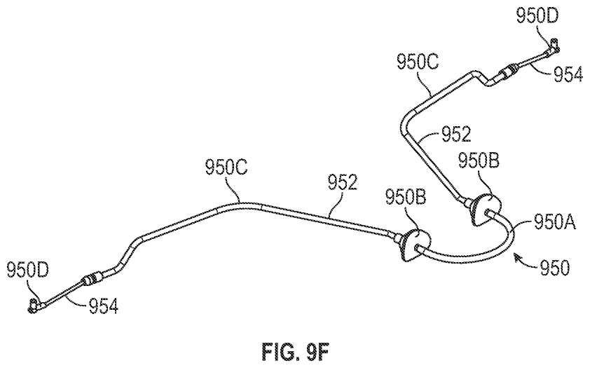

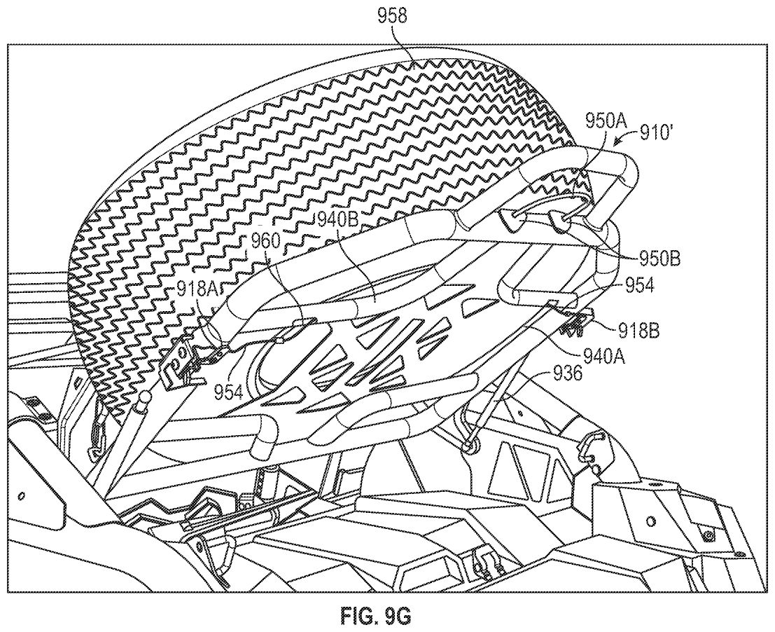

Referring now to FIGS. 9A-9D, a rack assembly 910 is illustrated. The rack assembly 910 is disposed within the cargo box 16. In the present example, the rack assembly 910 is flush with the rails 46 on the side walls 16A, 16B. The rack assembly 910 may be used for various purposes including but not limited to holding a spare tire.

The rack assembly 910 includes a first side member 912A and a second side member 912B. The first side member 912A and the second side member 912B are parallel to each other. The side members 912A, 912B are also parallel to the side walls 16A, 16B. The side members 912A, 912B extend between lateral members 914A, 914B. The lateral members 914A, 914B are parallel to each other and perpendicular to the side members 912A, 912B. The side members 912A, 912B and the lateral members 914A, 914B are formed from a tube material. The material may be metal composite or combinations thereof.

The lateral member 914A is rotatably coupled to the double channel receiver 70 disposed on both sides of the cargo box 16 at the walls 16A, 16B. The pivot point is fixed but allows the rack and the lateral member 914A to rotate thereabout. Bearings 916A, 916B may be located at opposite ends of the lateral member 914A to facilitate the movement relative to the double channel receiver 70.

It should be noted that the double channel receiver 70 has vertical walls to which the lateral member 914A is rotatably coupled.

A latch mechanism 918A, 918B are disposed on the side members 912A, 912B, respectively. A first striker plate 920A and a second striker plate 920B are mounted to vertical walls of the double channel receiver 70 and allow the respective latch mechanisms 918A, 918B to latch thereon to maintain the rack assembly 910 in a stored position.

The rack assembly 912 may also have a plurality of rails 46 disposed between the lateral members 914A, 914B. In this example, five rails 46 are disposed therebetween. The rails 46 may be configured in the manner described above in FIG. 2B.

A support 930 is coupled to the lateral members 914B. The support 930 may rest against the moving wall 916C.

In addition, a rack front member 932 extends from the lateral member 914A. Both the support 930 and the rack front member 932 extend laterally are loop shaped.

In FIG. 9C, a cross section of the area of the striker plate 920 joining the latch mechanism 918A is set forth.

In this example, a pivot plate 934 is shown coupled to the double channel receiver 70. The pivot plate 934 remains fixed while the rack assembly including the side members 912A, 912B, the lateral member 914A, 914B and the rails 46 move. A lift mechanism 936, such as a gas spring 840, has one end fixed to the pivot plate 934 and a second end coupled to the lateral member 914A. It should be noted that a pivot plate 934 and the lift mechanism 936 may be duplicated on the opposite side of the rack assembly 910. As illustrated in FIG. 9D, when lifting up on the rack assembly 910 in the area of the support 930, the lift mechanism 936 assists the lifting as the lateral member 914A pivots at the pivot plate 934.

The lift mechanism 936 may be implemented together with the latch mechanism 918A, 918B described above. The latch mechanisms 918A, 918B may, however.

Referring now to FIGS. 9E-9G, an alternate configuration for a rack assembly 910′ is set forth. The rack assembly 910′ has internal tubular member 940A, 940B, 940C and 940D. The tubular members 940A and 940B have generally longitudinally extending portions 942A, 942B. Likewise, tubular members 940C and 940D have generally longitudinally extending portions 942C, 942D. The tubular members 940A-940D also have generally laterally extending portions 944A, 944B, 944C and 944 D. The tubular members 940 may be generally planar and used to support a tire or other tools or implements. The lift mechanism 936 may be implemented together with the latch mechanism 918A, 918B described above. The latch mechanisms 918A and 918B may, however, be controlled by a cable actuator 950. The cable actuator 950 is also illustrated in further detail in FIG. 9F. The cable actuator 950 is a single cable assembly that is used to activate (unlatch) both of the latches 918A, 918B at the same time. The rack has a laterally tubular member 914B′ and 914A′. The rack assembly 910′ may also include side members 912A, 912B. The side members 912A, 912B, the lateral members 914A′, 914B′ as well as the tubular members 940 may all form a plane onto which implements or a wheel may be assembled.

The cable actuator 950 has a handle portion 950A that acts as a grab handle for releasing the latch mechanisms 918A, 918B. The handle portion 950A may be tubular and surround the underlying cable. Retainers 950B are used to retain the cable actuator 950 within openings of the lateral member 914B′. The cable actuator 950 has internal portions 950C that extend within respective tubular members 940A, 940B. In FIG. 9E, the end of the cable 950D extends through the tubular members 940A, 940B to the latches 918A, 918B through the side members 912A, 912B.

The cable actuator handle portion 950A may be coated material on the underlying cable. Likewise, portions 950C may further have a sleeve 952 that protects the cable 954 therein.

Referring now to FIG. 9G, a wheel 958 is shown coupled to the rack assembly 910′. An opening 960 is shown in the lateral portions 944A, 944B. The ends of the cable actuator 950 extend from the opening 960 to the latch mechanism 918A, 918B.

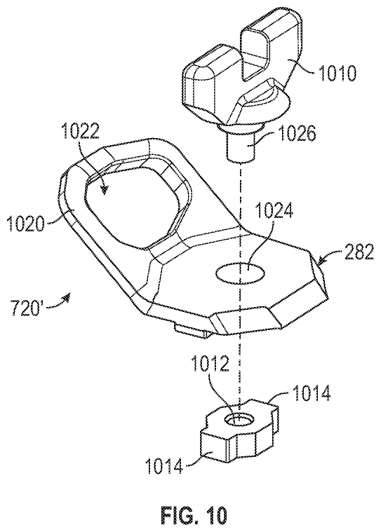

Referring now to FIG. 10, the retainer 720′ is illustrated in further detail. The retainer 720′ includes a fastener 1010 that is coupled to a nut 1012. The nut 1012 has extensions 1014 that extend in opposite directions therefrom. The nut 1012 and the extensions 1014 may be received in the locating openings 54 described above. The nut may be moved within the channel away from the locating openings 54 so that the nut 1012 is positioned within the channel. A D-ring 1020 has an opening 1022 that may be used for coupling to various accessories. A fastening opening 1024 receives a threaded end 1026 when tightened, the fastener 1010 secures the D-ring 1020 in a particular location within the channel 50 of a rail 46.

Further details of the retainer 720 are set forth above. As illustrated above, the retainer 720 may be used to fix the headache rack or other accessories to rails 46 in the vehicle.

Referring now to FIGS. 11A and 11B, another example of a retainer 1110 is set forth. The retainer 1110 is shown relative to a rail 46 having a receiver 44 disposed therein. The rail 46 and the receiver 44 were described in further detail above. The rail 46 and the receiver 44 form the channel 50. Ultimately, the retainer 1110 is secured to the rail 46 and the outer wall 48 that defines the channel 50.

A housing 1112 is mounted to an article 1114, a portion of which is illustrated. The article 1114 has an article wall 1116. The article wall 1116 and the housing 1112 are coupled together to form the retainer. The article 1114, one or more retainers 1110 are used to secure an article 1114 to the rail 46. As mentioned above, examples of articles include but are not limited to tool mounts, utensil mounts, coolers and other equipment. The retainer 1110 may secure the article 1114 in a bed of a utility vehicle, on the side of utility vehicle or on a wall of a utility vehicle. However, the retainer 1110 may also be used outside of the automotive vehicle setting such as for storage in a building.

The housing 1112 is formed from a plurality of surfaces. In the present example, the surfaces 1118 generally form a trapezoid shape when viewed from the side view. That is, the surfaces 1118 include two generally trapezoid shape surfaces 1118A and 1118B. A top surface 1118C extends between the side surfaces 1118A, 1118B and two angular surfaces 1118D and 1118E. The surfaces 1118 enclose the interior of the housing 1112 together with the article wall 1116. While the surfaces 1118 and the article wall 1116 form a trapezoid solid, other shapes such as rectangular solid or an irregular solid shape may be formed. The housing 1112 may also have an additional surface 1118 adjacent to the article wall 1116. That is, the underside of the housing 1112 may also be enclosed with a wall that is ultimately fastened to the article 1114 or article wall 1116 of the article 1114.

A lever 1130 is rotatably coupled to the housing 1112. The lever 1130 has a first end 1130A and a second end 1130B. The first end rotates relative to the housing 1112. In this example, the first end 1130A has a first arm 1132A and a second arm 1132B. The arms 1132A, 1132B are directly adjacent to the surfaces 1118A and 1118B. A handle 1134 extends between the first arm 1132A and the second arm 1132B. In the example of FIG. 11A, the retainer 1110 is locked to the rail 46 when the handle 1134 is rotated and is closer to the article wall 1116. The retainer 1110 is unlocked in FIG. 11B and slidable relative to the rail 46 when the handle 1134 and thus the lever 1130 is rotated away from the article wall 1116 as illustrated in FIG. 11B. Of course, the handle and the locking position may be reversed depending upon how the lever 1130 is formed as will be further described below.

The handle 1134 has a gripping surface 1136 disposed thereon. In this example, the gripping surface 1136 comprises a plurality of laterally extending grooves. Of course, the handle 1134 may have the gripping surface 1136 formed of a soft pliable material or other types of materials that enable a user to grasp the gripping surface 1136.

Referring now to FIG. 11C, the retainer 1110 is illustrated in an exploded view. In this example, the retainer 1110 is turned to expose the underside. The housing 1112 has a plunger receiver 1138 formed therein. The plunger receiver 1138 may be integrally formed with the housing 1112. The housing 1112 may be molded from plastic. The plunger receiver 1138 has a shape designed to fit at least a portion of a plunger 1140 therein. In the example, the plunger body 1142 is received within the plunger receiver 1138. As will be shown in more detail below, the plunger body 1142 is a rounded rectangular shape in cross section. However, other types of cross sections may be used. The plunger 1140 also includes a foot 1144. The foot 1144 is larger in cross section than the plunger body 1142 and acts as an engagement means for engaging or locking the retainer to the outer wall 48. The foot 1144 does not enter the plunger receiver 1138 during operation. That is, the width of the plunger body is just smaller than the size of the plunger receiver 1138. The foot 1144 is longer and/or wider than the plunger receiver 1138. As illustrated in FIG. 11I, the width of the plunger body 1142 is W1. The width of the foot 1144 is W2. The width W2 is greater than the width W1. A shoulder 1146 provides a surface against which a coil spring 1148 placed into the plunger receiver 1138 pushes against. That is, the coil spring 1148 urges the plunger 1140 outward from the plunger receiver 1138 during operation. A leaf spring 1150 is also disposed within the housing 1112. The leaf spring 1150 is supported on ridges 1152 that form walls within the housing 1112. In this example, the leaf spring 1150 provides a cam engaging surface 1151 as will be described in more detail below. The cam engaging surface 1151 of the leaf spring 1150 flexes. The leaf spring 1150 is curved and is used to allow various tolerances within the rail 46. In this example, the leaf spring 1150 has a first spring arm 1152A and a second spring arm 1152B that extend on either side of the housing around the plunger receiver 1138.

The plunger receiver 1138 has a slot 1156 disposed on either side thereof. The slot 1156 receives a pin 1158 that extends through the plunger body 1142. The slot defines the distance the plunger moves relative to the housing 1112.

The plunger body 1142 may also include alignment features 1162 such as grooves and slots that align with grooves and slots within the plunger receiver 1138. The alignment features 1162 extends longitudinally along the plunger body 1142 in this example. A hole 1160 extends through the plunger body 1142 to receive the pin 1158.

The housing 1112 includes a fastener receiver 1164. In this example, two fastener receivers 1164 are disposed and integrally formed with the housing. The fastener receivers 1164 receive fasteners 1166. The fasteners 1166 are received within the fastener receivers 1164. In this example, the fastener receivers 1166 may be threaded and received within the threads formed within the fastener receiver 1164. However, a sleeve 1168 may of a metal material may be molded into the plastic or material of the housing 1112 and is used to receive the fastener 1166. That is, the fastener receiver 1164 may be integrally molded with the housing and a sleeve 1168 may be molded or secured therein. The sleeve 1168 may have threads therein for receiving the threads on the fastener 1166. The threads 1167 are illustrated on the fastener 1166 may have a head 1169 that has a width wider than the shaft having the threads 1167 thereon. The head 1169 forms a shoulder 1170 that is used to retain the article wall 1116 against the housing 1112. An optional spacer 1171 may be disposed between the head 1169 and the sleeve 1168 to hold the head 1169 away from the housing 1112. That is, the housing 1112 may be secured to the article wall 1116 using the fastener 1166. The head 1169 acts as an alignment feature that is received within the channel 50 of the rail 46. Although two alignment features such as the fasteners 1166 are illustrated, one or three or more fasteners or alignment features may be provided. The fasteners 1166 and the foot 1144 of the plunger 1140 are used for preventing rotation of the housing 1112 relative to the rail 46 during operation. The fastener 1166 and the relative position of the article wall 1116 are best illustrated in FIG. 11H. The article wall 1116 has an opening 1172 to allow the plunger body 1142 and the foot 1144 of the plunger 1140 to extend therethrough and allow the foot to clamp to the rail 46 on the opposite side of the outer wall 48 as the housing 1112. In FIG. 11H, the plunger 1140 is illustrated in a clamped or retained position within the rail 46. The force of the foot 1144 is provided upward in FIG. 11H and the lever arm together with the position of the other components forces the plunger 1140 in an upward direction which corresponds to the plunger 1140 being received further within the plunger receiver 1138.

Referring back to FIG. 11C, the housing 1112 has a lever opening 1174. In this example, two lever openings 1174 are disposed in the outer surfaces 1118A, 1118B. The lever openings 1174 extend from the housing 1112 near the article wall 1116 toward the upper surface 1118C.

The lever 1130, at the first end 1130A, has a cam 1176 disposed on either arm 1132, 1132B. The cam 1176 has an outer surface that allows the movement and locking of the pin 1158 in the pin opening 1178. The operation will be described in more detail below. Between the cams 1176 disposed on either arm 1132A, 1132B is a shaft surface having a width sized to accommodate the surfaces 1118A and 1118B. A tab 1182 may be provided to engage with the stop 1184 at each of the lever openings 1174. The tab 1182 acts as a rotation limiter.

Referring now to FIG. 11D, the stop 1184 is illustrated with the tab 1182 disposed therein. When the tab 1182 rotates due to movement of the lever 1130, the rotational movement of the lever 1130 is prevented based on the angle of the stop 1184 and the position of the tab 1182. That is, the tab 1182 rotates with the lever arm and prevents movement beyond the stop 1184 formed in the surfaces of the housing 1112 at the lever openings 1174. The lever opening 1174 also prevents the rotation of the lever in a clockwise direction when the tab 1182 hits the surface 1118B, as illustrated in FIG. 11E.

In FIG. 11D and FIG. 11E, the leaf spring 1150 has the spring arms 1152A and 1152B disposed within the housing 1112. The longitudinal ends of the leaf springs 1150 are curved and extend inward toward the surface 1118C within the housing 1112. As illustrated, the cam 1176 rides on the cam engaging surface 1151 surface of the leaf spring 1150, and more particular, the surface of the spring arms 1152A and 1152B. The leaf spring 1150 urges the cam 1176 in a direction toward the surface 1118C.

Referring now specifically to FIGS. 11F and 11G, the cam 1176 is shown in an unlocked position and locked position respectively. In the unlocked position illustrated in FIG. 11G, the cam 1176 is disposed away from the housing surface 1118C. This allows the plunger 1140 to have the foot 1144 extended outward from the housing 1112. The position of the cam 1176, in FIG. 11F, can somewhat float due to the action of the leaf spring 1150. The leaf spring 1150 provides an upward force but is compliant in the downward direction as well. The pin 1158 is engaged within the pin opening 1178.

In FIG. 11G, the outer surface of the cam 1176 rides on the leaf spring 1150 in an upward direction toward the surface 1118C. This action pushes the pin 1158 toward the surface 1118C within the plunger receiver 1138 to compress the coil spring 1148 within the plunger receiver 1138. Again, the leaf spring 1150 also allows the accommodation of different thicknesses of rails and the materials that form the rails 46. Thus, the retainer 1110 may accommodate different manufacturing tolerance of the rails 46 and the outer wall 48 forming the rails 46.

Referring now to FIG. 11H, the pin 1158 is shown within the slot 1156 of the plunger receiver 1138. In this example, the lever 1130 has been removed so the position of the pin 1158 within the slot 1156 is illustrated.

Referring now to FIG. 11J, a cross section view through the middle of the retainer 1110 is illustrated. The position of the coil spring 1148 relative to the plunger receiver 1138 and the shoulder 1146.

Referring now to FIG. 11K, the fastener receivers 1164 are illustrated in the housing 1112. The fastener receivers 1164 may be integrally formed or integrally molded as mentioned above. Also, the spring arms 1142A, 1142B may have each end disposed within the cavity 1186 that extends longitudinally relative to the housing 1112. The cavity 1186 extends on each side of the plunger receiver 1138.

The plunger receiver 1138 is shown as generally circular with alignment features 1188 formed therein. The alignment features 1188 of the plunger receiver 1138 are outwardly extending channels formed longitudinally within the inner surface of the plunger receiver 1138. Thus, the alignment features 1188 of the plunger receiver 1138 align with the alignment features 1162 of the plunger body 1142.

The stops 1184 are shown as a surface formed in the outer surfaces 1118A, 1118B.

Referring back to FIG. 11C, the device may be manufactured by placing the coil spring 1148 within the plunger receiver 1138. The pin 1158 is inserted into the pin hole 1160 so that the pin is received within the slot 1156. The handle flexes and is placed so that the pin openings 1178 receive the pin. That is, the cams 1176 are inserted within the lever openings 1174 so that pin 1158 is received within the pin opening 1178. The leaf spring 1150 is placed within the cavity 1186 so that the cam 1176 on each side of the lever 1130 is disposed between the leaf spring and the housing 1112. The fasteners 1166 is used to fasten the housing 1112 to an article 1114 and, more specifically, to the article wall 1116. Of course, a separate cover may be applied to the housing 1112 in place of or in addition to the article wall 1116. The heads 1169 thus extend outward from the housing 1112.

In operation, the retainer 1110 has the foot 1144 extending therefrom and is aligned with a receiver 44 in a rail 46. The foot 1144 is in an outward position relative to the housing 1112 and the lever 1130 is in the upright position. Some flexibility is allowed so that the foot 1144 can easily be aligned within the receiver 44. As the handle is rotated, the cam pushes the pin and thus the lever toward the surface 1118C, the foot 1144 engages the underside of the surface of the channel 50 so that the retainer 1110 maintains its position. As mentioned above, the flexibility of the leaf spring allows the foot 1144 to be engaged to a channel so that manufacturing tolerances are compensated therefor.

When the lever 1130 is moved in the clockwise most position relative to FIG. 11F, the foot 1144 is moved into the upward most position and the retainer 1110 is locked in place. When the lever 1130 is rotated in the counterclockwise direction, the foot 1144 disengages the channel 50 and the retainer 1110 is allowed to slide freely within the channel.

Referring now to FIG. 11L, another example of a retainer 1110′ is set forth. In this example, the retainer 1110′ has the configuration illustrated in FIG. 11C above. That is, a housing 1112, the lever 1130 with the gripping surface 1136, the plunger 1138 and the fasteners 1166 having the head 1169 is shown. FIG. 11L is especially similar to that set forth in FIG. 11A but the retainer 1110′ has a cover plate 1180 disposed on the opposite surface of the housing 1112 than the lever 1130. The operation of the example illustrated as the plunger 1138 is self-contained meaning that the mechanism may be detached from an accessory so it can be installed after the accessory is placed in position on the rail 46.

Referring now to FIG. 11M, the retainer 1110′ illustrated above may have a more complex cover plate 1180 that extends outward therearound. The cover plate 1180 has a base 1183 that is parallel to the bottom of the housing 1112 and parallel to the rail 46 onto which the cover mounts. A slot 1185 may be formed in the edge of the base 1183. The slot 1185 extends longitudinally inward from the edge of the base 1183 and aligns with the elongated opening 52 of the rail 46. This allows various features to be clamped. For example, one or two of the retainers 1110′ may be used to position an accessory to the rail 46.

A flange 1187 extends in a perpendicular direction from the base 1183 away from the rail 46. The flange 1187 has a first hole 1190A and a second hole 1190B extending therethrough. The openings 1190A, 1190B may be used to couple to a device or accessory using fasteners. The openings 1190A, 1190B may be also used to receive a tie down such as rope or bungie cords for holding accessories desired to be clamped down. The cover plate 1180 and the accessories coupled thereto are fixed in position relative to the elongated openings 52 of the rail 46.

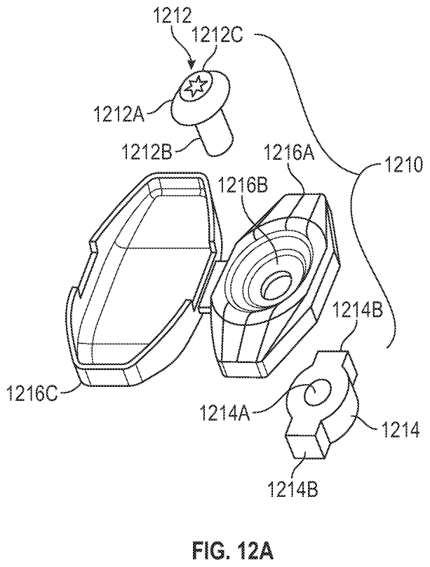

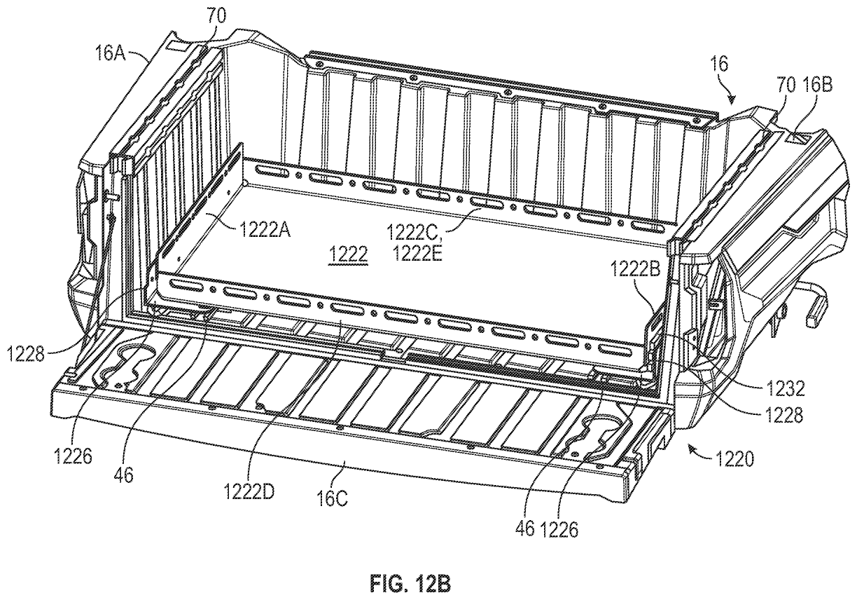

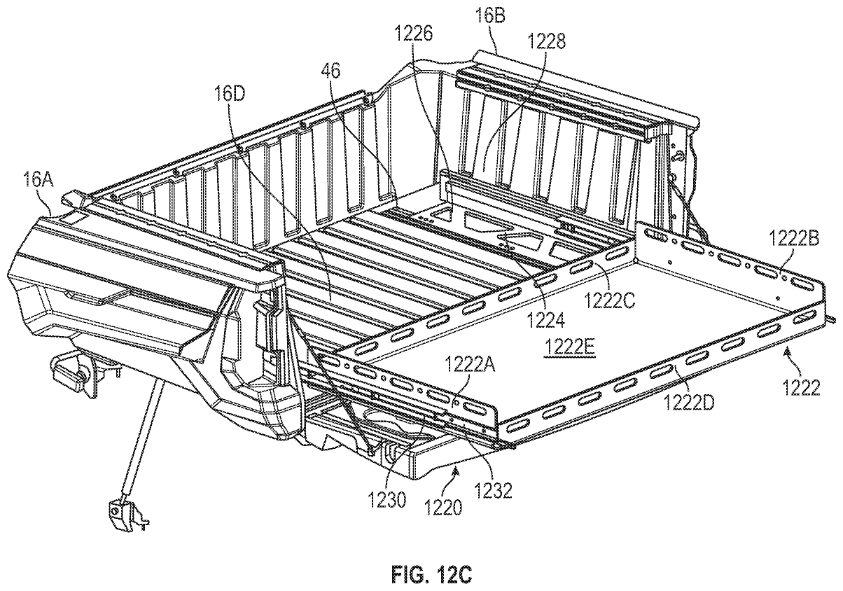

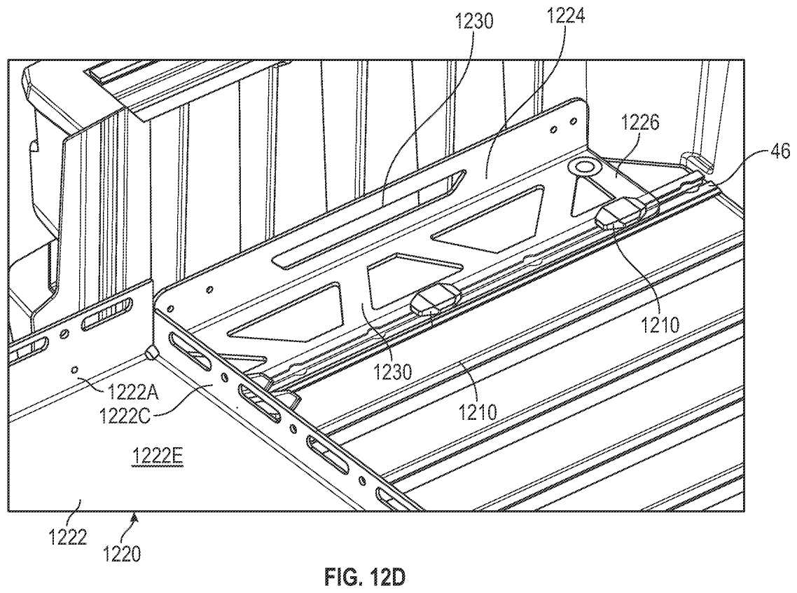

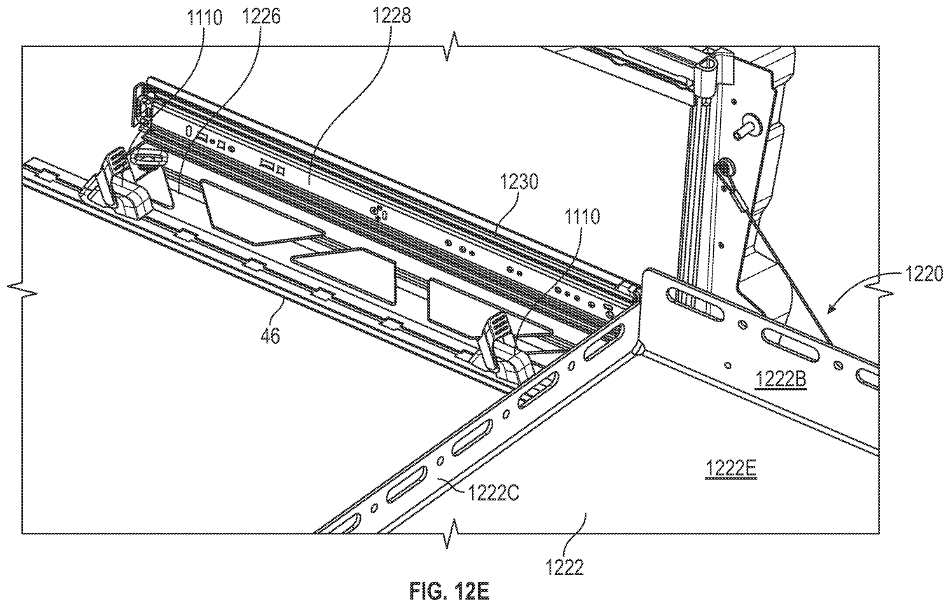

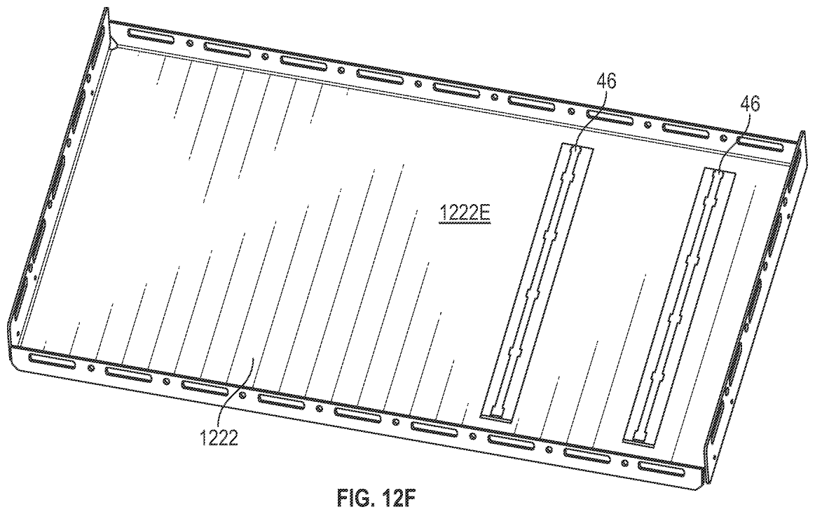

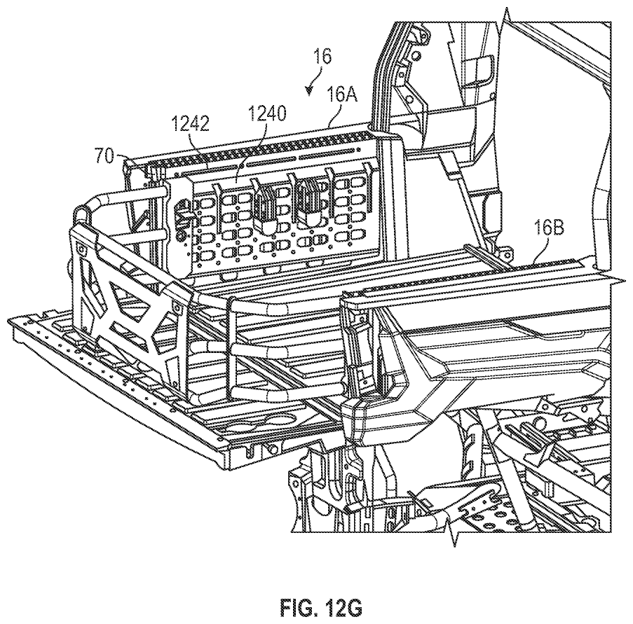

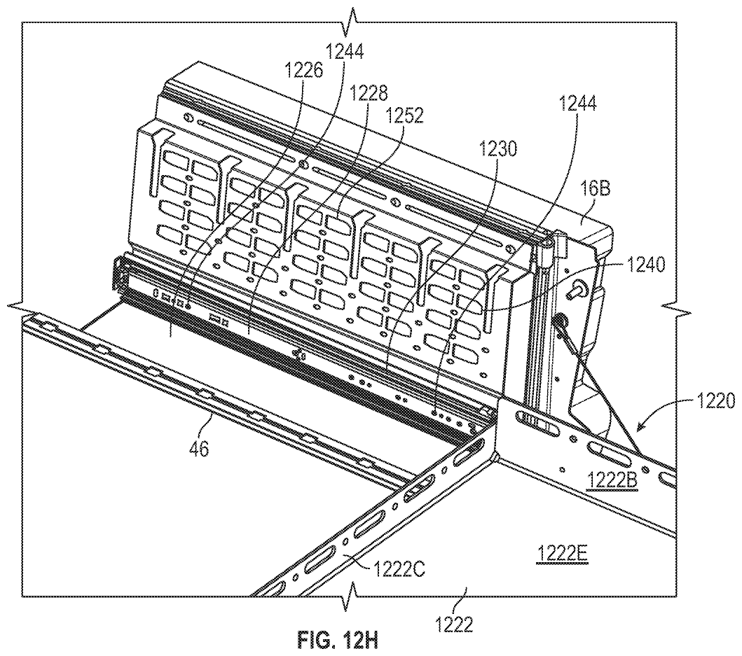

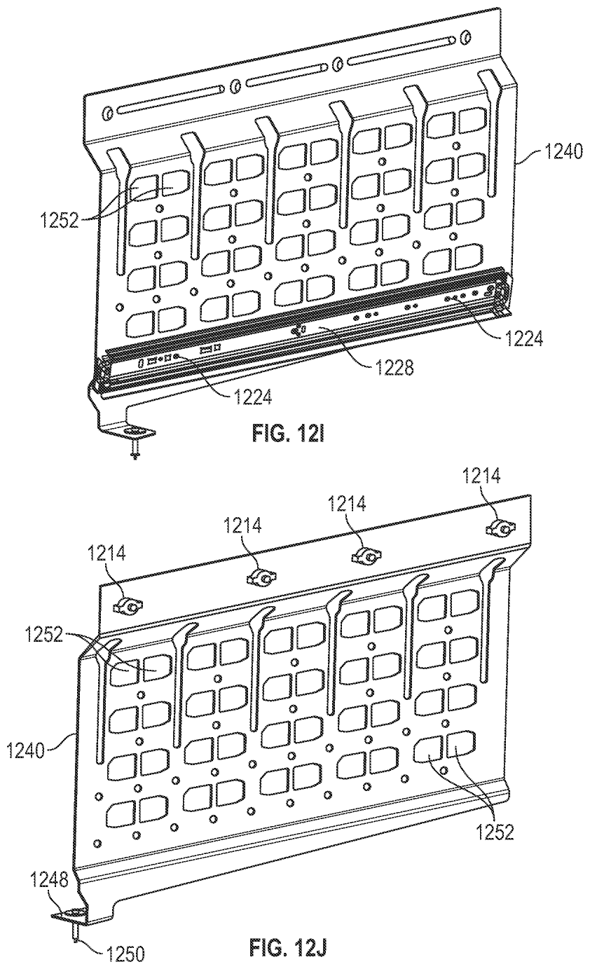

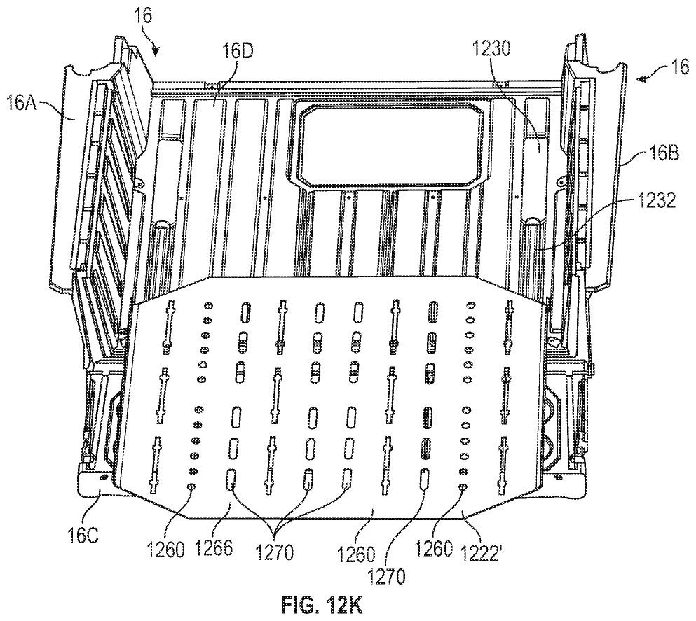

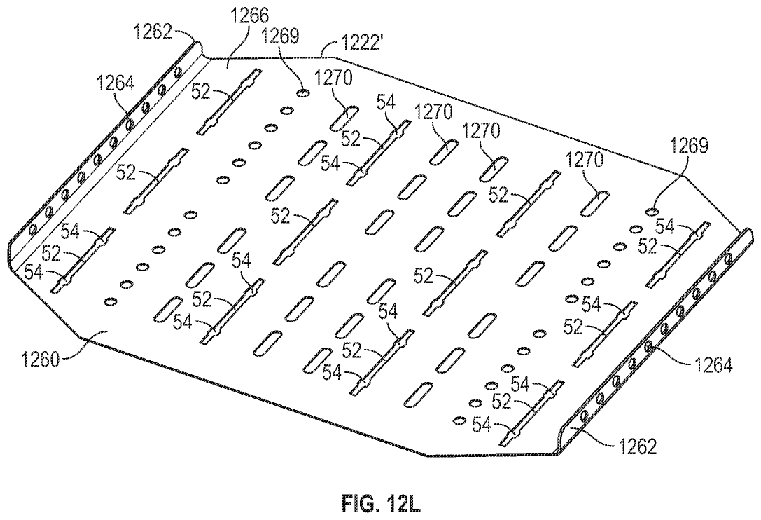

Referring now to FIG. 12A, another type of retainer for fixing an accessory in place that does not need to be removed very readily. The retainer 1210 includes a fastener 1212 that has a head 1212A and a shaft 1212B extending therefrom. A nut 1214 has a channel 1214A therethrough. The channel 1214A may have internal threads that receive threads on the shaft 1212B of the fastener 1212.

The fastener 1212 may also include a tool receiver 1212C. The tool receiver 1212C may be sized to fit a screwdriver, a Phillips heads screwdriver, a Torx® or an Allen head.

A cover assembly 1216 may be used to cover the fastener 1212. The cover assembly 1216 includes a base 1216A that has a receiver 1216B that receives the head 1212A of the fastener 1212. A rotatable cover piece 1216C may rotate and clasp to the base 1216A to provide a finish surface and to prevent damage to the tool receiver 1212C during operation.

Referring now to FIG. 12B-FIG. 12D, a slide out bed assembly 1220 is illustrated. In this example, the slide out bed assembly is disposed in the cargo box 16 of the vehicle 10. The cargo box 16, as mentioned above, has a first side wall 16A and a second side wall 16B spaced apart from the first side wall 16A. A tray 1222 has a pair of longitudinal sides 1222A, 1222B. The tray 1222 may also have lateral sides 1222C and 1222D. The sides 1222A-1222D extend vertically from a floor 1222E of the tray 1222. In this example, the sides 1222A, 1222B extend further vertically from the floor 1222E than the sides 1222C, 1222D. Of course, the length vertically of the sides 1222A-1222E may vary depending upon various design considerations.

As is most clearly shown in FIG. 12D, a pair of rails 46 may be used as a retaining system to retain the slide out bed assembly 1220 within the cargo box 16. The rail 46 may be configured in a manner described above in FIG. 2B and therefore the description of which will not be repeated.

The tray 1222 may be mounted to the rails 46 using a mounting bracket 1224. The mounting bracket 1224 is located or coupled to each of the rails 46 located on the right side and the left side of the load floor 16D of the cargo box 16. The mounting bracket 1224 is spaced apart from the other mounting bracket 1224 located on the other side of the cargo box 16. The mounting bracket 1224, this example, is L-shaped and has a horizontal member 1226 and a vertical member 1228. The horizontal member 1226 may be fixedly coupled to the rails 46 with retainer assemblies 1210. Of course, other types of retainers may be used such as the retainer 1110 illustrated in FIG. 12E.

Slide rails 1230 are coupled to or integrally formed with the vertical members 1228 of the brackets 1224. The slide rails 1230 couple to slides 1232 disposed on the sides 1222A, 1222B of the tray 1222. That is, the slide rails 1230 engage the slides 1232 to allow the tray 1222 to be slidably extended from and retracted back into from the cargo box 16.

Referring now to FIG. 12F, one or more rails 46 may also be located and affixed to the floor 1222E of the tray 1222, modular type storage may be provided so that various accessories may be fixed to the slide out bed tray assembly 1220.

Referring now to FIG. 12G, the cargo box 16 may also have molle panels 1240 coupled to the walls 16A, 16B. The molle panels 1240 may be coupled to the double channel receivers 70 located at the top of each of the respective walls 16A, 16B. Slots 1242 may receive a retainer to retain the molle panels 1240 to the double channel receivers 70.

Referring now to FIG. 12H, the slide out bed assembly 1220 is illustrated coupled to the molle panel 1240. That is, the slide rails 1230 may be coupled directly to the molle panels 1240 on each side of the cargo box. Retainers or fasteners 1244 may be used to secure the slide out bed assembly 1220 to the molle panels 1240. The rails 1230 may be coupled directly to the molle panels 1240 which are directly coupled to the side wall 16B in FIG. 12H. The slide rails 1230 may also be directly coupled to the side walls 16B by the fasteners 1234 as illustrated in FIG. 12D.

Referring now to FIGS. 121 and 12J, a front and back views of the molle panel 1240 is illustrated. The molle panel 1240 as mentioned above may be coupled to the double channel receiver using one of the types of retainers described in FIGS. 11A-11F or by the fastener 1212, the nut 1214 of which is illustrated in FIG. 12I. A flange 1248, with a fastener 1250, may be used to secure the molle panel 1240 to the floor 16D of the cargo box 16. The molle panel 1240 has plurality of openings 1252 that may be used to secure various tools or implements thereto.

Referring to FIGS. 12K and 12L, an alternative tray 1222′ is illustrated. The tray 1222′ is secured to the cargo box 16. In this example, the tray 1222′ is secured to the load floor 16D of the cargo box 16. In particular, slide rails 1230 are mounted to the cargo box 16 and more particularly to the load floor 16D of the cargo box 16 or the supporting frame thereunder. The slides 1232 are slidably coupled to the tray 1222′ so that the tray 1222′ moves relative to the slide walls 1230 and the cargo box 16. As illustrated in FIG. 12K, the tray 1222′ extends rearwardly and over the third vertical sidewall 16C that may be a tailgate or door. This allows easier loading and offloading of gear, hardware and goods. The slide rails 1230 and the slides 1232 operate in a similar manner to that described above and therefore, the operation is not described in further detail.

The tray 1222′ has vertical sidewalls 1262 that extend vertically relative to the vehicle 10. The sidewalls 1262 extend longitudinally and have openings 1264 therethrough. In this example, the openings 1264 are circular. However, other spaces of openings 1264 may be provided.

The tray 1222′ has a tray floor 1266. The tray floor 1266 has the slide 1232 mounted thereunder. The tray floor 1266 has a plurality of openings therein. The plurality of openings comprises circular holes 1260 that are disposed in rows. The rows of circular holes 1268 extend longitudinally relative to the vehicle. The openings in the tray floor 1266 also include elongated openings. In this example, two types of elongated openings are provided. Slots 1270 are provided. The slots 1270 are elongated in the longitudinal direction. In this example, four rows of six slots are provided in the tray floor 1266. The plurality openings also may include elongated openings 52 as described above. The elongated openings 52 may be similar in shape to those set forth in the rails 46. The elongated openings 52 have locating openings 54 that are sized to receive a retainer such as the retainers 720 or the retainer 1110. The retainers 720, 1110 may be coupled to various types of accessories for holding the accessory to the tray 1222′ during operation.

The openings 54, 1260, 1270 are used to help secure gear, hardware and goods to the tray 1222′. Ratchet straps, the retainers 720, 1110, bungie cords and other types of devices may be used and coupled to the openings.

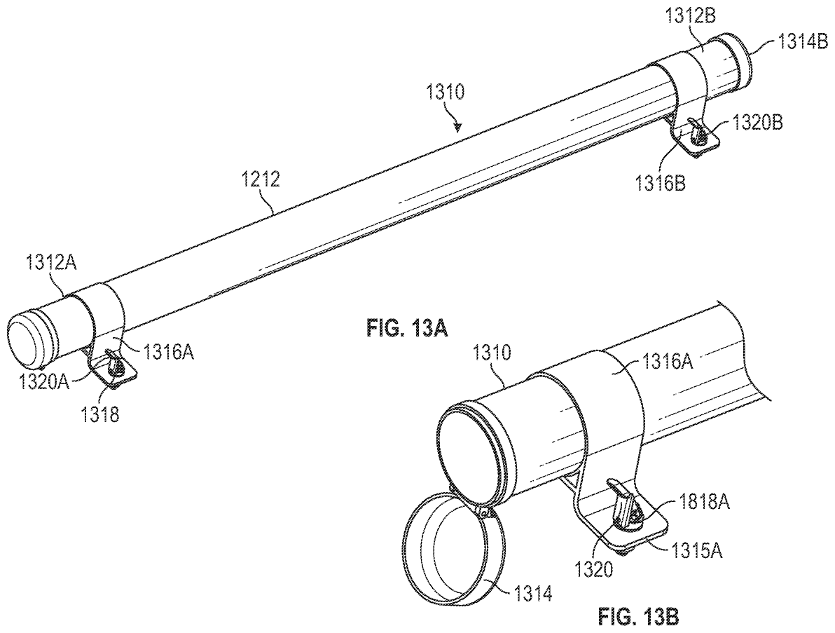

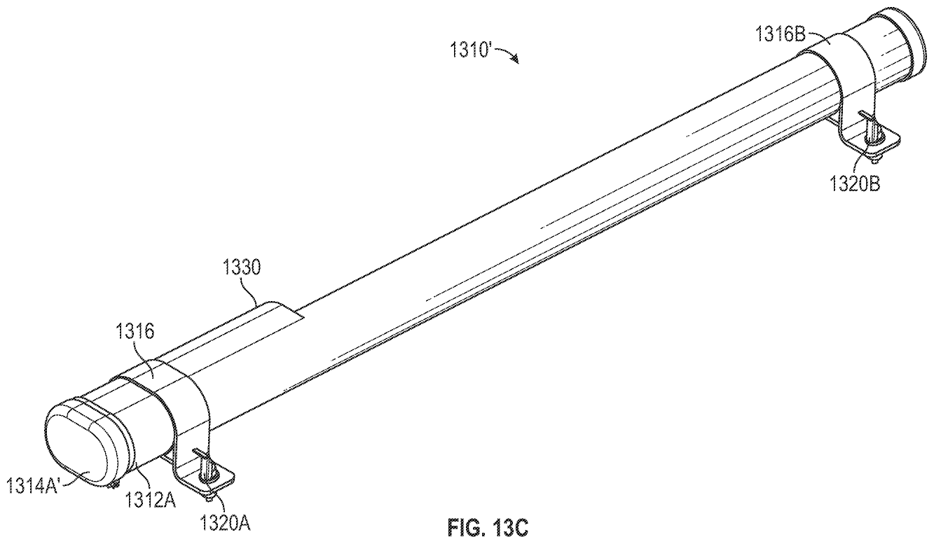

Referring now to FIGS. 13A-13C, a fishing pole transport assembly 1310 is illustrated. The fishing pole transport assembly 1310 has an elongated housing 1312 having a first end 1312A and a second end 1312B. Elongated housing 1312 is cylindrical in shape and therefore has a circular cross section. A first end cap 13A is disposed at the first end 1312A and a second end cap 1314B is disposed on the second end cap 1312B. The end caps 1314A, 1314B extend over the respective ends 1312A, 1312B. The elongated housing 1312 and the end caps may be formed of various materials including plastic or metal. One or both of the end caps 13A, 13B may be removable for receiving a fishing rod therein.

A first retainer strap 1316A and a second retainer strap 1316B are disposed around the elongated housing 1312 and have respective retainer openings 1318A, 1318B for receiving a retainer 1320A, 1320B. The retainers may be one of the many retainers described above. The retainers 1320A, 1320B retain the fishing pole transport assembly 1310 to a rail 46 such as the double channel receivers 70 illustrated above on the edge of the walls 16A, 16B of the cargo box 16. The retainers 1320A, 1320B may also be used to affix the fishing pole transport assembly 1310 in various other locations in the vehicle including the roof.

Referring now to FIG. 13C, another embodiment of the fishing pole transport assembly 1310′ is set forth. In this example, the configuration is the same except for an enlarged portion 1330 is disposed at the first end 1312A. That is, a wider diameter or enlarged portion 1330 may be used to receive a reel of a fishing pole. Thus, the elongated portion 1330 only extends a portion to correspond to where a typical reel may be found. The cover 1314A′ may also be elongated rather than circular as illustrated above.

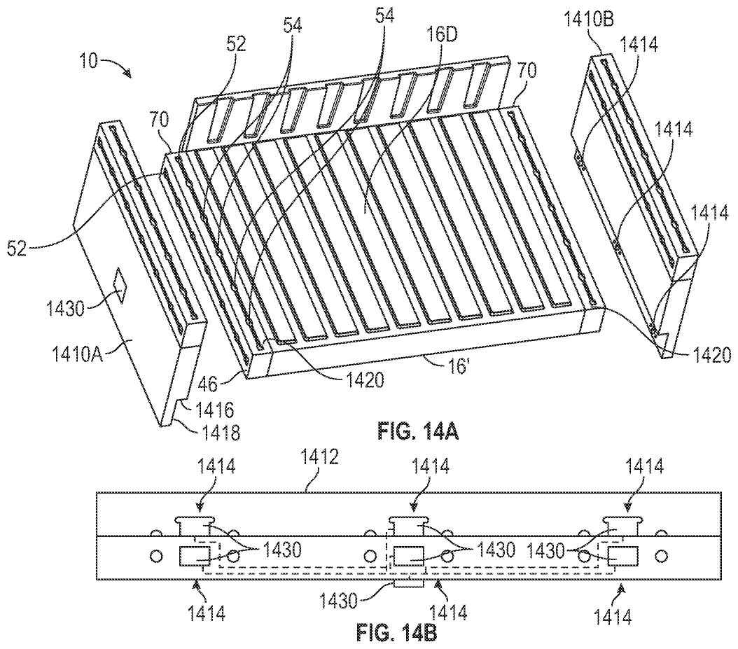

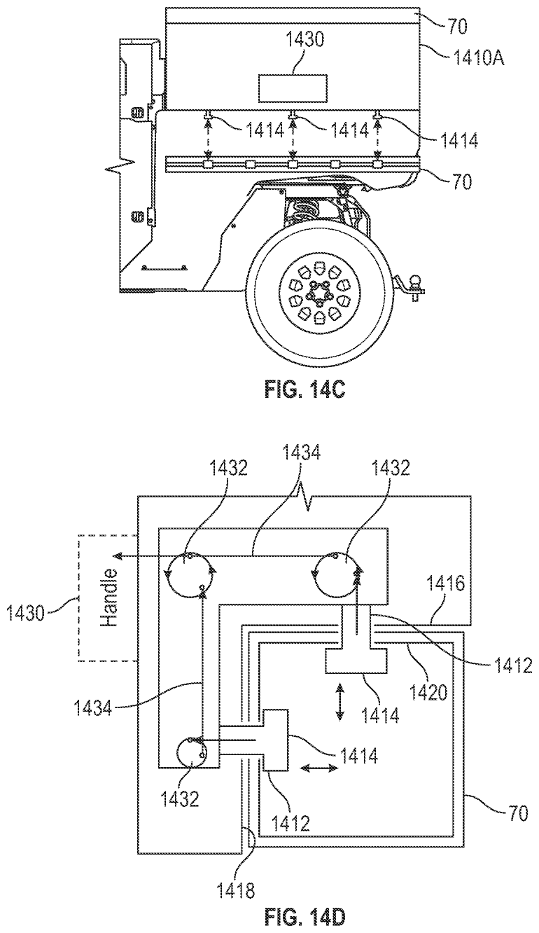

Referring now to FIGS. 14A-14D, an example of a cargo box 16′ having a removable cargo box is set forth. In this example, the cargo box floor 16D has a first side (left side of the vehicle) and a second side (the right side of the vehicle) that have a first rail 46 and a second rail 46 disposed adjacent thereto. The rails 46 may be the double channel receivers 70 described above. The double channel receivers 70 have locating openings 54 as described above. The locating openings 54 are regularly spaced and aligned laterally on the two side edges of the cargo box 16′.

The cargo box 16′ has removable sides 1410A, 1410B. The removable sides have a retainer system 1412 that is best illustrated in FIG. 14B. The retainer system 1412 comprises a plurality of retainers that used to retain the first side 1410A to the double channel receiver on the left side of the cargo box 16′ and a second retainer system 1412 that is used to couple the second side 1410B to the double channel receiver 70 located on the right side of the cargo box 16′.

The retainer system 1412 comprises a plurality of retainers 1414. In FIG. 14B, six retainers 1414 are illustrated. As is best illustrated in FIGS. 14B and 14C, the retainers 1414 extend from a first mounting edge 1416 and a second mounting edge 1418. The first mounting edge 1416, when the sides are installed, is a plane that is parallel to the floor 16D of the cargo box 16. The first mounting edge 1416 is adjacent to the horizontal surface 1420 of the double channel receiver 70. The second mounting edge 1416 is a plane that is parallel to a vertical surface 1422 of the double channel receiver 70. That is, the mounting edges 1416 and 1418 are perpendicular to each other.

The retainer system 1412 has a handle 1430 disposed on the outside of each of the sides 1410A, 1410B. The handle 1430 is mechanically coupled to the retainers 1414 to retract and release the retainers. The handle 1430 may be coupled using a plurality of cans 1432 and a mechanical linkage 1434 therebetween. When the handle 1430 is activated, the retainers 1414 are released from fixing the sides 1410 to the double channel receivers 70. The sides may be moved in a longitudinal direction and removed when the retainer 1414 is aligned with the locating openings 54.

The retainers 1414 may be formed in a similar manner to that described above relative to FIGS. 11A-11M. In particular, the retainers may be formed as illustrated in FIG. 11L with more than one retainer on each of the mounting edges 1416, 1418.

As is best illustrated in FIG. 14C, a double channel receiver 70 may also be located on top of each of the walls 1410A, 1410B.

To install or remove the sides 1410A, 1410B, the handle 1430 is positioned to remove the tension from the retainers 1414. The plunger foot 1144 of the retainer may therefore be moved away from the respective mounting edges 1416 or 1418. The retainer 1414 is placed in the locating openings and the wall is slide in a longitudinal direction and thereafter the handle is released so that the retainer retains the wall in the position.

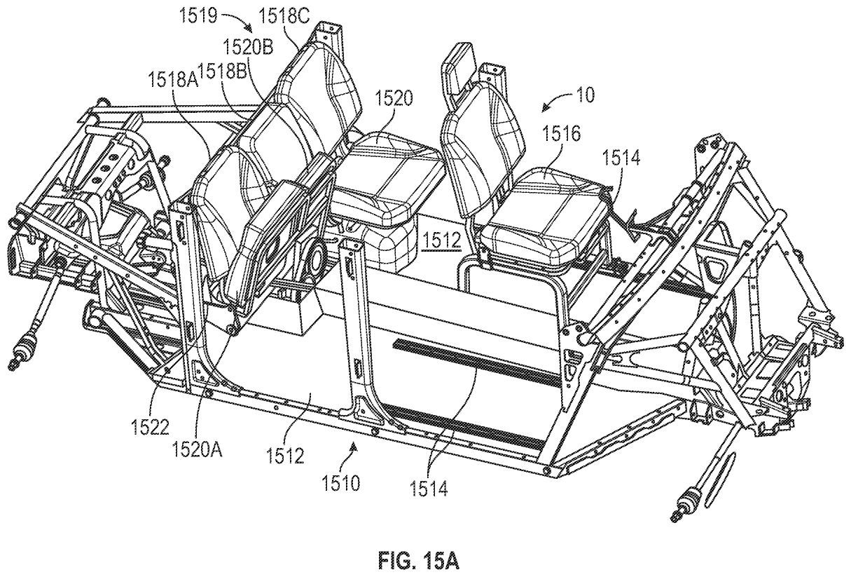

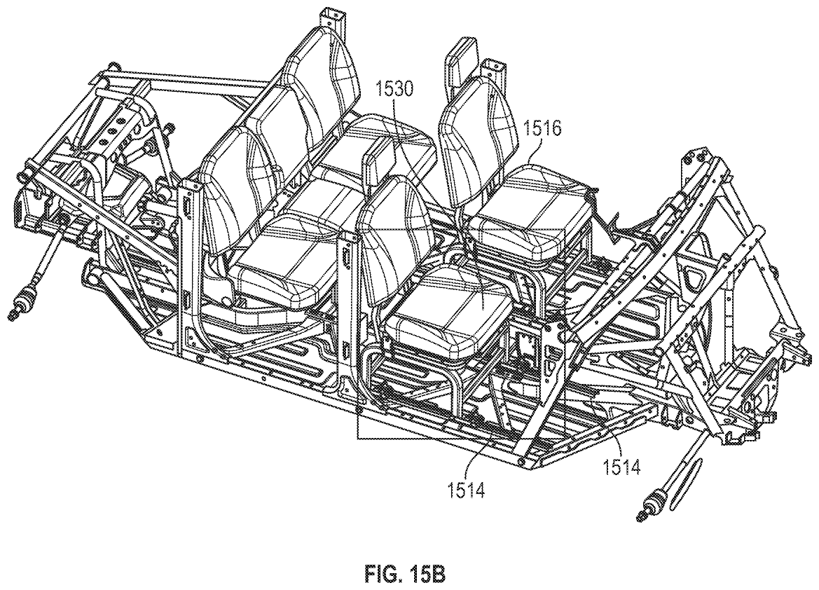

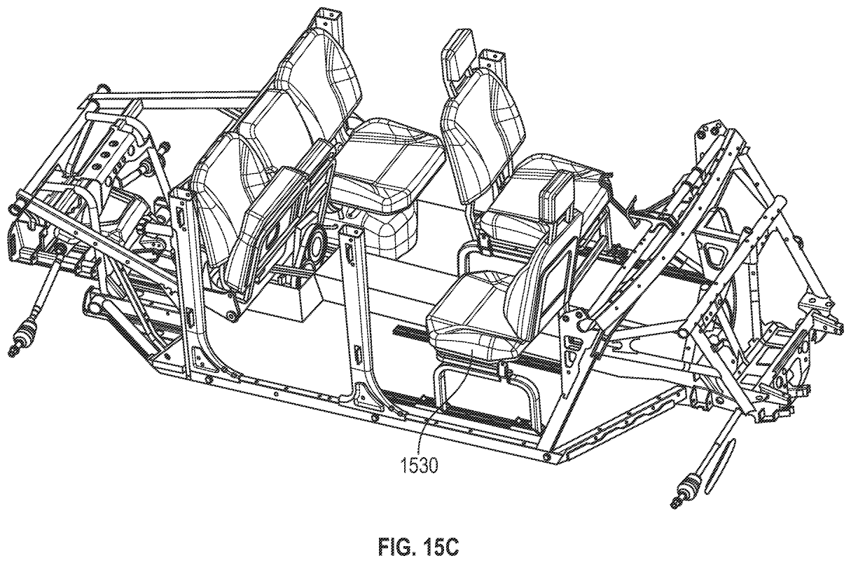

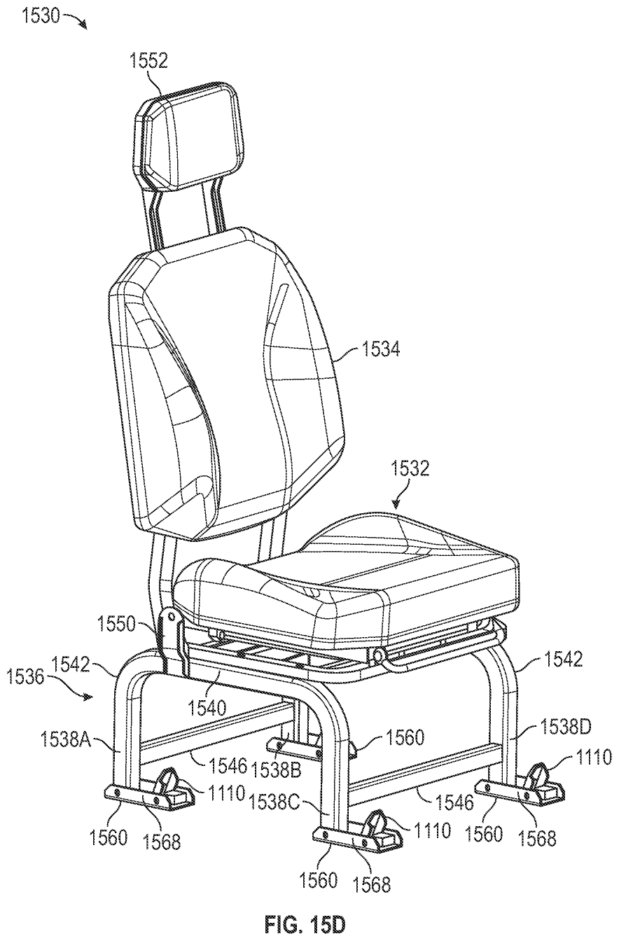

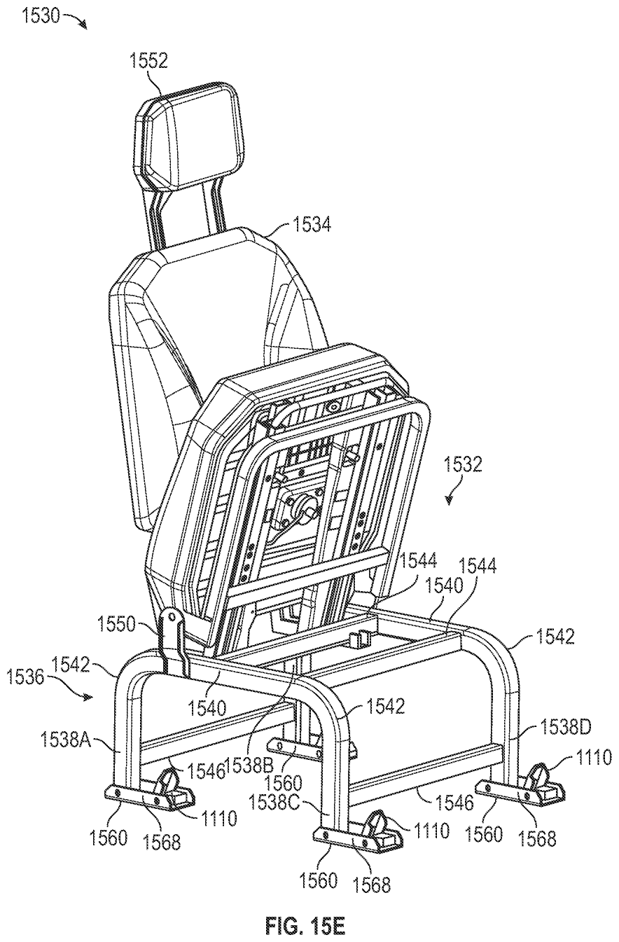

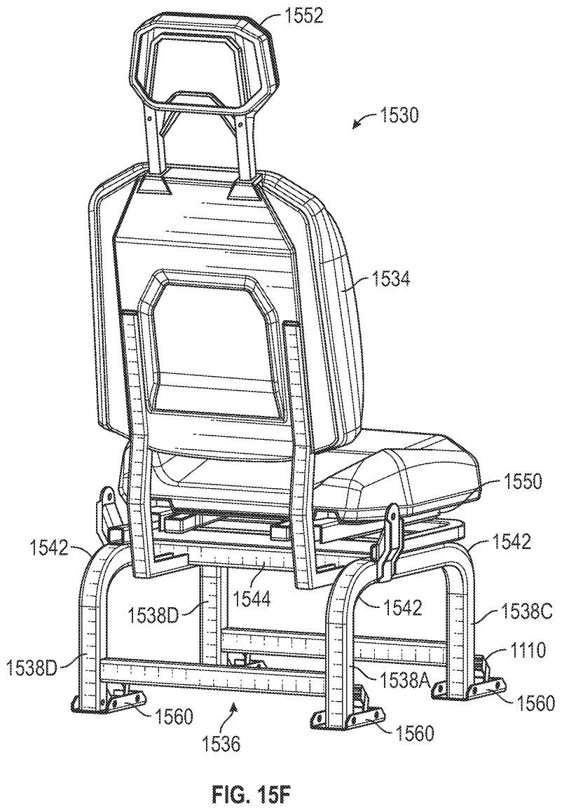

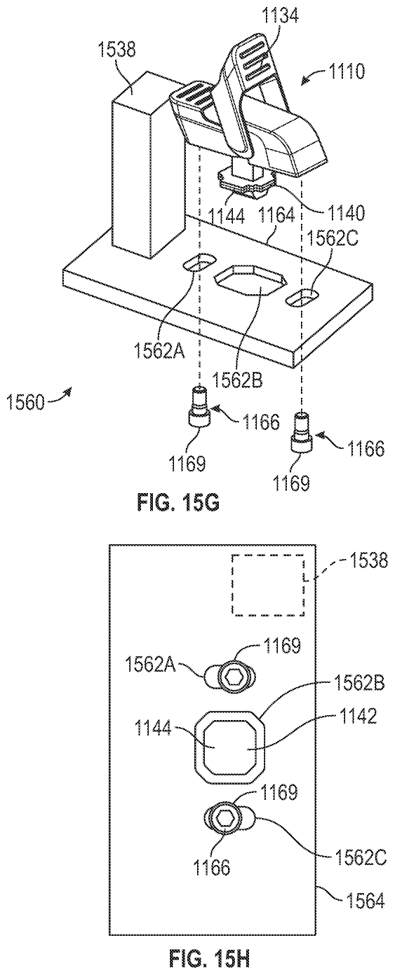

Referring now to FIG. 15A, a cutaway portion of the vehicle 10 is illustrated. In this example, the passenger compartment 1510 is illustrated. The passenger compartment 1510 has a floor 1512, the floor 1512 has rails 1514. The rails 1514 are mounted to the floor and are spaced apart. In this example, a passenger seat is not illustrated so that the rails 1514 are illustrated. A driver seat 1516 is secured to the floor with rails 1514 although only one rail is partially illustrated. A rear seat 1518 having a first rear seat portion 1518A, a second portion 1518B and a third portion 1518C is illustrated. In FIG. 15A, the first portion 1518A and the second portion 1518B have the seat bottom 1520A, 1520B and 1520C rotatably coupled to the vehicle 10. More specifically, the rear seat 1518 is coupled to the frame 1522 of the vehicle. In FIG. 15B, the passenger seat 1530 is forward facing. In FIG. 15C, the passenger seat is rearward facing.

Referring now to FIGS. 15D-15F, details of the passenger seat 1530 are illustrated. The passenger seat 1530 has a seat base 1532 and a seat back 1534. The seat base 1532 is rotatably coupled to a seat base support 1536. The seat base support 1536 has a plurality of legs including a first leg 1538A, a second leg 1538B, a third leg 1538C and a fourth leg 1538D. The seat base further includes intermediate portions 1540. A first intermediate portion 1540 extends between the first leg 1538A and the second leg 1538. A second intermediate portion 1540 extends between the second leg 1538B and the fourth leg 1538D. In this example, the intermediate portions 1540 are horizontal and attached to each respective leg with a curved portion 1542. The intermediate portions 1540 may be joined together by cross members 1544. In this example, two cross members 1544 are set forth.

A second set of cross members 1546 joins the first leg 1538A and the second leg 1538B, another cross member 1546 joins the third leg 1538C and the fourth leg 1538D.

The seat base 1532, in FIG. 15E, is illustrated in the raised position. In FIG. 15D, the seat base 1532 is in the lower position. The seat base 1532 is coupled to the intermediate portions 1540 by a pair of brackets 1550. That is, the seat base 1532 rotates relative to the brackets 1550 that are fixed to the intermediate portions 1540.

The seat back 1534 includes a headrest 1552 that may be fixed or slidably coupled to the seat back 1534.

A plurality of couplers 1560 are used to couple the seat base support 1536 to the rails 1514. The rails 1514 may correspond to the rails 46 illustrated above with an elongated slot or opening 52 and a locating opening 54 as shown in various figures including FIGS. 2B and 11A.

Coupler 1560 is illustrated in greater detail in FIGS. 15G and 15H. The coupler 1560 includes a retainer 1110 illustrated in FIGS. 11A-11K. The coupler 1560 includes a base 1162 that has openings 1562A, 1562B and 1562C. The openings 1562A-1562C correspond to the openings 716A-C illustrated in FIG. 7D. The plunger body 1142 extends through the opening 1562B so that the foot 1144 is positioned in the channel 50 of the rail 46. The fasteners 1166 extend through the openings 1562A and 1562C. The heads 1169 of the fasteners 1166 extend through the base 1564 and are positioned in the elongated openings 54 in the rails 46 within the channel 50. That is, the plunger 1142 and the heads 1169 engage the rails 46 as described above in greater detail. In FIG. 15G, the legs 1538A-1538D are collectively illustrated as leg 1538. Each leg 1538A-D may have the coupler 1560 coupled thereto. Each leg 1538A-D may be fastened with a fastener or by some other means such as welding. As illustrated best in FIGS. 15D-15F, flanges 1568 may be used for securing the retainer 1110 to the coupler 1560. In this example, the flanges 1568 are located on either side of the base 1564, the flanges extend in a vertical direction and are disposed longitudinally relative to the vehicle. Of course, the flanges 1568 are optional.

In operation, the retainers 1110, at each coupler 1560, has the handle 1134 in the upward position during assembly. When the handle 1134 is in the upward position, as illustrated in FIG. 15G, the plunger foot 11444 is in the downward position so it can be received within one of the locating openings 54 illustrated above. The couplers 1560 may be spaced to allow simultaneous positioning of the plungers 1140 of each coupler 1560 to the position within the locating openings 54. However, alignment is not necessary. Once all the plungers 1140 are positioned within the locating openings 54, the plungers are located within the channel 50 of the rail such as that illustrated in FIG. 4B above. Likewise, the heads 1169 are also aligned with the elongated openings 52 and are positioned within the channel 50 to fix the passenger seat 1530 (or the driver seat 1516) in place, the handle 1134 is positioned in a downward position so that the plunger contacts the underside of the rail to lock the respective seat in place. To remove the seat or move the seat into another position, the handles 1134 are raised to loosen the seat assembly relative to the rail 46, the plunger feet 1144 are aligned with the locating openings 54 to remove the seat or remove the seat and place the seat in a rotated or 180° position. The operation of the retainer 1110 is described in greater detail relative to FIGS. 2A-2C and FIGS. 11A-11M.

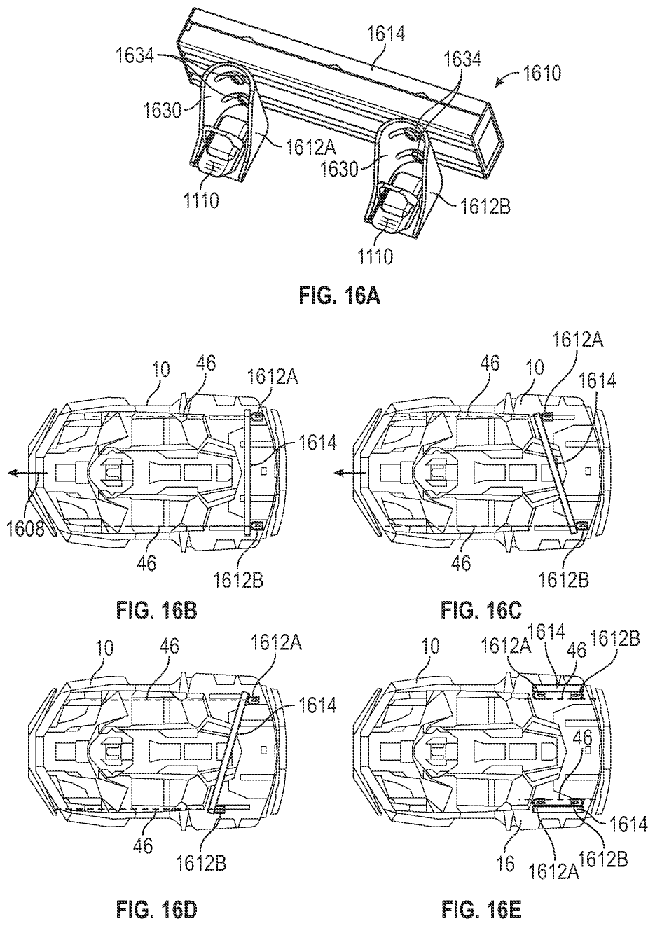

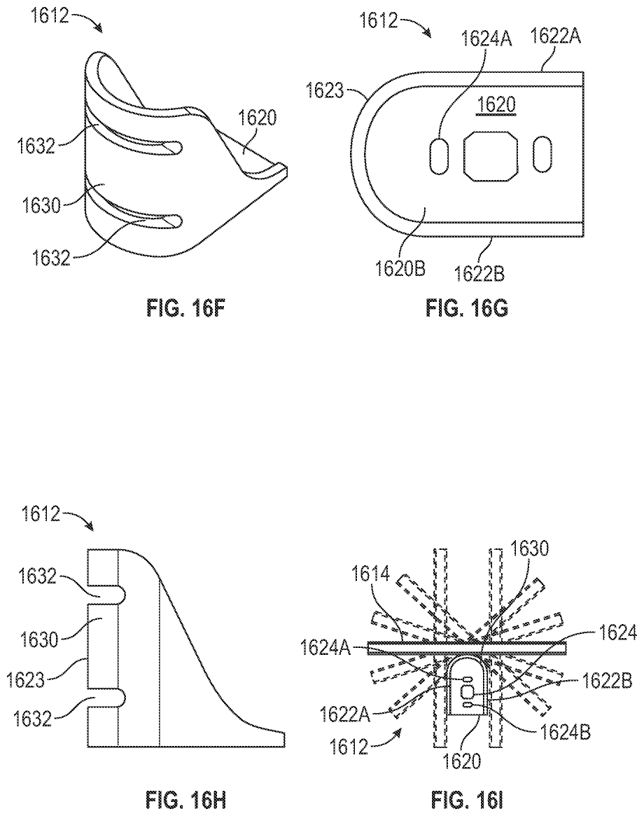

In FIGS. 16A-16H, a crossbar assembly 1610 is set forth. In this example, the crossbar assembly 1610 includes a crossbar mounting bracket 1612A and a crossbar mounting bracket 1612B. The crossbar mounting bracket is sized to receive a retainer 1110. Each crossbar mounting bracket 1612A, 1612B is sized to receive a retainer 1110 as described in greater detail above. The retainer 1110 is used to couple the crossbar mounting bracket 1612A, 1612B to a structure of the vehicle. The structure of the vehicle may include a roof as illustrated in FIG. 4A or a cargo box 16 as illustrated in FIG. 12. In any case, the crossbar mounting brackets 1612A, 1612B are mounted to rails 46. It should also be noted that the crossbar mounting brackets 1612A, 1612B may be mounted in various other positions such as within the cargo box 16 or on a tray 1222, 1222′ such as is illustrated in FIGS. 12A-12F. The shape of the crossbar mounting brackets 1612A, 1612B allow a crossbar to be mounted in a convenient location for the vehicle operator. In FIG. 16B, the rails 46 extend longitudinally relative to the vehicle 10 in the direction of the longitudinal axis 1608. The crossbar 1614 in FIG. 16B is perpendicular to the longitudinal direction of the rails 46. That is, the crossbar 1614 is laterally disposed relative to the vehicle 10. In many applications, this is very typical. However, as illustrated in FIG. 16C, the crossbar 1614 may not be perpendicular to the rails or the longitudinal direction of the vehicle. In the example set forth in FIG. 16C, the crossbar 1614 is positioned at an angle relative to the longitudinal direction of the vehicle and the rails 46. Because of the shape of the crossbar mounting brackets 1612A, 1612B, various angles may be provided as described in greater detail below. In the illustration of FIG. 16C, the mounting bracket 1612A is positioned more forward in the vehicle 10 than the mounting bracket 1612B to form the angle of the crossbar 1614.

In FIG. 16D, the mounting bracket 1612B is positioned more forward than the mounting bracket 1612A. Thus, the crossbar 1614 has a counter angle to that illustrated in FIG. 16C.

Referring now to FIG. 16E, two crossbars 1614 are illustrated in a parallel direction to the longitudinal direction of the vehicle. The forwardmost crossbar mounting bracket 1612A is positioned on a rail 46. A crossbar 1614 extends between the crossbar mounting bracket 1612A and a second crossbar mounting bracket 1612B, which is located more rearward from the first crossbar mounting bracket 1612A. In FIG. 16E, the crossbars 1614 may be mounted on the side of the cargo box 16.

Referring now to FIGS. 16F-16I, the crossbar mounting brackets 1612 is illustrated in further detail. The crossbar mounting bracket 1612 corresponds to both the crossbar mounting brackets 1612A and 1612B. The crossbar mounting bracket 1612 has a planar base 1620. The planar base 1620 has a rectangular portion 1620A and a curved portion 1620B. The rectangular portion 1620A has straight edges 1622A and 1622B. The curved portions 1620B has a curved edge at a curved end 1623 that extends between the first straight edge 1622A and the second straight edge 1622B. The rectangular portion has openings 1624A, 1624B that receive the fasteners of the retainer 1110 illustrated in greater detail above in FIGS. 11A-11L. Likewise, FIG. 15C shows the coupling of a planar base 1620 to the retainer 1110. The opening 1626 is used to receive the plunger of the retainer 1110 in the same manner as the opening 1562B of FIG. 15G. In general, the retainer 1110 is used to retain the crossbar mounting bracket 1612A, 1612B to a rail or a structure that has similar characteristics to a rail 46 such as the tray 1222, 1222′ as illustrated above.

The crossbar assembly 1610, in this example, contains two crossbar mounting brackets 1612A, 1612B for each crossbar 1614. However, a greater number of crossbar mounting brackets 1612 may be used.

The planar base 1620 has a curved wall 1630 that extends along the curved end 1623. The curved wall 1630 is perpendicular to the planar base 1620. The curved wall 1630 may also extend longitudinally relative to the planar base 1620 toward or along the straight edges 1622A, 1622B. In the present example, the curved wall 1630 extends furthest away from the planar base 1620 at the curved end 1623 and gradually tapers shorter at the straight edges 1622A, 1622B. In this example, the curved wall 1630 of each of the crossbar mounting brackets 1612A, 1612B include two slots 1632. The slots 1632 are elongated and extend within the curved wall 1630 from the curved portion to the straight edges 1622A, 1622B.

The crossbar 1614 is coupled to the curved walls 1630 by fasteners 1634. The fasteners 1634 may be adjustable to allow the crossbar 1614 to be positioned in a desired position. As is illustrated best in FIG. 16I, the crossbar 1614 may be positioned in various positions relative to the curved wall 1630. That is, the crossbar 1614 may be positioned on either side adjacent to the straight edges 1622A, 1622B. Likewise, an infinite number of angles adjacent to the curved walls 1630 may be achieved by the crossbar 1614. Seven different positions of the crossbar 1614 relative to the crossbar mounting brackets 1612 are provided in FIG. 16I. The flexibility of the positioning of the crossbar 1614 allows different types of vehicles such as but not limited to ATVs, ORVs, UTVs, motorcycles, trucks and commercial vehicles to use the same crossbar mounting bracket 1612 in various locations.

The modular design enables customers to customize the crossbar 1614 to their own needs. The crossbar may be a separate crossbar or may be a component to be attached to the crossbar mounting brackets 1612. For example, a spare tire carrier, a light bar, a roof rack or another feature may be included as a crossbar 1614. The crossbar mounting bracket 1612 distributes the weight evenly across the crossbar and the rails to which it is attached to ensure a safe and stable ride. The crossbar mounting bracket 1614 may be used in other locations such as within a garage. That is, the crossbar 1614 may be removed and coupled to rails disposed on a garage wall, for example. Because of the use of the retainers 1110, a quick removal and replacement of a specific type of device or crossbar 1614 may be performed by the vehicle operator.

To position the crossbar 1614, the crossbar mounting bracket 1612A, 1612B may be coupled to a rail or rails 46. That is, the retainers 1110 are used to couple the crossbar mounting brackets 1612A, 1612B to the same or different rails 46. As mentioned above, the plunger 1142 and the fasteners 1166 are used to retain the retainer and thus the crossbar mounting bracket 1612A, 1612B to the rails 46. The crossbar mounting bracket 1612A, 1612B may be mounted and the crossbar 1614 may be mounted thereto by placing the fasteners 1634 in the desired location. However, the fasteners and mounting brackets may be preassembled, then placed in the appropriate location such as coupled to a rail 46. In this manner, the crossbar 1614 is disposed at an angle to the longitudinal axis 1608. That is, the crossbar 1614 may be at an angle other than 90° or parallel to the longitudinal axis 1608.

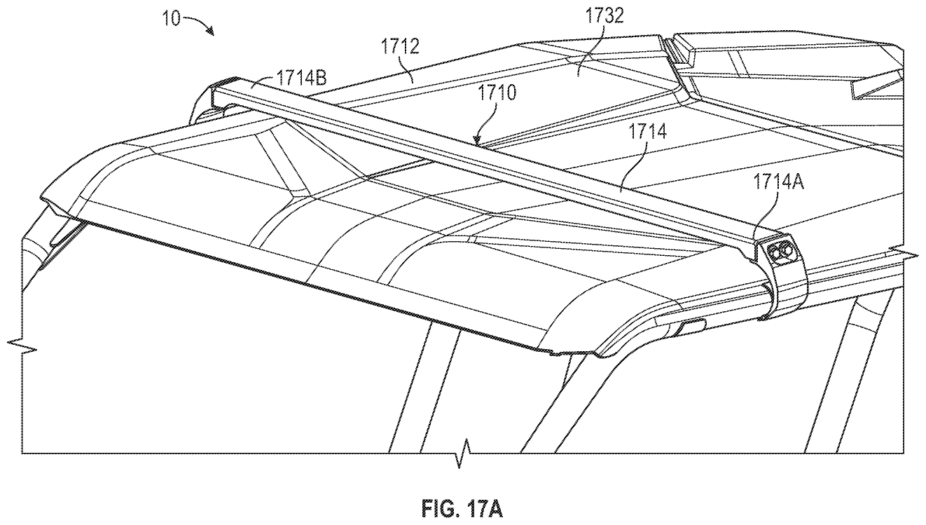

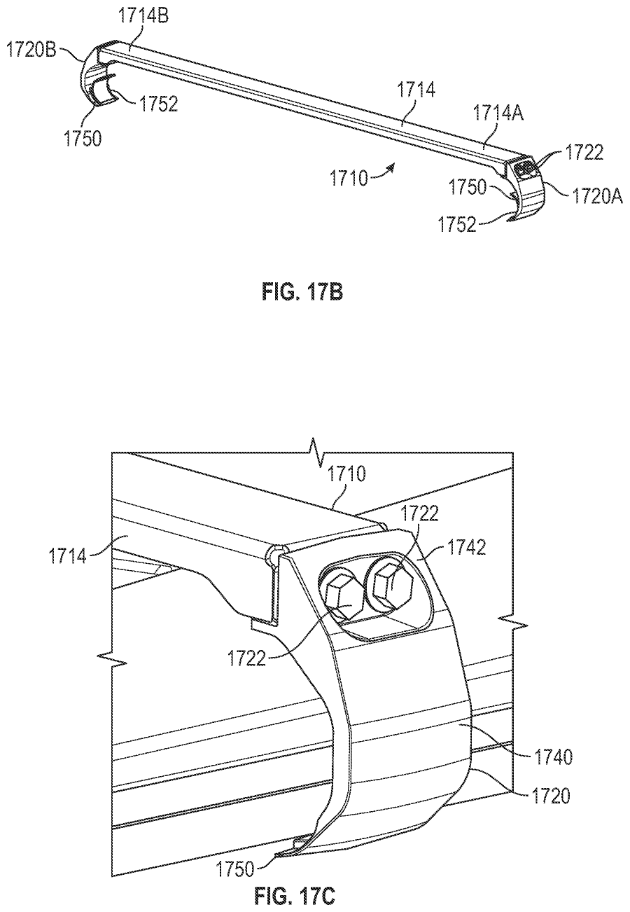

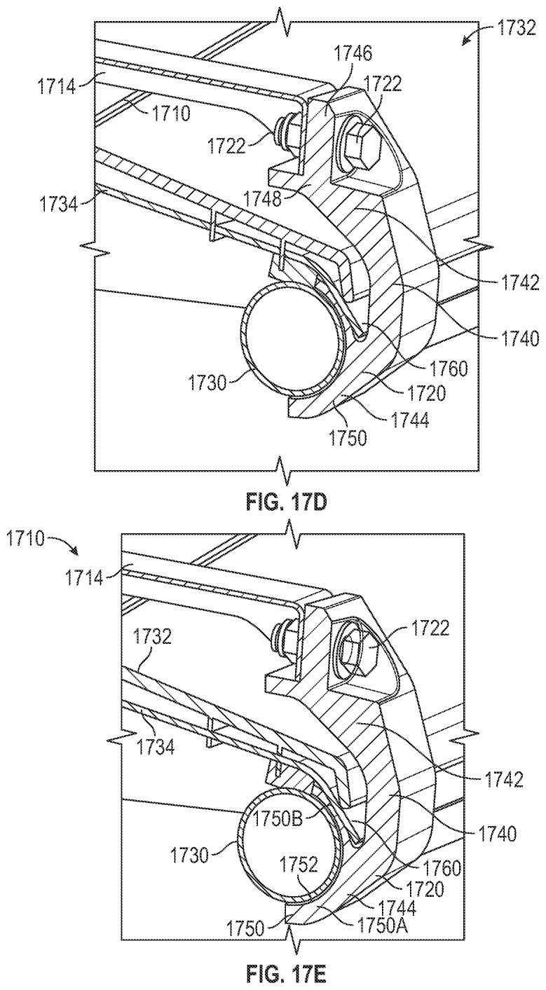

Referring now to FIGS. 17A-17E, a roof rack 1710 is illustrated coupled adjacent to a roof 1712. The roof rack 1710 comprises a crossbar 1714 that extends laterally across the vehicle 10 in this example. Although not illustrated, the crossbar 1714 may have various configurations including the rail configuration illustrated in FIG. 2B. That is, the rail 46 may be incorporated into or form the crossbar 1714 so that various devices could be coupled thereto. Of course, other shapes of the crossbar 1714 may be formed. In FIG. 2B, the crossbar has an elongated opening 52 with locating openings 54 regularly spaced therealong. A channel 50 extends below the elongated opening 52 so that different types of devices may be coupled thereto. In this example, the crossbar 1714 has a first crossbar end 1714A and a second crossbar end 1714B. The first end 1714A is coupled to a first clamp 1720A. A second clamp 1720B is coupled to the second end 1714B. In this example, two fasteners 1722 are used at each end 1714A, 1714B. That is, fasteners 1722 extend through the first clamp 1720 of the crossbar. The second end 1714B of the crossbar 1714 is configured in a similar manner with two fasteners 1722, in this example.

The roof rack 1710, as is best illustrated, in FIGS. 17D and 17E, has the first clamp 1720A, 1720B on laterally outside sides of a tubular structure 1730. That is, the tubular structures 1730 are disposed longitudinally and support the roof 1712. As is best illustrated in FIGS. 17D and 17E, the roof has an outer panel 1732 and an inner panel 1734. Of course, other types of roofs may be accommodated.

In this example, the first clamp 1720A will be described in further detail. However, the second clamp 17B is identical but facing in the laterally opposite direction. Therefore, the clamp 1720 refers to both clamps and the configuration thereof. The clamp 1720 has a central portion 1740. The central portion 1740 may be curved. The central portion 1740 has a first end 1742 and a second end 1744. The first end 1742 has a first wall 1746 which is illustrated as a vertical wall. A second wall 1748 is also disclosed at the first end 1742. In this example, the second wall 1748 extends horizontally and laterally (a lateral extension portion) and forms an angle with the first wall 1746. The second wall 1748 extends laterally relative to the vehicle and may be used so that the first end 14A of the crossbar 1714 is supported thereby.

The second end 1744 has a coupler portion 1750 that a first wall 1750A and a second wall 1750B that are coextensive. The first wall 1750A and the second wall 1750B extend from the second end 1744 and form an inner continuous surface 1752. The continuous surface 1752 in this example is a curved surface that has a curvature that corresponds to the curvature of the tubular structure 1730.

A pocket 1760 used to receive the roof 1712 is formed by the clamp 1720. The pocket 1760 is defined by the first end 1742, the second end 1744 and the central portion 1740. In particular, the wall 1750B of the coupler portion, the central portion 1740 and the second wall 1748 of the first end 1742 form the pocket 1760. In this manner, the clamp 1720 does not interfere with the position of the roof when installing the roof rack 1710. It should be noted that FIGS. 17D and 17E are cross sections illustrating only one of the fasteners 1722. Further, FIG. 17A shows one portion of a roof rack 1710. More than one roof rack 1710 may be coupled to a roof 1712 and the tubular structure 1730 there below.

The central portion 1750, the first end 1742 and the second end 1744 may be monolithic in structure. That is, the entire clamp 1720 may be formed as a single structure.

To install the roof rack, the first clamp 1720A and the second clamp 1720B may be loosely coupled to the crossbar 1714. The coupler portion 1750 of the first clamp may be positioned against the tubular structure 1730 on the first side of the vehicle. The coupler portion 1750 of the second clamp 1720B may be positioned against the tubular structure 1730 on the other side of the vehicle. The fasteners 1722 may then be used to couple the clamps to the crossbar 1714. By tightening the fasteners 1722, the clamps 1720 and, in particular, the first end 1742 of the clamps are drawn together. The coupler portion 1750 is also tightened against the tubular structure 1730 so that lateral, longitudinal and vertical movement of the clamps 1720A, 1720B are prevented. It should be noted that the coupler portion 1750 may be formed to accommodate sizes of tubular structures in various types of vehicles. Further, modification of the roof 1712 or other portions of the vehicle is not required to accommodate the roof rack 1710.

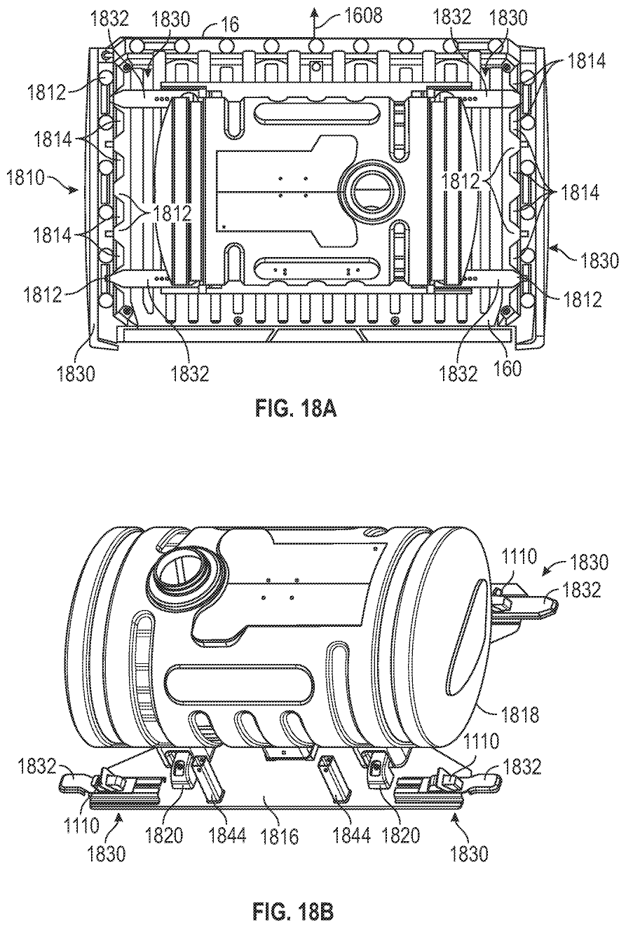

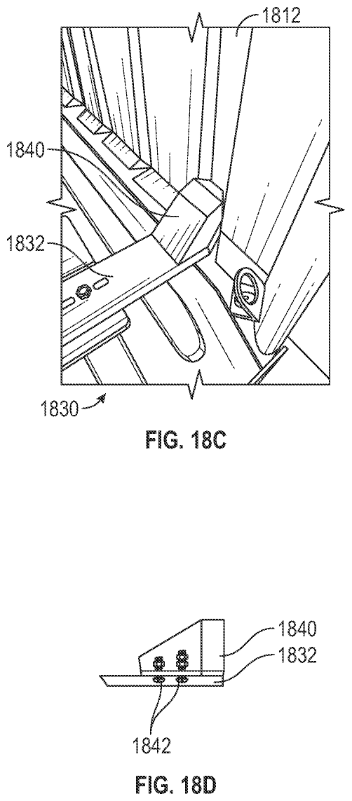

Referring now to FIGS. 18A-18D, a sprayer assembly 1810 is illustrated in a cargo box 16. The longitudinal axis 1608 of the vehicle 10 is illustrated. In this example, the cargo box 16 has vertically extending recesses 1812. The vertically extending recesses 1812 have ridges 1814 on either side thereof. The ridges 1814 may be formed of various materials including plastic or metal. The sprayer assembly 1810 is fixedly coupled within the cargo box 16. The sprayer assembly 1810, as is best illustrated in FIG. 18B, has a sprayer base 1816. The base 1816 is generally planar and rests against the floor 16D of the cargo box 16. A tank 1818 is coupled to the sprayer base 1816. Clamps 1820 fix the sprayer tank 1818 to the sprayer base 1816. Fasteners straps or other mechanisms may be used as the clamps 1820.

The sprayer assembly 1810 is removably coupled to the cargo box 16 by way of a plurality of rail locks 1830. The rail locks 1830 extend and engage the vertical extending recesses 1812 so that the position of the sprayer base 1816, and therefore the tank 1818, are maintained. The rail locks 1830 include a rail 46 as illustrated in FIG. 2B above. The rail 46, the elongated opening 52 and locating openings 54 may be provided. Of course, because the portion of the rail 46 is so short, the locating openings 54 may be eliminated.

Arms 1832 are used to engage the vertically extending recesses 1812. In this example, the arms 1832 extend laterally relative to the vehicle 10 to engage the vertically extending recesses 1812. The arms move in the direction illustrated by the arrows 1834. Retainers 1110 extend through the arms 1832 into the rails 46 for securing the arms 1832 to the rail 46. Details of the coupler are described above. FIGS. 15G and 15H illustrate the openings and how the coupler 110 may be coupled to the arm (without the leg of the seat base). That is, the arm 1832 may have the openings 1562A, 1562B and 1562C that receive the fasteners 1166 and the plunger 1142 of the retainer 1110. This allows the handle 1134 to be moved to an upward position and the arms 1832 may be allowed to slide in the lateral direction. To remove the tank, the handle 1134 is moved to the upward position to loosen the plunger 1142 and release the pressure of the foot of the plunger from the inside of the channel of the rail 46 and therefore allow the arm 1832 and therefore the retainer 1110 to move laterally (relative to the vehicle 10) within the rail 46 to install and uninstall the base 1816. That is, the rails 46 may be fixedly coupled to the base 1816 and the arms 1832 move relative to the rails 46.

Referring now specifically to FIGS. 18C and 18D, a block 1840, such as a rubber wedge block as illustrated, may be disposed at an end of each of the arms 132. The blocks 1840 engage the vertically extending recesses 1812 of the cargo box 16. Each corner of the sprayer base 1816 may have an arm 1832 and a block 1840. However, diagonal corners of the sprayer base 1816 may have arms 1832.

The sprayer base 1816 may also have fastening portions 1844 coupled thereto. The fastening portions 1844 may allow for different size sprayer tanks to be accommodated. For example, the sprayer base 1816 may be used to accommodate different size tanks such as a 40-gallon tank and a 60-gallon tank. The block 1840 may be coupled to the arm 1832 using fasteners 1842 such as screws or rivets. The fasteners 1842 extend into the arms 1832 as illustrated and into the block 1840.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A vehicle assembly comprising:
a roof panel having a plurality of roof recesses comprising a first roof recess spaced apart from a second roof recess;
a first roof mount comprising a first extension sized to be received in the first roof recess and a second roof mount comprising a second extension sized to be received in the second roof recess;
said first roof mount comprising a first mount recess having a first fastener passage receiving a first fastener, said first fastener coupling the first roof mount to the roof panel at the first roof recess, said first roof mount comprising a first receiver channel;
said second roof mount comprising a second mount recess having a second fastener passage receiving a second fastener, said second fastener coupling the second roof mount to the roof panel at the second roof recess, said second roof mount comprising a second receiver channel;
a first roof rail comprising a first rail channel at least partially disposed in the first receiver channel and the second receiver channel;
a third fastener coupling the first roof rail to the first roof mount at the first receiver channel; and
a fourth fastener coupling the first roof rail to the second roof mount at the second receiver channel.

2. The vehicle assembly of claim 1 further comprising a fifth fastener coupling the first roof rail to the first roof mount at the first receiver channel and a sixth fastener coupling the first roof rail to the second roof mount at the second receiver channel.

3. The vehicle assembly of claim 1 wherein the first fastener is recessed in the first mount recess.

4. The vehicle assembly of claim 1 further comprising a fourth fastener coupling the second roof mount to the roof panel.

5. The vehicle assembly of claim 4 wherein the fourth fastener is recessed in the second mount recess.

6. The vehicle assembly of claim 1 wherein the first roof mount is elongated and the second roof mount is elongated.

7. The vehicle assembly of claim 6 wherein the first roof mount and the second roof mount are oriented laterally on the roof panel.

8. The vehicle assembly of claim 1 wherein the third fastener and the fourth fastener are disposed in the first receiver channel.

9. The vehicle assembly of claim 1 further comprising a third roof mount and a fourth roof mount coupled to the roof panel and to a second rail extending therebetween.

10. The vehicle assembly of claim 1 further comprising a first cap coupled to a first end of the first roof rail and a second cap disposed in a second end of the first roof rail.

11. (canceled)
